(19) United States
(12) Patent Application Publication
(10) Pub. No.: US 2022/0300677 A1
(43) Pub. Date: Sep. 22, 2022

(54) METHOD FOR ANALYZING DYNAMIC RESPONSE AND DYNAMIC IMPEDANCE OF PILE GROUPS AND SYSTEM THEREFOR

(71) Applicant: Shanghai University, Shanghai (CN)

(72) Inventors: Wenjuan Yao, Shanghai (CN); Zekun Cheng, Shanghai (CN); Wu Li, Shanghai (CN); Tingchen Fang, Shanghai (CN); Wenyin Gu, Shanghai (CN)

(73) Assignee: Shanghai University, Shanghai (CN)

(21) Appl. No.: 17/378,582

(22) Filed: Jul. 16, 2021

(30) Foreign Application Priority Data
Mar. 15, 2021 (CN) 202110273292.6

(51) Int. Cl. G06F 30/20; G01M 5/00

(52) U.S. Cl. CPC G06F 30/20; G01M 5/0025; G06F 2111/10

(57) ABSTRACT

The present disclosure discloses a method for analyzing dynamic response and dynamic impedance of pile groups and a system therefor. The influence of wave load on pile groups is taken into account to study the dynamic stability of pile groups, the foundation reaction force is calculated by using an improved Vlasov foundation model, the dynamic stability equation of active piles and passive piles is established by combining an interaction factor method and a matrix transfer method, the dynamic interaction factor between adjacent piles and impedance of pile groups are obtained, and the stability of pile groups is analyzed by parameters. Through research, it is found that the existence of wave load makes the dynamic response of pile groups increase obviously; the dynamic impedance and the interaction factor of pile groups are mainly affected by soil parameters, but the existence of wave load will affect some soil parameters.

### CROSS REFERENCE TO RELATED APPLICATION(S)

This patent application claims the benefit and priority of Chinese Patent Application No. 202110273292.6, filed on Mar. 15, 2021, the disclosure of which is incorporated by reference herein in its entirety as part of the present application.

### TECHNICAL FIELD

The present disclosure belongs to the technical field of geotechnical engineering, and in particular relates to a calculation method for calculating dynamic response and dynamic impedance of pile groups based on an interaction factor superposition method.

### BACKGROUND ART

At present, for the study of dynamic stability of a single pile under the harmonic load effect and the impact load effect, most pile foundations appear in the form of pile groups in practical engineering, such as 2×2, 3×3, 6×6 pile groups, etc., and the number of the piles may be more in some large structures. Compared with a single pile, the dynamic analysis of pile groups is much more complicated. Different from a single pile which only needs to consider the load on itself, the pile foundation in pile groups should also consider the influence of other adjacent pile foundations on itself, that is, the pile group effect. Considering the pile group effect involves the interaction between pile-soil-pile, while the dynamic problem is mainly studied in the present disclosure. Therefore, it is mainly the dynamic interaction between piles and soil, and analyzing the dynamic interaction between piles and soil in the soil layer is the basis for further studying the dynamic response of the pile foundation.

### SUMMARY

In order to solve the problems in the prior art, the present disclosure aims to overcome the defects of the prior art, and provides a method and system for analyzing dynamic response and dynamic impedance of super-long pile groups under wave loading based on interaction factor and transfer matrix method. Winkler foundation model is widely used to calculate the reaction force of soil in some previous studies. However, because the Winkler model is simplified too much and has obvious shortcomings, the continuous characteristics between soils and pile group effect and pile soil pile interaction are considered in the method of the present disclosure, and the improved Vlasov foundation model is used to calculate the foundation reaction force of soil so as to solve the problems raised in the above background art. The present method is not only accurate calculation, but also simple and feasible, very suitable for practical engineering design.

In order to achieve the purpose of the present disclosure, the present disclosure uses the following technical scheme:

A method for analyzing dynamic response and dynamic impedance of pile groups, wherein the foundation reaction force is calculated by using an improved Vlasov foundation model, the dynamic stability equation of active piles and passive piles is established by combining an interaction factor method and a matrix transfer method, the dynamic interaction factor between adjacent piles and impedance of pile groups are obtained, and the stability of pile groups is analyzed by parameters to obtain dynamic response and dynamic impedance of pile groups.

Preferably, the method for analyzing dynamic response and dynamic impedance of pile groups according to the present disclosure comprises the following steps:

(1) parameter selection

the dynamic interaction between pile-soil-pile is an important part of analyzing the dynamic response of pile groups, through the analysis of the dynamic interaction between pile groups, the relationship between active pile-soil-passive pile is obtained, the dynamic response of pile groups is analyzed continuously, and the analysis of dynamic interaction starts with active piles first; the dynamic analysis model of active piles is as follows:

N₀ is set as the vertical static load of the pile top, Q₀e^{iwt} is set as the initial horizontal harmonic load of the pile top, M₀e^{iwt} is set as the initial bending moment of the pile top, and f_{z} is set as the wave load:

$${f}_{z} = \frac{2 ρ g H}{K} \cdot \frac{c h ( K {z}_{1} )}{c h ( K {d}_{L} )} {f}_{A} \cdot cos ( ω t )$$

where

$$k = \frac{2 π}{L} ,$$

L is the wavelength;

$$ω = \frac{2 π}{T} ,$$

T is the wave period, and ρ is the density of seawater, which is 1030 kg/m³;
g is the acceleration of gravity, which is 9.8 m/s²; H is the wave height; α is the phase angle; z₁ is the water depth, d_{L} is the water entry depth of the pile body and does not include the soil buried part;

$${f}_{A} = \frac{1}{\sqrt{{[ {J}_{1}^{′} ( π D / L ) ]}^{2} + {[ {Y}_{1}^{′} ( π D / L ) ]}^{2}}} ,$$

J′₁ is the first-order Bessel function of the first kind, Y′₁ is the first order;

according to the model, the motion balance equation of the soil layer is obtained as follows:

$$\{ \begin{matrix}\frac{\partial {Q}_{ai} ( z , t )}{\partial z} - ( {k}_{xi} {U}_{ai} ( z , t ) + {c}_{xi} \frac{\partial {U}_{ai} ( z , t )}{\partial t} - {t}_{gxi} \frac{{\partial }^{2} {U}_{ai} ( z , t )}{\partial {z}^{2}} + {N}_{0} \frac{{\partial }^{2} {U}_{ai} ( z , t )}{\partial {z}^{2}} ) = {ρ}_{p} {A}_{P} \frac{{\partial }^{2} {U}_{ai} ( z , t )}{\partial {t}^{2}} \\ \frac{\partial {M}_{ai} ( z , t )}{\partial z} + {Q}_{ai} ( z , t ) = {f}_{z} ( z , t )\end{matrix}$$

where kₓᵢ is the stiffness coefficient of soil beside the pile, t_{gxi} is the continuity coefficient of soil beside the pile, cₓᵢ is the damping coefficient of soil, A_{ρ} is the circular cross-sectional area of the pile, ρ_{ρ} is the bulk density of the pile, Qₐᵢ(z,t) and Mₐᵢ(z,t) are the cross-sectional shear force and bending moment of the active pile, respectively;

according to the dynamic interaction between pile-soil-pile involved in pile group, the interaction between pile-soil is described, and the reaction force of soil is simulated based on the VLasov foundation model derived from a continuous medium model. The specific calculation formula is as follows:

$$q ( x ) = {k}_{i} w ( x ) - 2 {t}_{gi} {w}^{″} ( x )$$

$$where$$

$${k}_{i} = \frac{{E}_{0}}{1 - {v}_{0}^{2}} {\int }_{0}^{H} {( \frac{d h ( z )}{d z} )}^{2} dz$$

$${t}_{gi} = \frac{{E}_{0}}{4 ( 1 - {v}_{0}^{2} )} {\int }_{0}^{H} {h ( z )}^{2} d z$$

h(z) is the parameters of the attenuation function of vertical displacement. Vallabhan and Das are used, the displacement function and the attenuation function are connected by using another new parameter γ, and the accurate expression of the displacement function and the attenuation function is obtained, which is referred to as an improved Vlasov foundation model; the improved Vlasov foundation model is used to calculate the foundation reaction force; according to Vallabhan and Das, the parameters of the foundation model based on the lateral displacement of the pile foundation are as follows:

$${k}_{V} = π ( {η}^{2} + 1 ) G \{ 2 γ \frac{{K}_{1} ( γ )}{{K}_{0} ( γ )} - {γ}^{2} [ {( \frac{{K}_{1} ( γ )}{{K}_{0} ( γ )} )}^{2} - 1 ] \}$$

$${t}_{g p} = π G \{ {\frac{{γ}^{2}}{{{K}_{0} ( γ )}^{2}} [ {{K}_{1} ( γ )}^{2} - {{K}_{0} ( γ )}^{2} ]}^{2} - 2 γ {K}_{1} ( γ ) {K}_{0} ( γ ) \}$$

where η is lamé constant,

G is the shear modulus of soil,

γ is the attenuation parameter, which is calculated by an iterative method,

K₀(·)is the zero-order modified Bessel function of the second kind;

K₁(·) is the first-order modified Bessel function of the second kind;

where

$$h ( γ ) = \frac{{K}_{0} ( 2 γ r / D )}{{K}_{0} ( γ )} ,$$

r is a variable in column coordinates;

the formula of a foundation soil reaction force q(x) is:

q(x)=k_{V}u(x)−2t _{gp}u″(x)

the damping of soil is calculated as follows:

$${c}_{xi} \approx 6 {ρ}_{i} {dV}_{si} / \sqrt[4]{{a}_{0}} + 2 {ξ}_{i} {k}_{xi} / ω$$

where ρᵢ is density of soil, d is the pile diameter, Vₛᵢ is the shear wave velocity in soil, ξᵢ is the damping ratio in soil, ω is the circular frequency of vibration, a₀=2πfd/Vₛᵢ, and f is the frequency of load; from the above formula, cₓᵢ is consisted of two parts, that is, the energy loss comes from two parts, one part is the damping of the material, that is,

$$6 {ρ}_{i} {dV}_{si} / \sqrt[4]{{a}_{0}} ,$$

and the other part is the loss caused by the propagation of stress wave in soil during the vibration of the pile body, that is, 2ξᵢkₓᵢ/ω;

(2) establishment of model equation

the general form of the steady-state vibration equation of the pile body obtained by the motion balance equation of the pile body is as follows:

$$E I \frac{\partial {U}_{ai} ( z , t )}{\partial {z}^{4}} + {k}_{xi} {U}_{ai} ( z , t ) + {ρ}_{ρ} {A}_{ρ} \frac{{\partial }^{2} {U}_{ai} ( z , t )}{\partial {t}^{2}} + {c}_{xi} \frac{\partial {U}_{ai} ( z , t )}{\partial t} + ( {N}_{i} ( z ) - {t}_{gxi} ) \frac{{\partial }^{2} {U}_{ai} ( z , t )}{\partial {z}^{2}} = 0$$

considering that the pile foundation is partially embedded and fixed in the soil, the part of the pile body in the water bears the effect of the wave load without the constraint of the soil, the pile body is divided into two parts, the vibration equation of the part of the pile body in the soil is shown in the above formula, while the vibration equation of the part of the pile body exposed to the soil is shown in the following formula:

$$E i \frac{\partial {U}_{ai} ( z , t )}{\partial {z}^{4}} + {ρ}_{ρ} {A}_{ρ} \frac{{\partial }^{2} {U}_{ai} ( z , t )}{\partial {t}^{2}} + {c}_{xi}^{′} \frac{\partial {U}_{ai} ( z , t )}{\partial t} + {N}_{i} ( z ) \frac{{\partial }^{2} {U}_{ai} ( z , t )}{\partial {z}^{2}} = {f}_{z} ( z )$$

the displacement Uₐᵢ,(z, t) of the pile body is expressed as Uₐᵢ, (z, t)=uₐᵢ(z)e^{iwt}, and the vibration equation becomes the following form:

the part of the pile body deep into soil:

$$\frac{{d}^{4} {u}_{ai} ( z )}{d {z}^{4}} - {m}_{1} \frac{{d}^{2} {u}_{ai} ( z )}{d {z}^{2}} - {m}_{2} {u}_{ai} ( z ) = 0$$

the part of the pile body in water:

$$\frac{{d}^{4} {u}_{ai} ( z )}{d {z}^{4}} - {m}_{3} \frac{{d}^{2} {u}_{ai} ( z )}{d {z}^{2}} - {m}_{4} {u}_{ai} ( z ) = {m}_{5} cosh ( {k}_{f} ( {d}_{L} - z ) )$$

$$where$$

$${m}_{1} = \frac{{δ}_{i}^{2}}{{h}_{i}^{2}} , {m}_{2} = \frac{{ϑ}_{i}^{4}}{{h}_{i}^{4}} , {m}_{3} = \frac{{N}_{i} ( z )}{{E}_{p} {I}_{p}} ,$$

$${m}_{4} = \frac{{ρ}_{ρ} {A}_{ρ} {w}^{2} - {c}_{xi}^{′} \cdot i \cdot w}{{E}_{p} {I}_{p}} , {m}_{5} = \frac{2 ρ {gH}_{i}}{{k}_{f z} {E}_{p} {I}_{p}} {f}_{A} , {d}_{L}$$

is the water depth;

where

$${δ}_{i} = {h}_{i} \sqrt{\frac{( {t}_{gxi} - {N}_{i} )}{{E}_{p} {I}_{p}}} , {ϑ}_{i} = {h}_{i} \sqrt[4]{\frac{{ρ}_{p} {A}_{p} {ω}^{2} - {k}_{xi} - i {c}_{xi} ω}{{E}_{p} {I}_{p}}} ,$$

$${c}_{xi}^{′} = 6 {ρ}_{i} {dV}_{si} / \sqrt[4]{{a}_{0}}$$

hᵢ is the thickness of the i-th layer of soil;

then the general solution of the following form is obtained by solving the above high-order vibration differential equation:

$${U}_{1 i} ( z ) = {A}_{1 i} cosh ( \frac{{ζ}_{1 i}}{{h}_{i}} z ) + {B}_{1 i} sinh ( \frac{{ζ}_{1 i}}{{h}_{i}} z ) + {C}_{1 i} cos ( \frac{{ζ}_{2 i}}{{h}_{i}} z ) + {D}_{1 i} sin ( \frac{{ζ}_{2 i}}{h} z )$$

$$where {ζ}_{1 i} = \sqrt{\frac{{δ}_{i}^{2}}{2} + \sqrt{\frac{{δ}_{i}^{4}}{4} + {ϖ}_{i}^{4}}} , {ζ}_{2 i} = \sqrt{- \frac{{δ}_{i}^{2}}{2} + \sqrt{\frac{{δ}_{i}^{4}}{4} + {ϖ}_{i}^{4}}} ,$$

A₁ᵢ, B₁ᵢ, C₁ᵢ, D₁ᵢ are the undetermined coefficients determined by boundary conditions;

the general solution of the above formula is:

$${U}_{1 i}^{′} ( z ) = {A}_{1 i}^{′} cosh ( {σ}_{1} z ) + {B}_{1 i}^{′} sinh ( {σ}_{1} z ) + {C}_{1 i}^{′} cos ( {σ}_{2} z ) + {D}_{1 i}^{′} sin ( {σ}_{2} z ) + {E}_{1} cosh [ {k}_{f z} ( {d}_{L} - z ) ]$$

$$where {σ}_{1} = z \sqrt{\frac{{m}_{3}}{2} + \frac{\sqrt{{m}_{3}^{2} + 4 {m}_{4}}}{2}} , {σ}_{2} = z \sqrt{\frac{\sqrt{{m}_{3}^{2} + 4 {m}_{4}}}{2} - \frac{{m}_{3}}{2}} ,$$

A′₁ᵢ, B′₁ᵢ, C′₁ᵢ, D′₁ᵢ, E₁ are also undetermined general solution coefficients, which are determined by the boundary conditions of the pile body, and E₁ is the wave load parameter, which is obtained by direct calculation;

(3) analysis of the part of the pile body exposed to soil, that is, analysis of the part of the pile body bearing the wave load:

the part of the pile body exposed to soil is regarded as a unit layer, which is similar to the division of a soil layer, and it is regarded as a layer, for the rotation angle of the cross section φ′(z), the shear force of the pile body Q′(z), the bending moment M′(z), and the horizontal displacement of the pile body:

the following relationship holds:

$${φ}_{1 i}^{′} ( z ) = {A}_{1 i}^{′} {σ}_{1} sinh ( {σ}_{1} z ) + {B}_{1 i}^{′} {σ}_{1} cosh ( {σ}_{1} z ) - {C}_{1 i}^{′} \frac{{ζ}_{2 i}}{{h}_{i}} sin ( {σ}_{2} z ) + {D}_{1 i}^{′} {σ}_{2} cos ( {σ}_{2} z ) - {k}_{f z} {E}_{1} s h ( {k}_{f} ( {d}_{L} - z ) )$$

$${Q}_{1 i}^{′} ( z ) = {E}_{P} {I}_{P} [ {σ}_{1}^{3} [ {A}_{1 i}^{′} sinh ( {σ}_{1} z ) + {B}_{1 i}^{′} cosh ( {σ}_{1} z ) ] + {σ}_{2}^{3} [ {C}_{1 i}^{′} sin ( {σ}_{2} z ) - {D}_{1 i}^{′} cos ( {σ}_{2} z ) ] - {k}_{f}^{3} {E}_{1} s h ( {k}_{f} ( {d}_{L} - z ) ) ]$$

$${M}_{1 i}^{′} ( z ) = {E}_{P} {I}_{P} [ {σ}_{1}^{2} [ {A}_{1 i}^{′} cosh ( {σ}_{1} z ) + {B}_{1 i}^{′} sinh ( {σ}_{1} z ) ] - {σ}_{2}^{2} [ {C}_{1 i}^{′} cos ( {σ}_{2} z ) + {D}_{1 i}^{′} sin ( {σ}_{2} z ) ] + {k}_{f}^{2} {E}_{1} s h ( {k}_{f} ( {d}_{L} - z ) ) ]$$

it is organized into a matrix as shown in the following formula:

$$\{ \begin{matrix}{U}_{ai}^{′} \\ {φ}_{ai}^{′} \\ {Q}_{ai}^{′} \\ {M}_{ai}^{′}\end{matrix} \} = {n}_{i}^{a} \{ \begin{matrix}{A}_{1 i}^{′} \\ {B}_{1 i}^{′} \\ {C}_{1 i}^{′} \\ {D}_{1 i}^{′}\end{matrix} \} + \{ \begin{matrix}{E}_{u} \\ {E}_{φ} \\ {E}_{Q} \\ {E}_{M}\end{matrix} \} ⇒ \{ \begin{matrix}{U}_{ai}^{′} - {E}_{u} \\ {φ}_{ai}^{′} - {E}_{φ} \\ {Q}_{ai}^{′} - {E}_{Q} \\ {M}_{ai}^{′} - {E}_{M}\end{matrix} \} = {n}_{i}^{a} \{ \begin{matrix}{A}_{1 i}^{′} \\ {B}_{1 i}^{′} \\ {C}_{1 i}^{′} \\ {D}_{1 i}^{′}\end{matrix} \}$$

$${n}_{i}^{a} = [ \begin{matrix}cosh {σ}_{1} z & sinh {σ}_{1} z & cos {σ}_{2} z & s i n {σ}_{2} z \\ {σ}_{1} s h {σ}_{1} z & {σ}_{1} c h {σ}_{1} z & - {σ}_{2} sin {σ}_{2} z & \frac{{ζ}_{2 i}}{{h}_{i}} c o s \frac{{ζ}_{2 i}}{{h}_{i}} z \\ {E}_{p} {I}_{p} {σ}_{1}^{3} sinh {σ}_{1} z & {E}_{p} {I}_{p} {σ}_{1}^{3} cosh {σ}_{1} z & {E}_{p} {I}_{p} {σ}_{2}^{3} sin {σ}_{2} z & - {E}_{p} {I}_{p} {σ}_{2}^{3} cos {σ}_{2} z \\ {E}_{p} {I}_{p} {σ}_{1}^{2} cosh {σ}_{1} z & {E}_{p} {I}_{p} {σ}_{1}^{2} sinh {σ}_{1} z & - {E}_{p} {I}_{p} {σ}_{2}^{2} cos {σ}_{2} z & - {E}_{p} {I}_{p} {σ}_{2}^{2} sin {σ}_{2} z\end{matrix} ]$$

$$[ \begin{matrix}{E}_{u} \\ {E}_{φ} \\ {E}_{Q} \\ {E}_{M}\end{matrix} ] = {E}_{1} [ \begin{matrix}ch [ {k}_{f} ( {d}_{L} - z ) ] \\ - {k}_{f} \cdot sh ( {k}_{f} ( {d}_{L} - z ) ) \\ - {E}_{P} {I}_{P} {k}_{f}^{3} sinh ( {k}_{f} ( {d}_{L} - z ) ) \\ {E}_{P} {I}_{P} {k}_{f}^{2} cosh ( {k}_{f} ( {d}_{L} - z ) )\end{matrix} ]$$

$${E}_{1} = \frac{- 2 \sqrt{2} \sqrt{{m}_{{3}^{+}} \sqrt{{m}_{3}^{2} + 4 {m}_{4}}}}{\sqrt{{m}_{3}^{2} + 4 {m}_{4}} ( 4 {k}_{f}^{2} - 2 ( {m}_{3} + \sqrt{{m}_{3}^{2} + 4 {m}_{4}} ) ) {σ}_{1}} + \frac{- 2 \sqrt{2} \sqrt{{m}_{3} - \sqrt{{m}_{3}^{2} + 4 {m}_{4}}}}{\sqrt{{m}_{3}^{2} + 4 {m}_{4}} ( 4 {k}_{f}^{2} - 2 ( {m}_{3} + \sqrt{{m}_{3}^{2} + 4 {m}_{4}} ) ) {σ}_{2}}$$

z=0 at the top of the pile and the following formula is obtained:

$$\{ \begin{matrix}{A}_{1 i}^{′} \\ {B}_{1 i}^{′} \\ {C}_{1 i}^{′} \\ {D}_{1 i}^{′}\end{matrix} \} = inv [ \begin{matrix}1 & 0 & 1 & 0 \\ 0 & {σ}_{1} & 0 & {σ}_{1} \\ 0 & {E}_{P} {I}_{P} {σ}_{1}^{3} & 0 & - {E}_{P} {I}_{P} {σ}_{2}^{3} \\ {E}_{P} {I}_{P} {σ}_{1}^{2} & 0 & - {E}_{P} {I}_{P} {σ}_{1}^{2} & 0\end{matrix} ] \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \} = {[ {n}_{i}^{a} ]}_{z = 0}^{- 1} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$

then, at the boundary of the part of the pile body in the water and the soil layer, let z=hᵢ to obtain:

$$\{ \begin{matrix}{U}_{ai}^{′} ( {h}_{i} ) - {E}_{u} ( {h}_{i} ) \\ {φ}_{ai}^{′} ( {h}_{i} - {E}_{φ} ( {h}_{i} ) \\ {Q}_{ai}^{′} ( {h}_{i} ) - {E}_{Q} ( {h}_{i} ) \\ {M}_{ai}^{′} ( {h}_{i} ) - {E}_{M} ( {h}_{i} )\end{matrix} \} = {[ {n}_{i}^{a} ]}_{z = {h}_{i}} \{ \begin{matrix}{A}_{1 i}^{′} \\ {B}_{1 i}^{′} \\ {C}_{1 i}^{′} \\ {D}_{1 i}^{′}\end{matrix} \} = {{[ {n}_{i}^{a} ]}_{z = {h}_{i}} [ {n}_{i}^{a} ]}_{z = 0}^{- 1} \{ \begin{matrix}{U}_{ai}^{′} ( 0 ) ‐ {E}_{u} ( 0 ) \\ {φ}_{ai}^{′} ( 0 ) ‐ {E}_{φ} ( 0 ) \\ {Q}_{ai}^{′} ( 0 ) ‐ {E}_{Q} ( 0 ) \\ {M}_{ai}^{′} ( 0 ) ‐ {E}_{M} ( 0 )\end{matrix} \} = {\overline{N}}^{a} \{ \begin{matrix}{U}_{ai}^{′} ( 0 ) ‐ {E}_{u} ( 0 ) \\ {φ}_{ai}^{′} ( 0 ) ‐ {E}_{φ} ( 0 ) \\ {Q}_{ai}^{′} ( 0 ) ‐ {E}_{Q} ( 0 ) \\ {M}_{ai}^{′} ( 0 ) ‐ {E}_{M} ( 0 )\end{matrix} \} {\overline{N}}^{a} = {{[ {n}_{i}^{a} ]}_{z = {h}_{i}} [ {n}_{i}^{a} ]}_{z = 0}^{- 1}$$

after the transformation of the matrix, the displacement of the top of the pile exposed to the soil is related to the displacement of the water-soil boundary, as shown in the following formula:

$$\{ \begin{matrix}{U}_{ai}^{′} ( {h}_{i} ) - {E}_{u} ( {h}_{i} ) \\ {φ}_{ai}^{′} ( {h}_{i} - {E}_{φ} ( {h}_{i} ) \\ {Q}_{ai}^{′} ( {h}_{i} ) - {E}_{Q} ( {h}_{i} ) \\ {M}_{ai}^{′} ( {h}_{i} ) - {E}_{M} ( {h}_{i} )\end{matrix} \} = {\overline{N}}^{a} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$

it is assumed that the pile length of the part exposed to the soil is L₁, the displacement, the rotation angle, the shear force and the bending moment of the pile bottom of the part exposed to the soil are shown in the following formula:

$$\{ \begin{matrix}{U}_{a}^{′} ( {L}_{1} ) - {E}_{u} ( {L}_{1} ) \\ {φ}_{a}^{′} ( {h}_{i} ) - {E}_{φ} ( {L}_{1} ) \\ {Q}_{a}^{′} ( {h}_{i} ) - {E}_{Q} ( {L}_{1} ) \\ {M}_{a}^{′} ( {h}_{i} ) - {E}_{M} ( {L}_{1} )\end{matrix} \} = {\overline{N}}^{a} \{ \begin{matrix}{U}_{a}^{′} ( 0 ) - {E}_{u} ( 0 ) \\ {φ}_{a}^{′} ( 0 ) - {E}_{φ} ( 0 ) \\ {Q}_{a}^{′} ( 0 ) - {E}_{Q} ( 0 ) \\ {M}_{a}^{′} ( 0 ) - {E}_{M} ( 0 )\end{matrix} \}$$

study of the part of the pile body in soil: according to the part of the pile body in soil which involves the constraint of soil and the stratification of soil, the specific calculation steps are as follows:

the displacement Uₐᵢ(z) of the pile body in soil is:

$${U}_{ai} ( z ) = {A}_{1 i} cosh ( \frac{{ζ}_{1 i}}{{h}_{i}} z ) + {B}_{1 i} sinh ( \frac{{ζ}_{1 i}}{{h}_{i}} z ) + {C}_{1 i} cos ( \frac{{ζ}_{2 i}}{{h}_{i}} z ) + {D}_{1 i} sin ( \frac{{ζ}_{2 i}}{{h}_{i}} z )$$

at this time, the displacement at the top of the pile becomes the displacement at the water-soil boundary, and the displacement at the bottom of the pile is the actual displacement at the bottom of the pile; the relationship between the shear force and the bending moment in the soil layer unit and the horizontal displacement of the pile body is as follows:

$${φ}_{ai} ( z ) = {A}_{1 i} \frac{{ζ}_{1 i}}{{h}_{i}} sinh ( \frac{{ζ}_{1 i}}{{h}_{i}} z ) + {B}_{1 i} \frac{{ζ}_{1 i}}{{h}_{i}} cosh ( \frac{{ζ}_{1 i}}{{h}_{i}} z ) - {C}_{1 i} \frac{{ζ}_{2 i}}{{h}_{i}} sin ( \frac{{ζ}_{2 i}}{{h}_{i}} z ) + {D}_{1 i} \frac{{ζ}_{2 i}}{{h}_{i}} cos ( \frac{{ζ}_{2 i}}{{h}_{i}} z )$$

$${Q}_{ai} ( z ) = {E}_{P} {I}_{P} \frac{{ζ}_{1 i}^{3}}{{h}_{i}^{3}} [ {A}_{1 i} sinh ( \frac{{ζ}_{1 i}}{{h}_{i}} z ) + {B}_{1 i} cosh ( \frac{{ζ}_{1 i}}{{h}_{i}} z ) ] + {E}_{P} {I}_{P} \frac{{ζ}_{2 i}^{3}}{{h}_{i}^{3}} [ {C}_{{1}_{i}} sin ( \frac{{ζ}_{2 i}}{{h}_{i}} z ) - {D}_{1 i} cos ( \frac{{ζ}_{2 i}}{{h}_{i}} z ) ]$$

$${M}_{ai} ( z ) = {E}_{P} {I}_{P} \frac{{ζ}_{1 i}^{2}}{{h}_{i}^{2}} [ {A}_{1 i} cosh ( \frac{{ζ}_{1 i}}{{h}_{i}} z ) + {B}_{1 i} sinh ( \frac{{ζ}_{1 i}}{{h}_{i}} z ) ] - {E}_{P} {I}_{P} \frac{{ζ}_{2 i}^{2}}{{h}_{i}^{2}} [ {C}_{1 i} cos ( \frac{{ζ}_{2 i}}{{h}_{i}} z ) + {D}_{1 i} sin ( \frac{{ζ}_{{2}_{i}}}{{h}_{i}} z ) ]$$

the above formula is organized into a matrix as shown in the following formula:

$$\{ \begin{matrix}{U}_{ai} \\ {φ}_{ai} \\ {Q}_{ai} \\ {M}_{ai}\end{matrix} \} = [ \begin{matrix}cosh \frac{{ζ}_{1 i}}{{h}_{i}} z & sinh \frac{{ζ}_{1 i}}{{h}_{i}} z & cos \frac{{ζ}_{2 i}}{{h}_{i}} z & sin \frac{{ζ}_{2 i}}{{h}_{i}} z \\ \frac{{ζ}_{1 i}}{{h}_{i}} sh \frac{{ζ}_{1 i}}{{h}_{i}} z & \frac{{ζ}_{1 i}}{{h}_{i}} ch \frac{{ζ}_{1 i}}{{h}_{i}} z & - \frac{{ζ}_{2 i}}{{h}_{i}} sin \frac{{ζ}_{2 i}}{{h}_{i}} z & \frac{{ζ}_{2 i}}{{h}_{i}} cos \frac{{ζ}_{2 i}}{{h}_{i}} z \\ {E}_{p} {I}_{p} \frac{{ζ}_{1 i}^{3}}{{h}_{i}^{3}} sinh \frac{{ζ}_{1 i}}{{h}_{i}} z & {E}_{p} {I}_{p} \frac{{ζ}_{1 i}^{3}}{{h}_{i}^{3}} cosh \frac{{ζ}_{1 i}}{{h}_{i}} z & {E}_{p} {I}_{p} \frac{{ζ}_{2 i}^{3}}{{h}_{i}^{3}} sin \frac{{ζ}_{2 i}}{{h}_{i}} z & - {E}_{p} {I}_{p} \frac{{ζ}_{2 i}^{3}}{{h}_{i}^{3}} cos \frac{{ζ}_{2 i}}{{h}_{i}} z \\ {E}_{p} {I}_{p} \frac{{ζ}_{1 i}^{2}}{{h}_{i}^{2}} cosh \frac{{ζ}_{1 i}}{{h}_{i}} z & {E}_{p} {I}_{p} \frac{{ζ}_{1 i}^{2}}{{h}_{i}^{2}} sinh \frac{{ζ}_{1 i}}{{h}_{i}} z & - {E}_{p} {I}_{p} \frac{{ζ}_{2 i}^{2}}{{h}_{i}^{2}} cos \frac{{ζ}_{2 i}}{{h}_{i}} z & - {E}_{p} {I}_{p} \frac{{ζ}_{2 i}^{2}}{{h}_{i}^{2}} cos \frac{{ζ}_{2 i}}{{h}_{i}} z\end{matrix} ] \{ \begin{matrix}{A}_{1 i} \\ {B}_{1 i} \\ {C}_{1 i} \\ {D}_{1 i}\end{matrix} \}$$

$$let$$

$$[ {\tilde{m}}_{i}^{a} ] = [ \begin{matrix}cosh \frac{{ζ}_{1 i}}{{h}_{i}} z & sinh \frac{{ζ}_{1 i}}{{h}_{i}} z & cos \frac{{ζ}_{2 i}}{{h}_{i}} z & sin \frac{{ζ}_{2 i}}{{h}_{i}} z \\ \frac{{ζ}_{1 i}}{{h}_{i}} sh \frac{{ζ}_{1 i}}{{h}_{i}} z & \frac{{ζ}_{1 i}}{{h}_{i}} ch \frac{{ζ}_{1 i}}{{h}_{i}} z & - \frac{{ζ}_{2 i}}{{h}_{i}} sin \frac{{ζ}_{2 i}}{{h}_{i}} z & \frac{{ζ}_{2 i}}{{h}_{i}} cos \frac{{ζ}_{2 i}}{{h}_{i}} z \\ {E}_{p} {I}_{p} \frac{{ζ}_{1 i}^{3}}{{h}_{i}^{3}} sinh \frac{{ζ}_{1 i}}{{h}_{i}} z & {E}_{p} {I}_{p} \frac{{ζ}_{1 i}^{3}}{{h}_{i}^{3}} cosh \frac{{ζ}_{1 i}}{{h}_{i}} z & {E}_{p} {I}_{p} \frac{{ζ}_{2 i}^{3}}{{h}_{i}^{3}} sin \frac{{ζ}_{2 i}}{{h}_{i}} z & - {E}_{p} {I}_{p} \frac{{ζ}_{2 i}^{3}}{{h}_{i}^{3}} cos \frac{{ζ}_{2 i}}{{h}_{i}} z \\ {E}_{p} {I}_{p} \frac{{ζ}_{1 i}^{2}}{{h}_{i}^{2}} cosh \frac{{ζ}_{1 i}}{{h}_{i}} z & {E}_{p} {I}_{p} \frac{{ζ}_{1 i}^{2}}{{h}_{i}^{2}} sinh \frac{{ζ}_{1 i}}{{h}_{i}} z & - {E}_{p} {I}_{p} \frac{{ζ}_{2 i}^{2}}{{h}_{i}^{2}} cos \frac{{ζ}_{2 i}}{{h}_{i}} z & - {E}_{p} {I}_{p} \frac{{ζ}_{2 i}^{2}}{{h}_{i}^{2}} cos \frac{{ζ}_{2 i}}{{h}_{i}} z\end{matrix} ]$$

it is assumed that z=0 at the top of the pile, that is, at the surface of the soil, it can be obtained that:

$$\{ \begin{matrix}{A}_{1 i} \\ {B}_{1 i} \\ {C}_{1 i} \\ {D}_{1 i}\end{matrix} \} = i n v \{ \begin{matrix}1 & 0 & 1 & 0 \\ 0 & \frac{{ζ}_{1 i}}{{h}_{i}} & 0 & \frac{{ζ}_{2 i}}{{h}_{i}} \\ 0 & {E}_{P} {I}_{P} \frac{{ζ}_{1 i}^{3}}{{h}^{3}} & 0 & - {E}_{P} {I}_{P} \frac{{ζ}_{2 i}^{3}}{{h}_{i}^{3}} \\ {E}_{P} {I}_{P} \frac{{ζ}_{1 i}^{2}}{{h}_{i}^{2}} & 0 & - {E}_{P} {I}_{P} \frac{{ζ}_{2 i}^{2}}{{h}_{i}^{2}} & 0\end{matrix} \} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} = {[ {\tilde{m}}_{i}^{a} ]}_{z = 0}^{- 1} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \}$$

similarly, z=h, at the lower part of the pile foundation, it can be obtained that:

$$\{ \begin{matrix}{U}_{ai} ( {h}_{i} ) \\ {φ}_{ai} ( {h}_{i} ) \\ {Q}_{ai} ( {h}_{i} ) \\ {M}_{ai} ( {h}_{i} )\end{matrix} \} = {[ {\tilde{m}}_{i}^{a} ]}_{z = {h}_{i}} \{ \begin{matrix}{A}_{1 i} \\ {B}_{1 i} \\ {C}_{1 i} \\ {D}_{1 i}\end{matrix} \} = {{[ {\tilde{m}}_{i}^{a} ]}_{z = {h}_{i}} [ {\tilde{m}}_{i}^{a} ]}_{z = 0}^{- 1} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} = [ {\tilde{M}}_{i}^{a} ] \{ \begin{matrix}{U}_{ai} ( 0 ) \\ {φ}_{ai} ( 0 ) \\ {Q}_{ai} ( 0 ) \\ {M}_{ai} ( 0 )\end{matrix} \}$$

$$[ {\tilde{M}}^{a} ] = {{[ {\tilde{m}}_{i}^{a} ]}_{z = {h}_{i}} [ {\tilde{m}}_{i}^{a} ]}_{z = 0}^{- 1}$$

if the soil is divided into multi-layers, according to the principle of continuity of soil uᵢ(0)=uᵢ₋₁(hᵢ₋₁), φᵢ₋₁(hᵢ₋₁), Qᵢ(0)=Qᵢ₋₁(hᵢ₋₁),Mᵢ(0)=Mᵢ₋₁(hᵢ₋₁),

the transfer matrix method is used to connect the displacement, the shear force, the rotation angle and the bending moment between soil layers through a parameter transfer matrix, as shown in the following formula:

$$\{ \begin{matrix}{U}_{a} ( {L}_{2} ) \\ {φ}_{a} ( {L}_{2} ) \\ {Q}_{a} ( {L}_{2} ) \\ {M}_{a} ( {L}_{2} )\end{matrix} \} = [ {\tilde{M}}_{n}^{a} ] [ {\tilde{M}}_{n - 1}^{a} ] [ {\tilde{M}}_{i}^{a} ] … [ {\tilde{M}}_{1}^{a} ] \{ \begin{matrix}{U}_{a} ( 0 ) \\ {φ}_{a} ( 0 ) \\ {Q}_{a} ( 0 ) \\ {M}_{a} ( 0 )\end{matrix} \}$$

where L₂ is the length of the pile body in soil;

[\tilde{M}^{a}]=[\tilde{M}ₙ^{a}][\tilde{M}ₙ₋₁^{a}][\tilde{M}ᵢ^{a}] . . . [\tilde{M}₁^{a}], this matrix is the transfer matrix;

let

$$[ {\tilde{M}}^{a} ] = [ \begin{matrix}{\tilde{M}}_{11}^{a} & {\tilde{M}}_{12}^{a} \\ {\tilde{M}}_{21}^{a} & {\tilde{M}}_{22}^{a}\end{matrix} ]$$

the above formula is expressed as follows:

$$\{ \begin{matrix}{U}_{a} ( {L}_{2} ) \\ {φ}_{a} ( {L}_{2} )\end{matrix} \} = [ {\tilde{M}}_{11}^{a} ] \{ \begin{matrix}{u}_{a} ( 0 ) \\ {φ}_{a} ( 0 )\end{matrix} \} + [ {\tilde{M}}_{12}^{a} ] \{ \begin{matrix}{Q}_{a} ( 0 ) \\ {M}_{a} ( 0 )\end{matrix} \}$$

$$\{ \begin{matrix}{Q}_{a} ( {L}_{2} ) \\ {M}_{a} ( {L}_{2} )\end{matrix} \} = [ {\tilde{M}}_{21}^{a} ] \{ \begin{matrix}{u}_{a} ( 0 ) \\ {φ}_{a} ( 0 )\end{matrix} \} + [ {\tilde{M}}_{22}^{a} ] \{ \begin{matrix}{Q}_{a} ( 0 ) \\ {M}_{a} ( 0 )\end{matrix} \}$$

it is assumed that the boundary condition of the pile bottom is a fixed end and the pile top is a free end, then:

$$\{ \begin{matrix}{U}_{a} ( {L}_{2} ) \\ {φ}_{a} ( {L}_{2} )\end{matrix} \} = \{ \begin{matrix}0 \\ 0\end{matrix} \}$$

the above formula is organized, it is obtained that:

$$\{ \begin{matrix}{U}_{a} ( 0 ) \\ {φ}_{a} ( 0 )\end{matrix} \} = {[ - {\tilde{M}}_{11}^{a} ]}^{- 1} [ {\tilde{M}}_{12}^{a} ] \{ \begin{matrix}{Q}_{a} ( 0 ) \\ {M}_{a} ( 0 )\end{matrix} \} = [ {K}_{S} ] \{ \begin{matrix}{Q}_{a} ( 0 ) \\ {M}_{a} ( 0 )\end{matrix} \}$$

$$[ {K}_{S} ] = - {[ {\tilde{M}}_{11}^{a} ]}^{- 1} [ {\tilde{M}}_{12}^{a} ]$$

[K_{S}] is the impedance function matrix of the pile top;

$$[ {K}_{S} ] = [ \begin{matrix}{K}_{S 11} & {K}_{S 12} \\ {K}_{S 21} & {K}_{S 22}\end{matrix} ]$$

the above formula is organized, it is obtained that:

Uₐ(0)=K_{S}(1,1)Qₐ(0)+K_{S}(1,2)Mₐ(0)

φₐ(0)=K_{S}(2,1)Qₐ(0)+K_{S}(2,2)Mₐ(0)

finally, when calculating the total displacement and the total rotation angle of the pile top, the displacements of the pile top of the part in the soil Uₐ(0) and φₐ(0) are regarded as the displacement of the pile bottom in the part of the pile body exposed to the soil to obtain:

$$\{ \begin{matrix}{U}_{a}^{′} ( 0 ) - {E}_{u} ( 0 ) \\ {φ}_{a}^{′} ( 0 ) - {E}_{φ} ( 0 ) \\ {Q}_{a}^{′} ( 0 ) - {E}_{Q} ( 0 ) \\ {M}_{a}^{′} ( 0 ) - {E}_{M} ( 0 )\end{matrix} \} = {[ {\overline{N}}^{a} ]}^{- 1} \{ \begin{matrix}{U}_{a} ( 0 ) - {E}_{u} ( {L}_{1} ) \\ {φ}_{a} ( 0 ) - {E}_{φ} ( {L}_{1} ) \\ {Q}_{a} ( 0 ) - {E}_{Q} ( {L}_{1} ) \\ {M}_{a} ( 0 ) - {E}_{M} ( {L}_{1} )\end{matrix} \}$$

the above formula is the displacement, the rotation angle, the shear force and the bending moment of the final pile top obtained by combining the dynamic response of the two parts of the pile body;

according to the definition of the horizontal impedance of the single pile, the calculation formula of the single pile impedance is obtained as shown in the following formula:

$${R}_{K} = \frac{{Q}_{a} ( 0 )}{{u}_{a} ( 0 )} = \frac{{Q}_{a} ( 0 )}{{K}_{S} ( 1 , 1 ) {Q}_{a} ( 0 ) + {K}_{S} ( 1 , 2 )} = {K}_{K} + i {a}_{0} {C}_{K}$$

where the impedance R_{K} consists of a real part and an imaginary part, the real part K_{K} is the dynamic stiffness of a single pile in the horizontal direction, and the imaginary part C_{K} is the horizontal dynamic damping of a single pile;

(4) establishment of pile groups model:

4-1) model analysis of pile groups:

ψ(s,θ) is set as the attenuation function of soil stress wave, f′_{z} is set as the wave load borne by the passive pile, and the other parameters have the same meaning as the single pile; the attenuation function ψ(s,θ) is calculated as follows:

$$ψ ( s , θ ) = ψ ( s , 0 ) {cos}^{2} θ + ψ ( s , \frac{π}{2} ) {sin}^{2} θ$$

$$where ψ ( s , 0 ) = {\sqrt{\frac{{r}_{p}}{s} e}}^{\frac{ω ( η + i ) ( s - {r}_{p} )}{{V}_{L a}}} , ψ ( s , \frac{π}{2} ) = {\sqrt{\frac{{r}_{p}}{s} e}}^{\frac{ω ( η + i ) ( s - {r}_{p} )}{{V}_{si}}}$$

here s is the pile spacing, θ is the included angle between piles; V_{La} is the Lysmer simulation wave velocity of soil, which is calculated as follows:

$${V}_{L a} = \frac{3.4 {V}_{S i}}{π ( 1 - {ν}_{si} )}$$

where Vₛᵢ is the shear wave velocity of soil, and vₛᵢ is the Poisson's ratio of soil;

the displacement when the stress wave caused by vibration of the active pile is sent is Uₐᵢ(z, t), and according to the loss of the stress wave in soil, the displacement attenuation after reaching the passive pile is:

Uₐₛuₐₛ(z)e^{iωt}=ψ(s,θ)uₐᵢ(z)e^{iωt}

it is assumed that the displacement of the passive pile is U_{bi}(z,t), which is written in the form of U_{bi}(z,t)=U_{bi}(z)e^{iwt} for the convenience of calculation, and the vibration balance equation of the passive pile is as follows:

the vibration balance equation of the part of the pile body in water;

$$E i \frac{\partial {U}_{bi} ( z , t )}{\partial {z}^{4}} + {ρ}_{ρ} {A}_{ρ} \frac{{\partial }^{2} {U}_{bi} ( z , t )}{\partial {t}^{2}} + {c}_{xi}^{′} \frac{\partial {U}_{bi} ( z , t )}{\partial t} + {N}_{i} ( z ) \frac{{\partial }^{2} {U}_{bi} ( z , t )}{\partial {z}^{2}} = {f}_{z}^{′} ( z )$$

the vibration balance equation of the part of the pile body in soil;

$${E}_{P} {I}_{P} \frac{{d}^{4} {u}_{bi} ( z )}{d {z}^{4}} - ( {t}_{gxi} - {N}_{i} ( z ) ) \frac{{d}^{2} {u}_{bi} ( z )}{d {z}^{2}} - {ρ}_{ρ} {A}_{ρ} {ω}^{2} {u}_{bi} ( z ) = ( {k}_{xi} + i ω {c}_{xi} ) ( {ψ}_{i} ( s , θ ) {u}_{ai} ( z ) - {u}_{bi} ( z ) )$$

compared with the active pile, the value of the wave load f_{z} of the passive pile is slightly different, because the positions of the active pile and the passive pile are different, and the wave crest is uncapable of acting on each pile at the same time; in addition, the interaction between piles leads to asymmetry of vortices and interaction between vortices, so as to lead to different loads on each pile; at the same time, considering the influence of other factors, in the calculation of this step, the wave load borne by the passive pile is calculated according to f′_{z}=0.8 f_{z};

the calculation process of the above formula is as follows:

first let

$${φ}_{i} ( s , θ ) = \frac{( {k}_{xi} + i ω {c}_{xi} )}{{E}_{p} {I}_{p}} {ψ}_{i} ( s , θ )$$

the above formula is expressed as:

$$\frac{{d}^{4} {u}_{bi} ( z )}{d {z}^{4}} - {ζ}_{1} \frac{{d}^{2} {u}_{bi} ( z )}{d {z}^{2}} - {ζ}_{2} {u}_{bi} ( z ) = φ ( s , θ ) {u}_{ai} ( z )$$

$$where$$

$${ζ}_{1} = {( \frac{{δ}_{i}}{{h}_{i}} )}^{2} , {ζ}_{2} = {( \frac{{\overline{ω}}_{i}}{{h}_{i}} )}^{4} ,$$

the general solution of the above formula is expresses as:

$${u}_{bi} ( z ) = {A}_{2 i} ch \frac{{ζ}_{1 i}}{{h}_{i}} z + {B}_{2 i} s h \frac{{ζ}_{1 i}}{{h}_{i}} z + {C}_{2 i} cos \frac{{ζ}_{2 i}}{{h}_{i}} z + {D}_{2 i} sin \frac{{ζ}_{2 i}}{{h}_{i}} z + z {α}_{i} ( {A}_{1 i} sinh \frac{{ζ}_{1 i}}{{h}_{i}} z + {B}_{1 i} cosh \frac{{ζ}_{1 i}}{{h}_{i}} z ) + z {β}_{i} ( - {C}_{1 i} sin \frac{{ζ}_{2 i}}{{h}_{i}} z + {D}_{1 i} cos \frac{{ζ}_{2 i}}{{h}_{i}} z )$$

$$where$$

$${α}_{i} = \frac{φ ( s , θ )}{2 \frac{{ζ}_{1 i}}{{h}_{i}} [ 2 {( \frac{{ζ}_{1 i}}{{h}_{i}} )}^{2} - {( \frac{{δ}_{i}}{{h}_{i}} )}^{2} ]} , {β}_{i} = \frac{φ ( s , θ )}{2 \frac{{ζ}_{2 i}}{{h}_{i}} [ 2 {( \frac{{ζ}_{2 i}}{{h}_{i}} )}^{2} - {( \frac{{δ}_{i}}{{h}_{i}} )}^{2} ]} ,$$

in the soil layer unit, the relationship between the rotation angle of the cross section φ_{bi}(z) , the bending moment M_{bi}(z), the shear force Q_{bi}(z) and the lateral displacement u_{bi}(z) of the cross section of each pile foundation has the same calculation process as that of a single pile, which is expressed in the form of matrix as follows:

$$\{ \begin{matrix}{u}_{bi} ( L ) \\ {φ}_{bi} ( L ) \\ {Q}_{bi} ( L ) \\ {M}_{bi} ( L )\end{matrix} \} = [ {\tilde{M}}_{i}^{a} ] \{ \begin{matrix}{u}_{bi} ( 0 ) \\ {φ}_{bi} ( 0 ) \\ {Q}_{bi} ( 0 ) \\ {M}_{bi} ( 0 )\end{matrix} \} + [ {\tilde{M}}_{i}^{b} ] \{ \begin{matrix}{u}_{ai} ( 0 ) \\ {φ}_{ai} ( 0 ) \\ {Q}_{ai} ( 0 ) \\ {M}_{ai} ( 0 )\end{matrix} \}$$

where [\tilde{M}ᵢ^{a}] d is the same as the calculation of a single pile, but the calculation of [\tilde{M}ᵢ^{b}] is slightly complicated, as shown in the following formula:

$$[ {\tilde{M}}_{i}^{b} ] = - {{{{[ {\tilde{m}}_{i}^{a} ]}_{z = {h}_{i}} [ {\tilde{m}}_{i}^{a} ]}_{z = 0}^{- 1} [ {\tilde{m}}_{i}^{b} ]}_{z = 0} [ {\tilde{m}}_{i}^{a} ]}_{z = 0}^{- 1} + {{[ {\tilde{m}}_{i}^{b} ]}_{z = {h}_{i}} [ {\tilde{m}}_{i}^{a} ]}_{z = 0}^{- 1}$$

$$where$$

$$[ {\tilde{m}}_{i}^{b} ] = \{ \begin{matrix}{\tilde{m}}_{1 i}^{b} \\ {\tilde{m}}_{2 i}^{b} \\ {\tilde{m}}_{3 i}^{b} \\ {\tilde{m}}_{4 i}^{b}\end{matrix} \}$$

$${[ {\tilde{m}}_{1 i}^{b} ]}^{T} = [ \begin{matrix}{α}_{i} zsh \frac{{ζ}_{1 i}}{{h}_{i}} z \\ {α}_{i} zch \frac{{ζ}_{1 i}}{{h}_{i}} z \\ - {β}_{i} z sin \frac{{ζ}_{2 i}}{{h}_{i}} z \\ {β}_{j} z cos \frac{{ζ}_{2 i}}{{h}_{i}} z\end{matrix} ] ,$$

$${[ {\tilde{M}}_{2 i}^{b} ]}^{T} = [ \begin{matrix}{α}_{i} s h \frac{{ζ}_{1 i}}{{h}_{i}} z + {α}_{i} z \frac{{ζ}_{1 i}}{{h}_{i}} c h \frac{{ζ}_{1 i}}{{h}_{i}} z \\ {α}_{i} c h \frac{{ζ}_{1 i}}{{h}_{i}} z + {α}_{i} z \frac{{ζ}_{1 i}}{{h}_{i}} s h \frac{{ζ}_{1 i}}{{h}_{i}} z \\ - {β}_{j} sin \frac{{ζ}_{2 i}}{{h}_{i}} z - {β}_{i} z \frac{{ζ}_{2 i}}{{h}_{i}} cos \frac{{ζ}_{2 i}}{{h}_{i}} z \\ {β}_{i} cos \frac{{ζ}_{2 i}}{{h}_{i}} z - {β}_{i} z \frac{{ζ}_{2 i}}{{h}_{i}} sin \frac{{ζ}_{2 i}}{{h}_{i}} z\end{matrix} ]$$

$${[ {\tilde{m}}_{3 i}^{b} ]}^{T} = [ \begin{matrix}{E}_{p} {I}_{p} ( 3 {α}_{i} \frac{{ζ}_{1 i}^{2}}{{h}_{i}^{2}} s h \frac{{ζ}_{1 i}}{{h}_{i}} z + {α}_{i} z \frac{{ζ}_{1 i}^{3}}{{h}_{i}^{3}} c h \frac{{ζ}_{1 i}}{{h}_{i}} z ) \\ {E}_{p} {I}_{p} ( 3 {α}_{i} \frac{{ζ}_{1 i}^{2}}{{h}_{i}^{2}} c h \frac{{ζ}_{1 i}}{{h}_{i}} z + {α}_{i} z \frac{{ζ}_{1 i}^{3}}{{h}_{i}^{3}} s h \frac{{ζ}_{1 i}}{{h}_{i}} z ) \\ {E}_{p} {I}_{p} ( 3 {β}_{i} \frac{{ζ}_{2 i}^{2}}{{h}_{i}^{2}} sin \frac{{ζ}_{2 i}}{{h}_{i}} z + {β}_{i} z \frac{{ζ}_{2 i}^{3}}{{h}_{i}^{3}} cos \frac{{ζ}_{2 i}}{{h}_{i}} z ) \\ {E}_{p} {I}_{p} ( - 3 {β}_{i} \frac{{ζ}_{2 i}^{2}}{{h}_{i}^{2}} cos \frac{{ζ}_{2 i}}{{h}_{i}} z + {β}_{i} z \frac{{ζ}_{2 i}^{3}}{{h}_{i}^{3}} sin \frac{{ζ}_{2 i}}{{h}_{i}} z )\end{matrix} ]$$

$${[ {\tilde{m}}_{4 i}^{b} ]}^{T} = [ \begin{matrix}{E}_{p} {I}_{p} ( 2 {α}_{i} \frac{{ζ}_{1 i}}{{h}_{i}^{2}} s h \frac{{ζ}_{1 i}}{{h}_{i}} z + {α}_{i} z \frac{{ζ}_{1 i}^{2}}{{h}_{i}^{2}} c h \frac{{ζ}_{1 i}}{{h}_{i}} z ) \\ {E}_{p} {I}_{p} ( 2 {α}_{i} \frac{{ζ}_{1 i}}{{h}_{i}} c h \frac{{ζ}_{1 i}}{{h}_{i}} z + {α}_{i} z \frac{{ζ}_{1 i}^{2}}{{h}_{i}^{2}} s h \frac{{ζ}_{1 i}}{{h}_{i}} z ) \\ {E}_{p} {I}_{p} ( 2 {β}_{i} \frac{{ζ}_{2 i}}{{h}_{i}^{2}} cos \frac{{ζ}_{2 i}}{{h}_{i}} z + {β}_{i} z \frac{{ζ}_{2 i}^{2}}{{h}_{i}^{2}} sin \frac{{ζ}_{2 i}}{{h}_{i}} z ) \\ {E}_{p} {I}_{p} ( - 2 {β}_{i} \frac{{ζ}_{2 i}}{{h}_{i}^{2}} sin \frac{{ζ}_{2 i}}{{h}_{i}} z + {β}_{i} z \frac{{ζ}_{2 i}^{2}}{{h}_{i}^{2}} cos \frac{{ζ}_{2 i}}{{h}_{i}} z )\end{matrix} ]$$

according to the transfer matrix, the displacement, the rotation angle, the shear force and the bending moment of each soil layer are linked, as shown in the following formula, and the organized transfer matrix is:

$$\{ \begin{matrix}{u}_{b} ( {L}_{2} ) \\ {φ}_{b} ( {L}_{2} ) \\ {Q}_{b} ( {L}_{2} ) \\ {M}_{b} ( {L}_{2} )\end{matrix} \} = [ {\tilde{M}}^{a} ] \{ \begin{matrix}{u}_{b} ( 0 ) \\ {φ}_{b} ( 0 ) \\ {Q}_{b} ( 0 ) \\ {M}_{b} ( 0 )\end{matrix} \} + [ {\tilde{M}}^{b} ] \{ \begin{matrix}{u}_{a} ( 0 ) \\ {φ}_{a} ( 0 ) \\ {Q}_{a} ( 0 ) \\ {M}_{a} ( 0 )\end{matrix} \}$$

$$where [ {\tilde{M}}^{a} ] = [ {\tilde{M}}_{n}^{a} ] [ {\tilde{M}}_{n - 1}^{a} ] … [ {\tilde{M}}_{1}^{a} ]$$

$$[ {\tilde{M}}^{b} ] = {\sum }_{j = 1}^{n} [ {\tilde{M}}_{n}^{a} ] … [ {\tilde{M}}_{j + 1}^{a} ] [ [ {\tilde{M}}_{j}^{a} ] [ {\tilde{M}}_{j - 1}^{a} ] … [ {\tilde{M}}_{1}^{a} ]$$

$$[ {\tilde{M}}^{b} ] = [ \begin{matrix}{\tilde{M}}_{11}^{b} & {\tilde{M}}_{12}^{b} \\ {\tilde{M}}_{21}^{b} & {\tilde{M}}_{22}^{b}\end{matrix} ]$$

the above formula is expressed as:

$$\{ \begin{matrix}{u}_{b} ( L ) \\ {φ}_{b} ( L )\end{matrix} \} = [ {\tilde{M}}_{11}^{a} ] \text{} \{ \begin{matrix}{U}_{b} ( 0 ) \\ {φ}_{b} ( 0 )\end{matrix} \} + [ \text{} {\tilde{M}}_{12}^{a} ] \text{} \{ \begin{matrix}{Q}_{b} ( 0 ) \\ {M}_{b} ( 0 )\end{matrix} \} + [ \text{} {\tilde{M}}_{11}^{b} ] \{ \begin{matrix}{U}_{a} ( 0 ) \\ {φ}_{a} ( 0 )\end{matrix} \} + [ {\tilde{M}}_{12}^{b} ] \{ \begin{matrix}{Q}_{a} ( 0 ) \\ {M}_{a} ( 0 )\end{matrix} \}$$

$$\{ \begin{matrix}{Q}_{b} ( L ) \\ {M}_{b} ( L )\end{matrix} \} = [ {\tilde{M}}_{21}^{a} ] \{ \begin{matrix}{U}_{b} ( 0 ) \\ {φ}_{b} ( 0 )\end{matrix} \} + [ \text{} {\tilde{M}}_{22}^{a} ] \{ \begin{matrix}{Q}_{b} ( 0 ) \\ {M}_{b} ( 0 )\end{matrix} \} + [ {\tilde{M}}_{21}^{b} ] \{ \begin{matrix}{U}_{a} ( 0 ) \\ {φ}_{a} ( 0 )\end{matrix} \} + [ {\tilde{M}}_{22}^{b} ] \{ \begin{matrix}{Q}_{a} ( 0 ) \\ {M}_{a} ( 0 )\end{matrix} \}$$

according to the model, it is assumed that the boundary condition is that the pile top is fixed, so:

$$\{ \begin{matrix}{U}_{b} ( L ) \\ {φ}_{b} ( L )\end{matrix} \} = 0$$

then the boundary conditions are substituted into the above formula to obtain:

$$\{ \begin{matrix}{U}_{b} ( L ) \\ {φ}_{b} ( L )\end{matrix} \} = [ {μ}_{v} ( s , θ ) ] \{ \begin{matrix}{u}_{a} ( 0 ) \\ {φ}_{0} ( 0 )\end{matrix} \}$$

$$where [ {μ}_{v} ( s , θ ) ] = - {[ {\tilde{M}}_{11}^{a} ]}^{- 1} ( [ {\tilde{M}}_{11}^{b} ] + [ {\tilde{M}}_{12}^{b} ] [ {[ {\tilde{M}}_{12}^{a} ]}^{- 1} - [ {\tilde{M}}_{11}^{a} ] \text{} ) \text{}$$

[μᵥ(s,θ)] is the interaction matrix between the active pile and the passive pile;

according to the definition of the interaction factor, it is obtained that:

the horizontal interaction factor of pile groups is:

$${β}_{up} = \frac{{U}_{b} ( 0 )}{{U}_{a} ( 0 )} = \frac{{μ}_{v} ( 1 , 1 ) {K}_{S} ( 1 , 1 ) + {μ}_{v} ( 1 , 2 ) {K}_{S} ( 2 , 1 )}{{K}_{S} ( 1 , 1 )}$$

the shaking interaction factor of pile groups is:

$${β}_{φ M} = \frac{{φ}_{b} ( 0 )}{{φ}_{a} ( 0 )} = \frac{{μ}_{v} ( 2 , 1 ) {K}_{S} ( 1 , 2 ) + {μ}_{v} ( 2 , 2 ) {K}_{S} ( 2 , 2 )}{{K}_{S} ( 2 , 2 )}$$

the total displacement and the rotation angle parameters of the pile top of pile groups have the same calculation method as those of a single pile, specifically as follows:

$$\{ \begin{matrix}{U}_{b}^{′} ( 0 ) - {E}_{u} ( 0 ) \\ {φ}_{b}^{′} ( 0 ) - {E}_{φ} ( 0 ) \\ {Q}_{b}^{′} ( 0 ) - {E}_{Q} ( 0 ) \\ {M}_{b}^{′} ( 0 ) - {E}_{M} ( 0 )\end{matrix} \} = {[ {\overline{N}}^{a} ]}^{- 1} \{ \begin{matrix}{U}_{b} ( 0 ) - {E}_{u} ( {L}_{1} ) \\ {φ}_{b} ( 0 ) - {E}_{φ} ( {L}_{1} ) \\ {Q}_{b} ( 0 ) - {E}_{Q} ( {L}_{1} ) \\ {M}_{b} ( 0 ) - {E}_{M} ( {L}_{1} )\end{matrix} \}$$

4-2) impedance analysis of pile groups:

the calculation of the horizontal impedance of pile groups is as follows, assuming that the number of pile groups is n, and the horizontal displacement u^{G} of pile groups is equal to the horizontal displacement uᵢ^{G} of each single pile, namely

$${u}^{G} = {u}_{i}^{G} = {\sum }_{j = 1}^{n} {u}_{ij}^{G} ( i , j = 1 , 2 , 3 … , n )$$

assuming that the influence factor of the active pile j on the passive pile i is χᵢⱼ, the load borne by pile j in pile groups is Pⱼ, and according to the relationship between load, impedance and displacement:

$${\sum }_{j = 1}^{n} {χ}_{ij} {P}_{j} = {R}_{K} {u}^{G} , {P}^{G} = {\sum }_{j = 1}^{n} {P}_{j} , {χ}_{ij} = 1 when i = k$$

where R_{K} is the impedance of a single pile;

the horizontal dynamic impedance of pile groups is:

$${R}^{G} = \frac{{P}^{G}}{{u}^{G}} = {K}^{G} + i {a}_{0} {C}^{G}$$

K^{G} is the horizontal dynamic stiffness of pile groups; C^{G} is the horizontal dynamic damping of pile groups.

A system for analyzing dynamic response and dynamic impedance of pile groups, comprising:

a storage subsystem, which is configured to store a computer program;

an information processing subsystem, which is configured to realize the steps of the method for analyzing dynamic response and dynamic impedance of pile groups according to the present disclosure when executing the computer program.

According to the “dynamic response” of the present disclosure, the displacement and rotation angle of the pile top of pile groups can be calculated under the action of a horizontal dynamic load (wave force). Therefore, in the practical engineering design, the displacement and rotation angle calculated by the method can be used as control conditions for the instable failure of pile groups, so as to ensure the safety and reliability of the pile foundation in service.

Dynamic impedance is mainly reflected in pile groups, which refers to the constraint of soil around piles, which varies with the distance between piles and is more complex than a single pile. Therefore, the calculated impedance of pile groups can be used to optimize the most reasonable pile spacing in the practical engineering design, so that the bearing force of piles can be optimized. The engineering cost can be reduced correspondingly while ensuring the structural safety.

Compared with the prior art, the present disclosure has the following obvious prominent substantive characteristics and obvious advantages.

1. The dynamic stability equation of active piles and passive piles is established by combining an interaction factor method and a matrix transfer method, the dynamic interaction factor between adjacent piles and impedance of pile groups are obtained, and the stability of pile groups is analyzed by parameters. The improved Vlasov foundation model in the present disclosure can accurately conform to the engineering practice.

2. The interaction factor superposition method according to the present disclosure, which has a simple derivation process and a less calculation amount, is a more suitable method for calculating the dynamic response and dynamic impedance of pile groups at present. The continuous characteristics between soils are considered in the calculation of the present disclosure, and the improved Vlasov foundation model is used to calculate the foundation reaction force of soil, and the calculation expense is obviously reduced.

3. The method of the present disclosure can reduce the cost, can accurately conform to the engineering practice, and is suitable for popularization and use.

### BRIEF DESCRIPTION OF THE DRAWINGS

FIG. 1 is a model diagram of active pile A according to the present disclosure.

FIG. 2 is a model diagram of pile-soil interaction of the Vlasov foundation model according to the present disclosure.

FIG. 3 is a flowchart of iterative calculation according to the present disclosure.

FIG. 4 is a model diagram of pile groups according to the present disclosure.

FIG. 5 is a position diagram of an active pile and a passive pile according to the present disclosure.

FIG. 6 is a schematic diagram of 2×2 pile groups according to the present disclosure.

FIG. 7 shows the interaction factor-real part of pile groups according to the present disclosure.

FIG. 8 shows the interaction factor-imaginary part of pile groups according to the present disclosure.

FIG. 9 shows the stiffness of a real part of impedance of pile groups according to the present disclosure.

FIG. 10 shows the stiffness of an imaginary part of impedance of pile groups according to the present disclosure.

FIG. 11 is a graph showing the change of the stiffness of a real part of impedance of pile groups with the elastic modulus ratio of a soil layer according to the present disclosure.

FIG. 12 is a graph showing the change of impedance of an imaginary part of pile groups with elastic modulus ratio of a soil layer according to the present disclosure.

FIG. 13 is a graph showing the change of the real part of impedance of pile groups of different foundation models according to the present disclosure.

FIG. 14 is a graph showing the change of the imaginary part of impedance of pile groups of different foundation models according to the present disclosure.

FIG. 15 is a graph showing the change of a horizontal dynamic interaction factor with a₀ and s/d according to the present disclosure.

FIG. 16 is a graph showing the change of a horizontal dynamic interaction factor with a₀ and s/d according to the present disclosure.

FIG. 17 is a diagram showing the influence of wave height on displacement response u of pile groups according to the present disclosure.

FIG. 18 is a diagram showing the influence of wavelength on displacement response u of pile groups according to the present disclosure.

### DETAILED DESCRIPTION OF THE EMBODIMENTS

The above scheme will be further explained with specific examples, and the preferred embodiments of the present disclosure are detailed as follows.

### Embodiment 1

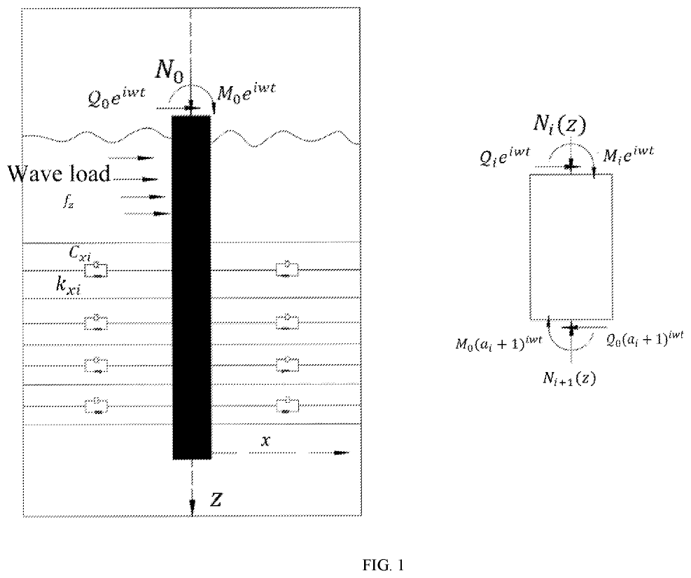

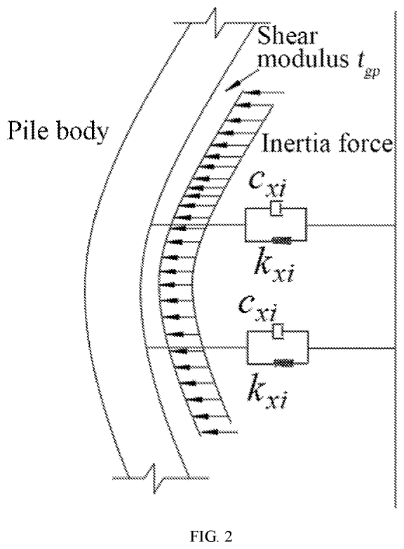

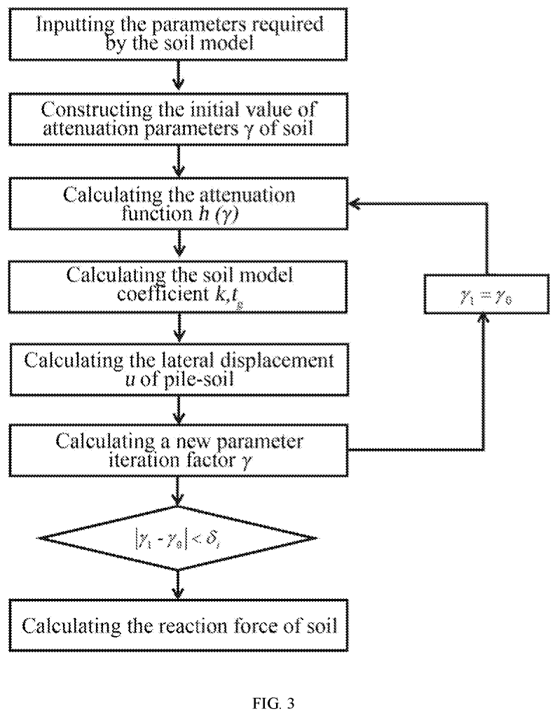

In this embodiment, referring to FIGS. 1-2, according to the method for analyzing dynamic response and dynamic impedance of pile groups, the foundation reaction force is calculated by using an improved Vlasov foundation model, the dynamic stability equation of active piles and passive piles is established by combining an interaction factor method and a matrix transfer method, the dynamic interaction factor between adjacent piles and impedance of pile groups are obtained, and the stability of pile groups is analyzed by parameters to obtain dynamic response and dynamic impedance of pile groups.

In this embodiment, the stability of pile groups is analyzed by parameters. The improved Vlasov foundation model in the present disclosure can accurately conform to the engineering practice.

### Embodiment 2

This embodiment is basically the same as the first embodiment with the following special features.

In this embodiment, the method for analyzing dynamic response and dynamic impedance of pile groups according to the present disclosure comprises the following steps:

(1) parameter selection

the dynamic interaction between pile-soil-pile is an important part of analyzing the dynamic response of pile groups, through the analysis of the dynamic interaction between pile groups, the relationship between active pile-soil-passive pile is obtained, the dynamic response of pile groups is analyzed continuously, and the analysis of dynamic interaction starts with active piles first; as shown in FIG. 1 below, FIG. 1 is a schematic diagram of the model of an active pile A;

The dynamic analysis model of an active pile is as follows:

N₀ is set as the vertical static load of the pile top, Q₀e^{iwt} is set as the initial horizontal harmonic load of the pile top, M₀e^{iwt} is set as the initial bending moment of the pile top, and f_{z} is set as the wave load:

$${f}_{z} = \frac{2 ρ gH}{K} \cdot \frac{ch ( {Kz}_{1} )}{ch ( {Kd}_{L} )} {f}_{A} \cdot cos ( ω t ) \\ where k = \frac{2 π}{L} ,$$

L is the wavelength;

$$ω = \frac{2 π}{T} ,$$

T is the wave period, and ρ is the density of seawater, which is 1030 kg/m³;

g is the acceleration of gravity, which is 9.8 m/s²; H is the wave height; α is the phase angle; z₁ is the water depth, d_{L} is the water entry depth of the pile body and does not include the soil buried part;

$${f}_{A} = \frac{1}{\sqrt{{[ {J}_{1}^{′} ( π D / L ) ]}^{2} + {[ {Y}_{1}^{′} ( π D / L ) ]}^{2}}} ,$$

J, is the first-order Bessel function of the first kind, Y′₁ is the first order;

according to the model, the motion balance equation of the soil layer is obtained as follows:

$$\{ \begin{matrix}\frac{\partial {Q}_{ai} ( z , t )}{\partial z} - ( {k}_{xi} {U}_{ai} ( z , t ) + {c}_{xi} \frac{\partial {U}_{ai} ( z , t )}{\partial t} - {t}_{gxi} \frac{{\partial }^{2} {U}_{ai} ( z , t )}{\partial {z}^{2}} + \\ {N}_{0} \frac{{\partial }^{2} {U}_{ai} ( z , t )}{\partial {z}^{2}} ) = {ρ}_{p} {A}_{P} \frac{{\partial }^{2} {U}_{ai} ( z , t )}{\partial {t}^{2}} \\ \frac{\partial {M}_{ai} ( z , t )}{\partial z} + {Q}_{ai} ( z , t ) = {f}_{z} ( z , t )\end{matrix}$$

where kₓᵢ is the stiffness coefficient of soil beside the pile, t_{gxi} is the continuity coefficient of soil beside the pile, cₓᵢ is the damping coefficient of soil, A_{ρ} is the circular cross-sectional area of the pile, ρ_{ρ} is the bulk density of the pile, Qₐᵢ (z,t) and Mₐᵢ(z,t) are the cross-sectional shear force and bending moment of the active pile; because pile group involves the dynamic interaction between pile-soil-pile, in order to describe the interaction between piles and soil more accurately, the reaction force of soil is simulated based on the VLasov foundation model derived from a continuous medium model. The schematic diagram of the model is shown in FIG. 2;

according to the dynamic interaction between pile-soil-pile involved in pile group, the interaction between pile-soil is described, and the reaction force of soil is simulated based on the VLasov foundation model derived from a continuous medium model, the specific calculation formula is as follows:

$$q ( x ) = {k}_{i} w ( x ) - 2 {t}_{gi} {w}^{″} ( x ) \\ where \\ {k}_{i} = \frac{{E}_{0}}{1 - {v}_{0}^{2}} {\int }_{0}^{H} {( \frac{dh ( z )}{dz} )}^{2} dz \\ {t}_{gi} = \frac{{E}_{0}}{4 ( 1 - {v}_{0}^{2} )} {\int }_{0}^{H} {h ( z )}^{2} dz$$

h(z) is the parameters of the attenuation function of vertical displacement, Vallabhan and Das are used, the displacement function and the attenuation function are connected by using another new parameter γ, and the accurate expression of the displacement function and the attenuation function is obtained, which is referred to as an improved Vlasov foundation model; the improved Vlasov foundation model is used to calculate the foundation reaction force; according to Vallabhan and Das, the parameters of the foundation model based on the lateral displacement of the pile foundation are as follows:

$${k}_{V} = π ( {η}^{2} + 1 ) G \{ 2 γ \frac{{K}_{1} ( γ )}{{K}_{0} ( γ )} - {γ}^{2} [ {( \frac{{K}_{1} ( γ )}{{K}_{0} ( γ )} )}^{2} - 1 ] \} \\ {t}_{gp} = π G \{ {\frac{{γ}^{2}}{{{K}_{0} ( γ )}^{2}} [ {{K}_{1} ( γ )}^{2} - {{K}_{0} ( γ )}^{2} ]}^{2} - 2 γ {K}_{1} ( γ ) {K}_{0} ( γ ) \}$$

where η is lame constant,

G is the shear modulus of soil,

γ is the attenuation parameter, which is calculated by an iterative method,

K₀(·) is the zero-order modified Bessel function of the second kind;

K₁(·) is the first-order modified Bessel function of the second kind;

where

$$h ( γ ) = \frac{{K}_{0} ( 2 γ r / D )}{{K}_{0} ( γ )} ,$$

r is a variable in column coordinates;

the formula of a foundation soil reaction force q(x) is:

q(x)=k_{V}u(x)−2t_{gp}u′(x)

the damping of soil is calculated as follows:

$${c}_{xi} \approx 6 {ρ}_{i} {dV}_{si} / \sqrt[4]{{a}_{0}} + 2 {ξ}_{i} {k}_{xi} / ω$$

where ρᵢ is density of soil, d is the pile diameter, Vₛᵢ is the shear wave velocity in soil, ξᵢ is the damping ratio in soil, ω is the circular frequency of vibration, α₀2πfd/Vₛᵢ, and f is the frequency of load; from the above formula, cₓᵢ is consisted of two parts, that is, the energy loss comes from two parts, one part is the damping of the material, that is,

$$6 {ρ}_{i} {dV}_{si} / \sqrt[4]{{a}_{0}} ,$$

and the other part is the loss caused by the propagation of stress wave in soil during the vibration of the pile body, that is, 2ξᵢkₓᵢ/ω;

(2) establishment of model equation

the general form of the steady-state vibration equation of the pile body obtained by the motion balance equation of the pile body is as follows:

$$EI \frac{\partial {U}_{ai} ( z , t )}{\partial {z}^{4}} + {k}_{xi} {U}_{ai} ( z , t ) + {ρ}_{ρ} {A}_{ρ} \frac{{\partial }^{2} {U}_{ai} ( z , t )}{\partial {t}^{2}} + {c}_{xi} \frac{\partial {U}_{ai} ( z , t )}{\partial t} + ( {N}_{i} ( z ) - {t}_{gxi} ) \frac{{\partial }^{2} {U}_{ai} ( z , t )}{\partial {z}^{2}} = 0$$

considering that the pile foundation is partially embedded and fixed in the soil, the part of the pile body in the water bears the effect of the wave load without the constraint of the soil, the pile body is divided into two parts, the vibration equation of the part of the pile body in the soil is shown in the above formula, while the vibration equation of the part of the pile body exposed to the soil is shown in the following formula:

$$EI \frac{\partial {U}_{ai} ( z , t )}{\partial {z}^{4}} + {ρ}_{ρ} {A}_{ρ} \frac{{\partial }^{2} {U}_{ai} ( z , t )}{\partial {t}^{2}} + {c}_{xi}^{′} \frac{\partial {U}_{ai} ( z , t )}{\partial t} + {N}_{i} ( z ) \frac{{\partial }^{2} {U}_{ai} ( z , t )}{\partial {z}^{2}} = {f}_{z} ( z )$$

the displacement Uₐᵢ(z,t) of the pile body is expressed as: Uₐᵢ(z,t)=uₐᵢ(z)e^{iwt}, and the vibration equation becomes the following form:

the part of the pile body deep into soil:

$$\frac{{d}^{4} {u}_{ai} ( z )}{{dz}^{4}} - {m}_{1} \frac{{d}^{2} {u}_{ai} ( z )}{{dz}^{2}} - {m}_{2} {u}_{ai} ( z ) = 0$$

the part of the pile body in water:

$$\frac{{d}^{4} {u}_{ai} ( z )}{{dz}^{4}} - {m}_{3} \frac{{d}^{2} {u}_{ai} ( z )}{{dz}^{2}} - {m}_{4} {u}_{ai} ( z ) = {m}_{5} cosh ( {k}_{f} ( {d}_{L} - z ) ) \\ where \\ {m}_{1} = \frac{{δ}_{i}^{2}}{{h}_{i}^{2}} , {m}_{2} = \frac{{ϑ}_{i}^{4}}{{h}_{i}^{4}} , {m}_{3} = \frac{{N}_{i} ( z )}{{E}_{p} {I}_{p}} , \text{} {m}_{4} = \frac{{ρ}_{ρ} {A}_{ρ} {w}^{2} - {c}_{xi}^{′} \cdot i \cdot w}{{E}_{p} {I}_{p}} , {m}_{5} = \frac{2 ρ {gH}_{i}}{{k}_{fz} {E}_{p} {I}_{p}} {f}_{A} ,$$

d_{L} is the water depth;

where

$${δ}_{i} = {h}_{i} \sqrt{\frac{( {t}_{gxi} - {N}_{i} )}{{E}_{p} {I}_{p}}} , {ϑ}_{i} = {h}_{i} \sqrt[4]{\frac{{ρ}_{p} {A}_{p} {ω}^{2} - {k}_{xi} - {ic}_{xi} ω}{{E}_{p} {I}_{p}}} , {c}_{xi}^{′} = 6 {ρ}_{i} {dV}_{si} / \sqrt[4]{{a}_{0}}$$

hᵢ is the thickness of the i-th layer of soil;

then the general solution of the following form is obtained by solving the above high-order vibration differential equation:

$${U}_{1 i} ( z ) = {A}_{1 i} cosh ( \frac{{Ϛ}_{1 i}}{{h}_{i}} z ) + {B}_{1 i} sinh ( \frac{{Ϛ}_{1 i}}{{h}_{i}} z ) + {C}_{1 i} cos ( \frac{{Ϛ}_{2 i}}{{h}_{i}} z ) + {D}_{1 i} sin ( \frac{{Ϛ}_{2 i}}{{h}_{i}} z ) \\ where {Ϛ}_{1 i} = \sqrt{\frac{{δ}_{i}^{2}}{2} + \sqrt{\frac{{δ}_{i}^{4}}{4} + {ϖ}_{i}^{4}}} , {Ϛ}_{2 i} = \sqrt{- \frac{{δ}_{i}^{2}}{2} + \sqrt{\frac{{δ}_{i}^{4}}{4} + {ϖ}_{i}^{4}}} ,$$

A₁i, B₁ᵢ, C₁i, D₁i are the undetermined coefficients determined by boundary conditions;

the general solution of the above formula is:

$${U}_{1 i}^{′} ( z ) = {A}_{1 i}^{′} cosh ( {σ}_{1} z ) + {B}_{1 i}^{′} sinh ( {σ}_{1} z ) + \text{} {C}_{1 i}^{′} cos ( {σ}_{2} z ) + {D}_{1 i}^{′} sin ( {σ}_{2} z ) + {E}_{1} cosh [ {k}_{fz} ( {d}_{L} - z ) ] \\ where {σ}_{1} = z \sqrt{\frac{{m}_{3}}{2} + \frac{\sqrt{{m}_{3}^{2} + 4 {m}_{4}}}{2}} , {σ}_{2} = z \sqrt{\frac{\sqrt{{m}_{3}^{2} + 4 {m}_{4}}}{2} - \frac{{m}_{3}}{2}} ,$$

A′₁ᵢ, B′₁ᵢ, C′₁ᵢ, D′₁ᵢ, Eᵢ are also undetermined general solution coefficients, which are determined by the boundary conditions of the pile body, and E₁ is the wave load parameter, which is obtained by direct calculation;

(3) analysis of the part of the pile body exposed to soil, that is, analysis of the part of the pile body bearing the wave load:

the part of the pile body exposed to soil is regarded as a unit layer, which is similar to the division of a soil layer, and it is regarded as a layer, for the rotation angle of the cross section φ′(z), the shear force of the pile body Q′(z), the bending moment M′(z), and the horizontal displacement of the pile body:

the following relationship holds:

$${φ}_{1 i}^{′} ( z ) = {A}_{1 i}^{′} {σ}_{1} sinh ( {σ}_{1} z ) + {B}_{1 i}^{′} {σ}_{1} cosh ( {σ}_{1} z ) - {C}_{1 i}^{′} \frac{{ζ}_{2 i}}{{h}_{i}} sin ( {σ}_{2} z ) + {D}_{1 i}^{′} {σ}_{2} cos ( {σ}_{2} z ) - {k}_{f z} {E}_{1} sh ( {k}_{f} ( {d}_{L} - z ) ) \\ {Q}_{1 i}^{′} ( z ) = {E}_{P} {I}_{P} [ {σ}_{1}^{3} [ {A}_{1 i}^{′} sinh ( {σ}_{1} z ) + {B}_{1 i}^{′} cosh ( {σ}_{1} z ) ] + {σ}_{2}^{3} [ {C}_{1 i}^{′} sin ( {σ}_{2} z ) - {D}_{1 i}^{′} cos ( {σ}_{2} z ) ] - {k}_{f}^{3} {E}_{1} sh ( {k}_{f} ( {d}_{L} - z ) ) ] \\ {M}_{1 i}^{′} ( z ) = {E}_{P} {I}_{P} [ {σ}_{1}^{2} [ {A}_{1 i}^{′} cosh ( {σ}_{1} z ) + {B}_{1 i}^{′} sinh ( {σ}_{1} z ) ] - {σ}_{2}^{2} [ {C}_{1 i}^{′} cos ( {σ}_{2} z ) + {D}_{1 i}^{′} sin ( {σ}_{2} z ) ] + {k}_{f}^{2} {E}_{1} sh ( {k}_{f} ( {d}_{L} - z ) ) ]$$

it is organized into a matrix as shown in the following formula:

$$\{ \begin{matrix}{U}_{ai}^{′} \\ {φ}_{ai}^{′} \\ {Q}_{ai}^{′} \\ {M}_{ai}^{′}\end{matrix} \} = {n}_{i}^{a} \{ \begin{matrix}{A}_{1 i}^{′} \\ {B}_{1 i}^{′} \\ {C}_{1 i}^{′} \\ {D}_{1 i}^{′}\end{matrix} \} + [ \begin{matrix}{E}_{u} \\ {E}_{φ} \\ {E}_{Q} \\ {E}_{M}\end{matrix} ] ⇒ \{ \begin{matrix}{U}_{ai}^{′} - {E}_{u} \\ {φ}_{ai}^{′} - {E}_{φ} \\ {Q}_{ai}^{′} - {E}_{Q} \\ {M}_{ai}^{′} - {E}_{M}\end{matrix} \} = {n}_{i}^{a} \{ \begin{matrix}{A}_{1 i}^{′} \\ {B}_{1 i}^{′} \\ {C}_{1 i}^{′} \\ {D}_{1 i}^{′}\end{matrix} \} \\ {n}_{i}^{a} = [ \begin{matrix}cosh {σ}_{1} z & sinh {σ}_{1} z & cos {σ}_{2} z & sin {σ}_{2} z \\ {σ}_{1} sh {σ}_{1} z & {σ}_{1} c h {σ}_{1} z & - {σ}_{2} sin {σ}_{2} z & \frac{{ζ}_{2 i}}{{h}_{i}} cos \frac{{ζ}_{2 i}}{{h}_{i}} z \\ {E}_{p} {I}_{p} {σ}_{1}^{3} sinh {σ}_{1} z & {E}_{p} {I}_{p} {σ}_{1}^{3} cosh {σ}_{1} z & {E}_{p} {I}_{p} {σ}_{2}^{3} sin {σ}_{2} z & - {E}_{p} {I}_{p} {σ}_{2}^{3} cos {σ}_{2} z \\ {E}_{p} {I}_{p} {σ}_{1}^{2} cosh {σ}_{1} z & {E}_{p} {I}_{p} {σ}_{1}^{2} sinh {σ}_{1} z & - {E}_{p} {I}_{p} {σ}_{2}^{2} cos {σ}_{2} z & - {E}_{p} {I}_{p} {σ}_{2}^{2} sin {σ}_{2} z\end{matrix} ] \\ [ \begin{matrix}{E}_{u} \\ {E}_{φ} \\ {E}_{Q} \\ {E}_{M}\end{matrix} ] = {E}_{1} [ \begin{matrix}ch [ {k}_{f} ( {d}_{L} - z ) \\ - {k}_{f} \cdot sh ( {k}_{f} ( {d}_{L} - z ) ) \\ - {E}_{P} {I}_{P} {k}_{f}^{3} sinh ( {k}_{f} ( {d}_{L} - z ) ) \\ {E}_{P} {I}_{P} {k}_{f}^{2} cosh ( {k}_{f} ( {d}_{L} - z ) )\end{matrix} ] \\ {E}_{1} = \frac{- 2 \sqrt{2} \sqrt{{m}_{3} + \sqrt{{m}_{3}^{2} + 4 {m}_{4}}}}{\sqrt{{m}_{3}^{2} + 4 {m}_{4}} ( 4 {k}_{f}^{2} - 2 ( {m}_{3} + \sqrt{{m}_{3}^{2} + 4 {m}_{4}} ) ) {σ}_{1}} + \frac{- 2 \sqrt{2} \sqrt{{m}_{3} - \sqrt{{m}_{3}^{2} + 4 {m}_{4}}}}{\sqrt{{m}_{3}^{2} + 4 {m}_{4}} ( 4 {k}_{f}^{2} - 2 ( {m}_{3} + \sqrt{{m}_{3}^{2} + 4 {m}_{4}} ) ) {σ}_{2}}$$

z=0 at the ton of the vile and the following formula is obtained:

$$\{ \begin{matrix}{A}_{1 i}^{′} \\ {B}_{1 i}^{′} \\ {C}_{1 i}^{′} \\ {D}_{1 i}^{′}\end{matrix} \} = inv [ \begin{matrix}1 & 0 & 1 & 0 \\ 0 & {σ}_{1} & 0 & {σ}_{1} \\ 0 & {E}_{P} {I}_{P} {σ}_{1}^{3} & 0 & - {E}_{P} {I}_{P} {σ}_{2}^{3} \\ {E}_{P} {I}_{P} {σ}_{1}^{2} & 0 & - {E}_{P} {I}_{P} {σ}_{1}^{2} & 0\end{matrix} ] \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \} = {[ {n}_{i}^{a} ]}_{z = 0}^{- 1} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$

then, at the boundary of the part of the pile body in the water and the soil layer, let z=hᵢ to obtain:

$$\{ \begin{matrix}{U}_{ai}^{′} ( {h}_{i} ) - {E}_{u} ( {h}_{i} ) \\ {φ}_{ai}^{′} ( {h}_{i} ) - {E}_{φ} ( {h}_{i} ) \\ {Q}_{ai}^{′} ( {h}_{i} ) - {E}_{Q} ( {h}_{i} ) \\ {M}_{ai}^{′} ( {h}_{i} ) - {E}_{M} ( {h}_{i} )\end{matrix} \} = {[ {n}_{i}^{a} ]}_{z = {h}_{i}} \{ \begin{matrix}{A}_{1 i}^{′} \\ {B}_{1 i}^{′} \\ {C}_{1 i}^{′} \\ {D}_{1 i}^{′}\end{matrix} \} = \\ {{[ {n}_{i}^{a} ]}_{z = {h}_{i}} [ {n}_{i}^{a} ]}_{z = 0}^{- 1} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \} = {\overline{N}}^{a} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \} \\ {\overline{N}}^{a} = {{[ {n}_{i}^{a} ]}_{z = {h}_{i}} [ {n}_{i}^{a} ]}_{z = 0}^{- 1}$$

after the transformation of the matrix, the displacement of the top of the pile exposed to the soil is related to the displacement of the water-soil boundary, as shown in the following formula:

$$\{ \begin{matrix}{U}_{ai}^{′} ( {h}_{i} ) - {E}_{u} ( {h}_{i} ) \\ {φ}_{ai}^{′} ( {h}_{i} ) - {E}_{φ} ( {h}_{i} ) \\ {Q}_{ai}^{′} ( {h}_{i} ) - {E}_{Q} ( {h}_{i} ) \\ {M}_{ai}^{′} ( {h}_{i} ) - {E}_{M} ( {h}_{i} )\end{matrix} \} = {\overline{N}}^{a} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$

it is assumed that the pile length of the part exposed to the soil is L₁, the displacement, the rotation angle, the shear force and the bending moment of the pile bottom of the part exposed to the soil are shown in the following formula:

$$\{ \begin{matrix}{U}_{a}^{′} ( {L}_{1} ) - {E}_{u} ( {L}_{1} ) \\ {φ}_{a}^{′} ( {h}_{i} ) - {E}_{φ} ( {L}_{1} ) \\ {Q}_{a}^{′} ( {h}_{i} ) - {E}_{Q} ( {L}_{1} ) \\ {M}_{a}^{′} ( {h}_{i} ) - {E}_{M} ( {L}_{1} )\end{matrix} \} = {\overline{N}}^{a} \{ \begin{matrix}{U}_{a}^{′} ( 0 ) - {E}_{u} ( 0 ) \\ {φ}_{a}^{′} ( 0 ) - {E}_{φ} ( 0 ) \\ {Q}_{a}^{′} ( 0 ) - {E}_{Q} ( 0 ) \\ {M}_{a}^{′} ( 0 ) - {E}_{M} ( 0 )\end{matrix} \}$$

study of the part of the pile body in soil: according to the part of the pile body in soil which involves the constraint of soil and the stratification of soil, the specific calculation steps are as follows:

the displacement Uₐᵢ(z) of the pile body in soil is:

$${U}_{ai} ( z ) = {A}_{1 i} cosh ( \frac{{ζ}_{1 i}}{{h}_{i}} z ) + {B}_{1 i} sinh ( \frac{{ζ}_{1 i}}{{h}_{i}} z ) + {C}_{1 i} cos ( \frac{{ζ}_{2 i}}{{h}_{i}} z ) + {D}_{1 i} sin ( \frac{{ζ}_{2 i}}{{h}_{i}} z )$$

at this time, the displacement at the top of the pile becomes the displacement at the water-soil boundary, and the displacement at the bottom of the pile is the actual displacement at the bottom of the pile; the relationship between the shear force and the bending moment in the soil layer unit and the horizontal displacement of the pile body is as follows:

$${φ}_{ai} ( z ) = {A}_{1 i} \frac{{ζ}_{1 i}}{{h}_{i}} sinh ( \frac{{ζ}_{1 i}}{{h}_{i}} z ) + {B}_{1 i} \frac{{ζ}_{1 i}}{{h}_{i}} cosh ( \frac{{ζ}_{1 i}}{{h}_{i}} z ) - {C}_{1 i} \frac{{ζ}_{2 i}}{{h}_{i}} sin ( \frac{{ζ}_{2 i}}{{h}_{i}} z ) + {D}_{1 i} \frac{{ζ}_{2 i}}{{h}_{i}} cos ( \frac{{ζ}_{2 i}}{{h}_{i}} z ) \\ {Q}_{ai} ( z ) = {E}_{P} {I}_{P} \frac{{ζ}_{1 i}^{3}}{{h}_{i}^{3}} [ {A}_{1 i} sinh ( \frac{{ζ}_{1 i}}{{h}_{i}} z ) + {B}_{1 i} cosh ( \frac{{ζ}_{1 i}}{{h}_{i}} z ) ] + {E}_{P} {I}_{P} \frac{{ζ}_{2 i}^{3}}{{h}_{i}^{3}} [ {C}_{1 i} sin ( \frac{{ζ}_{2 i}}{{h}_{i}} z ) - {D}_{1 i} cos ( \frac{{ζ}_{2 i}}{{h}_{i}} z ) ] \\ \\ {M}_{ai} ( z ) = {E}_{P} {I}_{P} \frac{{ζ}_{1 i}^{2}}{{h}_{i}^{2}} [ {A}_{1 i} cos h ( \frac{{ζ}_{1 i}}{{h}_{i}} z ) + {B}_{1 i} sinh ( \frac{{ζ}_{1 i}}{{h}_{i}} z ) ] - {E}_{P} {I}_{P} \frac{{ζ}_{2 i}^{2}}{{h}_{i}^{2}} [ {C}_{1 i} cos ( \frac{{ζ}_{2 i}}{{h}_{i}} z ) + {D}_{1 i} sin ( \frac{{ζ}_{2 i}}{{h}_{i}} z ) ]$$

the above formula is organized into a matrix as shown in the following formula:

$$\{ \begin{matrix}{U}_{ai} \\ {φ}_{ai} \\ {Q}_{ai} \\ {M}_{ai}\end{matrix} \} = [ \begin{matrix}cosh \frac{{ζ}_{1 i}}{{h}_{i}} z & sinh \frac{{ζ}_{1 i}}{{h}_{i}} z & cos \frac{{ζ}_{2 i}}{{h}_{i}} z & sin \frac{{ζ}_{2 i}}{{h}_{i}} z \\ \frac{{ζ}_{1 i}}{{h}_{i}} sh \frac{{ζ}_{1 i}}{{h}_{i}} z & \frac{{ζ}_{1 i}}{{h}_{i}} ch \frac{{ζ}_{1 i}}{{h}_{i}} z & - \frac{{ζ}_{2 i}}{{h}_{i}} sin \frac{{ζ}_{2 i}}{{h}_{i}} z & \frac{{ζ}_{2 i}}{{h}_{i}} cos \frac{{ζ}_{1 i}}{{h}_{i}} z \\ {E}_{p} {I}_{p} \frac{{ζ}_{1 i}^{3}}{{h}_{i}^{3}} sinh \frac{{ζ}_{1 i}}{{h}_{i}} z & {E}_{p} {I}_{p} \frac{{ζ}_{1 i}^{3}}{{h}_{i}^{3}} cosh \frac{{ζ}_{1 i}}{{h}_{i}} z & {E}_{p} {I}_{p} \frac{{ζ}_{2 i}^{3}}{{h}_{i}^{3}} sin \frac{{ζ}_{2 i}}{{h}_{i}} z & - {E}_{p} {I}_{p} \frac{{ζ}_{2 i}^{3}}{{h}_{i}^{3}} cos \frac{{ζ}_{2 i}}{{h}_{i}} z \\ {E}_{p} {I}_{p} \frac{{ζ}_{1 i}^{2}}{{h}_{i}^{2}} cosh \frac{{ζ}_{1 i}}{{h}_{i}} z & {E}_{p} {I}_{p} \frac{{ζ}_{1 i}^{2}}{{h}_{i}^{2}} sinh \frac{{ζ}_{1 i}}{{h}_{i}} z & - {E}_{p} {I}_{p} \frac{{ζ}_{2 i}^{2}}{{h}_{i}^{2}} cos \frac{{ζ}_{2 i}}{{h}_{i}} z & - {E}_{p} {I}_{p} \frac{{ζ}_{2 i}^{2}}{{h}_{i}^{2}} sin \frac{{ζ}_{2 i}}{{h}_{i}} z\end{matrix} ] \{ \begin{matrix}{A}_{1 i} \\ {B}_{1 i} \\ {C}_{1 i} \\ {D}_{1 i}\end{matrix} \} \\ let \\ [ {\tilde{m}}_{i}^{a} ] = [ \begin{matrix}cosh \frac{{ζ}_{1 i}}{{h}_{i}} z & sinh \frac{{ζ}_{1 i}}{{h}_{i}} z & cos \frac{{ζ}_{2 i}}{{h}_{i}} z & sin \frac{{ζ}_{2 i}}{{h}_{i}} z \\ \frac{{ζ}_{1 i}}{{h}_{i}} sh \frac{{ζ}_{1 i}}{{h}_{i}} z & \frac{{ζ}_{1 i}}{{h}_{i}} ch \frac{{ζ}_{1 i}}{{h}_{i}} z & - \frac{{ζ}_{2 i}}{{h}_{i}} sin \frac{{ζ}_{2 i}}{{h}_{i}} z & \frac{{ζ}_{2 i}}{{h}_{i}} cos \frac{{ζ}_{1 i}}{{h}_{i}} z \\ {E}_{p} {I}_{p} \frac{{ζ}_{1 i}^{3}}{{h}_{i}^{3}} sinh \frac{{ζ}_{1 i}}{{h}_{i}} z & {E}_{p} {I}_{p} \frac{{ζ}_{1 i}^{3}}{{h}_{i}^{3}} cosh \frac{{ζ}_{1 i}}{{h}_{i}} z & {E}_{p} {I}_{p} \frac{{ζ}_{2 i}^{3}}{{h}_{i}^{3}} sin \frac{{ζ}_{2 i}}{{h}_{i}} z & - {E}_{p} {I}_{p} \frac{{ζ}_{2 i}^{3}}{{h}_{i}^{3}} cos \frac{{ζ}_{2 i}}{{h}_{i}} z \\ {E}_{p} {I}_{p} \frac{{ζ}_{1 i}^{2}}{{h}_{i}^{2}} cosh \frac{{ζ}_{1 i}}{{h}_{i}} z & {E}_{p} {I}_{p} \frac{{ζ}_{1 i}^{2}}{{h}_{i}^{2}} sinh \frac{{ζ}_{1 i}}{{h}_{i}} z & - {E}_{p} {I}_{p} \frac{{ζ}_{2 i}^{2}}{{h}_{i}^{2}} cos \frac{{ζ}_{2 i}}{{h}_{i}} z & - {E}_{p} {I}_{p} \frac{{ζ}_{2 i}^{2}}{{h}_{i}^{2}} sin \frac{{ζ}_{2 i}}{{h}_{i}} z\end{matrix} ]$$

it is assumed that z=0 at the top of the pile, that is, at the surface of the soil, it can be obtained that:

$$\{ \begin{matrix}{A}_{1 i} \\ {B}_{1 i} \\ {C}_{1 i} \\ {D}_{1 i}\end{matrix} \} = inv \{ \begin{matrix}1 & 0 & 1 & 0 \\ 0 & \frac{{ζ}_{1 i}}{{h}_{i}} & 0 & \frac{{ζ}_{1 i}}{{h}_{i}} \\ 0 & {E}_{P} {I}_{P} \frac{{ζ}_{1 i}^{3}}{{h}_{i}^{3}} & 0 & - {E}_{P} {I}_{P} \frac{{ζ}_{2 i}^{3}}{{h}_{i}^{3}} \\ {E}_{P} {I}_{P} \frac{{ζ}_{1 i}^{2}}{{h}_{i}^{2}} & 0 & - {E}_{P} {I}_{P} \frac{{ζ}_{2 i}^{2}}{{h}_{i}^{2}} & 0\end{matrix} \} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} = {[ {\tilde{m}}_{i}^{a} ]}_{z = 0}^{- 1} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \}$$

similarly, z=hᵢ at the lower part of the pile foundation, it can be obtained that:

$$\{ \begin{matrix}{U}_{ai} ( {h}_{i} ) \\ {φ}_{ai} ( {h}_{i} ) \\ {Q}_{ai} ( {h}_{i} ) \\ {M}_{ai} ( {h}_{i} )\end{matrix} \} = \\ {[ {\tilde{m}}_{i}^{a} ]}_{z = {h}_{i}} \{ \begin{matrix}{A}_{1 i} \\ {B}_{1 i} \\ {C}_{1 i} \\ {D}_{1 i}\end{matrix} \} = {{[ {\tilde{m}}_{i}^{a} ]}_{z = {h}_{i}} [ {\tilde{m}}_{i}^{a} ]}_{z = 0}^{- 1} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} = [ {\tilde{M}}_{i}^{a} ] \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} \\ [ {\tilde{M}}^{a} ] = {{[ {\tilde{m}}_{i}^{a} ]}_{z = {h}_{i}} [ {\tilde{m}}_{i}^{a} ]}_{z = 0}^{- 1}$$

if the soil is divided into multi-layers, according to the principle of continuity of soil uᵢ(0)=uᵢ₋₁(hᵢ₋₁), φᵢ(0)=φᵢ₋₁ (hᵢ₋₁), Qᵢ(0)=Qᵢ₋₁(hᵢ₋₁)m Mᵢ(0)=Mᵢ₋₁(hᵢ₋₁),

the transfer matrix method is used to connect the displacement, the shear force, the rotation angle and the bending moment between soil layers through a parameter transfer matrix, as shown in the following formula:

$$\{ \begin{matrix}{U}_{a} ( {L}_{2} ) \\ {φ}_{a} ( {L}_{2} ) \\ {Q}_{a} ( {L}_{2} ) \\ {M}_{a} ( {L}_{2} )\end{matrix} \} = [ {\tilde{M}}_{n}^{a} ] [ {\tilde{M}}_{n - 1}^{a} ] [ {\tilde{M}}_{i}^{a} ] … [ {\tilde{M}}_{1}^{a} ] \{ \begin{matrix}{U}_{a} ( 0 ) \\ {φ}_{a} ( 0 ) \\ {Q}_{a} ( 0 ) \\ {M}_{a} ( 0 )\end{matrix} \}$$

where L₂ is the length of the pile body in soil;

[\tilde{M}^{a}]=[\tilde{M}ₙ^{a}][\tilde{M}ₙ₋₁^{a}][\tilde{M}ᵢ^{a}] . . . [\tilde{M}₁^{a}], this matrix is the transfer matrix;

let

$$[ {\tilde{M}}^{a} ] = [ \begin{matrix}{\tilde{M}}_{11}^{a} & {\tilde{M}}_{12}^{a} \\ {\tilde{M}}_{21}^{a} & {\tilde{M}}_{22}^{a}\end{matrix} ]$$

the above formula is expressed as follows:

$$\{ \begin{matrix}{U}_{a} ( {L}_{2} ) \\ {φ}_{a} ( {L}_{2} )\end{matrix} \} = [ {\tilde{M}}_{11}^{a} ] \{ \begin{matrix}{u}_{a} ( 0 ) \\ {φ}_{a} ( 0 )\end{matrix} \} + [ {\tilde{M}}_{12}^{a} ] \{ \begin{matrix}{Q}_{a} ( 0 ) \\ {M}_{a} ( 0 )\end{matrix} \} \\ \{ \begin{matrix}{Q}_{a} ( {L}_{2} ) \\ {M}_{a} ( {L}_{2} )\end{matrix} \} = [ {\tilde{M}}_{21}^{a} ] \{ \begin{matrix}{u}_{a} ( 0 ) \\ {φ}_{a} ( 0 )\end{matrix} \} + [ {\tilde{M}}_{22}^{a} ] \{ \begin{matrix}{Q}_{a} ( 0 ) \\ {M}_{a} ( 0 )\end{matrix} \}$$

it is assumed that the boundary condition of the pile bottom is a fixed end and the pile top is a free end, then:

$$\{ \begin{matrix}{U}_{a} ( {L}_{2} ) \\ {φ}_{a} ( {L}_{2} )\end{matrix} \} = \{ \begin{matrix}0 \\ 0\end{matrix} \}$$

the above formula is organized, it is obtained that:

$$\{ \begin{matrix}{U}_{a} ( 0 ) \\ {φ}_{a} ( 0 )\end{matrix} \} = {[ - {\tilde{M}}_{11}^{a} ]}^{- 1} [ {\tilde{M}}_{12}^{a} ] \{ \begin{matrix}{Q}_{a} ( 0 ) \\ {M}_{a} ( 0 )\end{matrix} \} = [ {K}_{S} ] \{ \begin{matrix}{Q}_{a} ( 0 ) \\ {M}_{a} ( 0 )\end{matrix} \} \\ [ {K}_{S} ] = - {[ {\tilde{M}}_{11}^{a} ]}^{- 1} [ {\tilde{M}}_{12}^{a} ]$$

[Kₛ] is the impedance function matrix of the pile top;

$$[ {K}_{S} ] = [ \begin{matrix}{K}_{S 11} & {K}_{S 12} \\ {K}_{S 21} & {K}_{S 22}\end{matrix} ]$$

the above formula is organized, it is obtained that:

Uₐ(0)=K_{S}(1,1)Qₐ(0)+K_{S}(1,2)Mₐ(0)

φₐ(0)=K_{S}(2,1)Qₐ(0)+K_{S}(2,2)Mₐ(0)

finally, when calculating the total displacement and the total rotation angle of the pile top, the displacements of the pile top of the part in the soil Uₐ(0) and φₐ(0) are regarded as the displacement of the pile bottom in the part of the pile body exposed to the soil to obtain:

$$\{ \begin{matrix}{U}_{a}^{′} ( 0 ) ‐ {E}_{u} ( 0 ) \\ {φ}_{a}^{′} ( 0 ) ‐ {E}_{φ} ( 0 ) \\ {Q}_{a}^{′} ( 0 ) ‐ {E}_{Q} ( 0 ) \\ {M}_{a}^{′} ( 0 ) ‐ {E}_{M} ( 0 )\end{matrix} \} = {[ {\overline{N}}^{a} ]}^{- 1} \{ \begin{matrix}{U}_{a} ( 0 ) ‐ {E}_{u} ( {L}_{1} ) \\ {φ}_{a} ( 0 ) ‐ {E}_{φ} ( {L}_{1} ) \\ {Q}_{a} ( 0 ) ‐ {E}_{Q} ( {L}_{1} ) \\ {M}_{a} ( 0 ) ‐ {E}_{M} ( {L}_{1} )\end{matrix} \}$$

the above formula is the displacement, the rotation angle, the shear force and the bending moment of the final pile top obtained by combining the dynamic response of the two parts of the pile body;

according to the definition of the horizontal impedance of the single pile, the calculation formula of the single pile impedance is obtained as shown in the following formula:

$${R}_{K} = \frac{{Q}_{a} ( 0 )}{{u}_{a} ( 0 )} = \frac{{Q}_{a} ( 0 )}{{K}_{S} ( 1 , 1 ) {Q}_{a} ( 0 ) + {K}_{S} ( 1 , 2 )} = {K}_{K} + i {a}_{0} {C}_{K}$$

where the impedance R_{K} consists of a real part and an imaginary part, the real part K_{K} is the dynamic stiffness of a single pile in the horizontal direction, and the imaginary part C_{K} is the horizontal dynamic damping of a single pile;

(4) establishment of pile groups model:

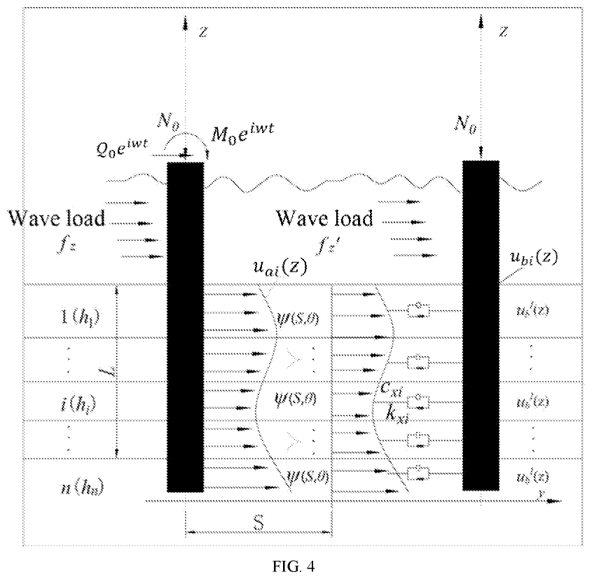

4-1) model analysis of pile groups is as shown in FIG. 4:

in the figure, ψ(s,θ) is set as the attenuation function of soil stress wave, f′_{z} is set as the wave load borne by the passive pile, and the other parameters have the same meaning as the single pile; the attenuation function ψ(s,θ) is calculated as follows:

$$ψ ( s , θ ) = ψ ( s , 0 ) {cos}^{2} θ + ψ ( s , \frac{π}{2} ) {sin}^{2} θ \\ where ψ ( s , 0 ) = {\sqrt{\frac{{r}_{p}}{s} e}}^{\frac{ω ( η + i ) ( s - {r}_{p} )}{{V}_{L a}}} , \\ ψ ( s , \frac{π}{2} ) = {\sqrt{\frac{{r}_{p}}{s} e}}^{\frac{ω ( η + i ) ( s - {r}_{p} )}{{V}_{si}}}$$

here s is the pile spacing, θ is the included angle between piles; V_{La} is the Lysmer simulation wave velocity of soil, which is calculated as follows:

$${V}_{La} = \frac{3.4 {V}_{si}}{π ( 1 - {v}_{si} )}$$

where Vₛᵢ is the shear wave velocity of soil, and vₛᵢ is the Poisson's ratio of soil;

the displacement when the stress wave caused by vibration of the active pile is sent is Uₐᵢ(z,t), and according to the loss of the stress wave in soil, the displacement attenuation after reaching the passive pile is:

Uₐₛ=uₐₛ(z)e^{iωt}=ψ(s,θ)uₐᵢ(z)e^{iωt}

it is assumed that the displacement of the passive pile is U_{bi}(z,t), which is written in the form of U_{bi}(z,t)=U_{bi}(z)e^{iwt} for the convenience of calculation, and the vibration balance equation of the passive pile is as follows:

the vibration balance equation of the part of the pile body in water;

$$EI \frac{\partial {U}_{bi} ( z , t )}{\partial {z}^{4}} + {ρ}_{ρ} {A}_{ρ} \frac{{\partial }^{2} {U}_{bi} ( z , t )}{\partial {t}^{2}} + {c}_{xi}^{′} \frac{\partial {U}_{bi} ( z , t )}{\partial t} + {N}_{i} ( z ) \frac{{\partial }^{2} {U}_{bi} ( z , t )}{\partial {z}^{2}} = {f}_{z}^{′} ( z )$$

the vibration balance equation of the part of the pile body in soil;

$${E}_{P} {I}_{P} \frac{{d}^{4} {u}_{bi} ( z )}{d {z}^{4}} - ( {t}_{gxi} , - {N}_{i} ( z ) ) \frac{{d}^{2} {u}_{bi} ( z )}{d {z}^{2}} - {ρ}_{ρ} {A}_{ρ} {ω}^{2} {u}_{bi} ( z ) = ( {k}_{xi} + i ω {c}_{xi} ) ( {ψ}_{i} ( s , θ ) {u}_{ai} ( z ) - {u}_{bi} ( z ) )$$

compared with the active pile, the value of the wave load f_{z} of the passive pile is slightly different, because the positions of the active pile and the passive pile are different, and the wave crest is uncapable of acting on each pile at the same time; in addition, the interaction between piles leads to asymmetry of vortices and interaction between vortices, so as to lead to different loads on each pile; at the same time, considering the influence of other factors, in the calculation of this step, the wave load borne by the passive pile is calculated according to f′_{z}=0.8 f_{z};

the calculation process of the above formula is as follows:

first let

$${φ}_{i} ( s , θ ) = \frac{( {k}_{xi} + i ω {c}_{xi} )}{{E}_{p} {I}_{p}} {ψ}_{i} ( s , θ )$$

the above formula is expressed as:

$$\frac{{d}^{4} {u}_{bi} ( z )}{d {z}^{4}} - {ς}_{1} \frac{{d}^{2} {u}_{bi} ( z )}{d {z}^{2}} - {ς}_{2} {u}_{bi} ( z ) = φ ( s , θ ) {u}_{ai} ( z ) \\ where {ς}_{1} = {( \frac{{δ}_{i}}{{h}_{i}} )}^{2} , {ς}_{2} = {( \frac{{ϖ}_{i}}{{h}_{i}} )}^{4} ,$$

the general solution of the above formula is expresses as:

$${u}_{bi} ( z ) = {A}_{2 i} ch \frac{{ζ}_{1 i}}{{h}_{i}} z + {B}_{2 i} sh \frac{{ζ}_{1 i}}{{h}_{i}} z + {C}_{2 i} cos \frac{{ζ}_{2 i}}{{h}_{i}} z + {D}_{2 i} sin \frac{{ζ}_{2 i}}{{h}_{i}} z + \\ z {α}_{i} ( {A}_{1 i} sinh \frac{{ζ}_{1 i}}{{h}_{i}} z + {B}_{1 i} cosh \frac{{ζ}_{1 i}}{{h}_{i}} z ) + z {β}_{i} ( - {C}_{1 i} sin \frac{{ζ}_{2 i}}{{h}_{i}} z + {D}_{1 i} cos \frac{{ζ}_{2 i}}{{h}_{i}} z ) \\ where {α}_{i} = \frac{φ ( s , θ )}{2 \frac{{ζ}_{1 i}}{{h}_{i}} [ 2 {( \frac{{ζ}_{1 i}}{{h}_{i}} )}^{2} - {( \frac{{δ}_{i}}{{h}_{i}} )}^{2} ]} , \\ {β}_{i} = \frac{φ ( s , θ )}{2 \frac{{ζ}_{2 i}}{{h}_{i}} [ 2 {( \frac{{ζ}_{2 i}}{{h}_{i}} )}^{2} - {( \frac{{δ}_{i}}{{h}_{i}} )}^{2} ]} ,$$

in the soil layer unit, the relationship between the rotation angle of the cross section φ_{bi}(z) , the bending moment M_{bi}(z), the shear force Q_{bi}(z) and the lateral displacement u_{bi}(z) of the cross section of each pile foundation has the same calculation process as that of a single pile, which is expressed in the form of matrix as follows:

$$\{ \begin{matrix}{u}_{bi} ( L ) \\ {φ}_{bi} ( L ) \\ {Q}_{bi} ( L ) \\ {M}_{bi} ( L )\end{matrix} \} = [ {\tilde{M}}_{i}^{a} ] \{ \begin{matrix}{u}_{bi} ( 0 ) \\ {φ}_{bi} ( 0 ) \\ {Q}_{bi} ( 0 ) \\ {M}_{bi} ( 0 )\end{matrix} \} + [ {\tilde{M}}_{i}^{b} ] \{ \begin{matrix}{u}_{ai} ( 0 ) \\ {φ}_{ai} ( 0 ) \\ {Q}_{ai} ( 0 ) \\ {M}_{ai} ( 0 )\end{matrix} \}$$

where [\tilde{M}ᵢ^{a}] is the same as the calculation of a single pile, but the calculation of [\tilde{M}ᵢ^{b}] is slightly complicated, as shown in the following formula:

$$[ {\tilde{M}}_{i}^{b} ] = - {{{{[ {\tilde{m}}_{i}^{a} ]}_{z = {h}_{i}} [ {\tilde{m}}_{i}^{a} ]}_{z = 0}^{- 1} [ {\tilde{m}}_{i}^{b} ]}_{z = 0} [ {\tilde{m}}_{i}^{a} ]}_{z = 0}^{- 1} + {{[ {\tilde{m}}_{i}^{b} ]}_{z = {h}_{i}} [ {\tilde{m}}_{i}^{a} ]}_{= 0}^{- 1} \\ where [ {\tilde{m}}_{i}^{b} ] = \{ \begin{matrix}{\tilde{m}}_{1 i}^{b} \\ {\tilde{m}}_{2 i}^{b} \\ {\tilde{m}}_{3 i}^{b} \\ {\tilde{m}}_{4 i}^{b}\end{matrix} \} \\ {[ {\tilde{m}}_{1 i}^{b} ]}^{T} = [ \begin{matrix}{α}_{i} zsh \frac{{ζ}_{1 i}}{{h}_{i}} z \\ {α}_{i} zch \frac{{ζ}_{1 i}}{{h}_{i}} z \\ - {β}_{i} z sin \frac{{ζ}_{2 i}}{{h}_{i}} z \\ {β}_{i} z cos \frac{{ζ}_{2 i}}{{h}_{i}} z\end{matrix} ] , \\ {[ {\tilde{M}}_{2 i}^{b} ]}^{T} = [ \begin{matrix}{α}_{i} sh \frac{{ζ}_{1 i}}{{h}_{i}} z + {α}_{i} z \frac{{ζ}_{1 i}}{{h}_{i}} ch \frac{{ζ}_{1 i}}{{h}_{i}} z \\ {α}_{i} ch \frac{{ζ}_{1 i}}{{h}_{i}} z + {α}_{i} z \frac{{ζ}_{1 i}}{{h}_{i}} sh \frac{{ζ}_{1 i}}{{h}_{i}} z \\ - {β}_{i} sin \frac{{ζ}_{2 i}}{{h}_{i}} z - {β}_{i} z \frac{{ζ}_{2 i}}{{h}_{i}} cos \frac{{ζ}_{2 i}}{{h}_{i}} z \\ {β}_{i} cos \frac{{ζ}_{2 i}}{{h}_{i}} z - {β}_{i} z \frac{{ζ}_{2 i}}{{h}_{i}} sin \frac{{ζ}_{2 i}}{{h}_{i}} z\end{matrix} ] \\ {[ {\tilde{m}}_{3 i}^{b} ]}^{T} = [ \begin{matrix}{E}_{p} {I}_{p} ( 3 {α}_{i} \frac{{ζ}_{1 i}^{2}}{{h}_{i}^{2}} sh \frac{{ζ}_{1 i}}{{h}_{i}} z + {α}_{i} z \frac{{ζ}_{1 i}^{3}}{{h}_{i}^{3}} ch \frac{{ζ}_{1 i}}{{h}_{i}} z ) \\ {E}_{p} {I}_{p} ( 3 {α}_{i} \frac{{ζ}_{1 i}^{2}}{{h}_{i}^{2}} ch \frac{{ζ}_{1 i}}{{h}_{i}} z + {α}_{i} z \frac{{ζ}_{1 i}^{3}}{{h}_{i}^{3}} sh \frac{{ζ}_{1 i}}{{h}_{i}} z ) \\ {E}_{p} {I}_{p} ( 3 {β}_{i} \frac{{ζ}_{2 i}^{2}}{{h}_{i}^{2}} sin \frac{{ζ}_{2 i}}{{h}_{i}} z + {β}_{i} z \frac{{ζ}_{2 i}^{3}}{{h}_{i}^{3}} cos \frac{{ζ}_{2 i}}{{h}_{i}} z ) \\ {E}_{p} {I}_{p} ( - 3 {β}_{i} \frac{{ζ}_{2 i}^{2}}{{h}_{i}^{2}} cos \frac{{ζ}_{2 i}}{{h}_{i}} z + {β}_{i} z \frac{{ζ}_{2 i}^{3}}{{h}_{i}^{3}} sin \frac{{ζ}_{2 i}}{{h}_{i}} z )\end{matrix} ] \\ {[ {\tilde{m}}_{4 i}^{b} ]}^{T} = [ \begin{matrix}{E}_{p} {I}_{p} ( 2 {α}_{i} \frac{{ζ}_{1 i}}{{h}_{i}} ch \frac{{ζ}_{1 i}}{{h}_{i}} z + {α}_{i} z \frac{{ζ}_{1 i}^{2}}{{h}_{i}^{2}} sh \frac{{ζ}_{1 i}}{{h}_{i}} z ) \\ {E}_{p} {I}_{p} ( 2 {α}_{i} \frac{{ζ}_{1 i}}{{h}_{i}} sh \frac{{ζ}_{1 i}}{{h}_{i}} z + {α}_{i} z \frac{{ζ}_{1 i}^{2}}{{h}_{i}^{2}} ch \frac{{ζ}_{1 i}}{{h}_{i}} z ) \\ {E}_{p} {I}_{p} ( - 2 {β}_{i} \frac{{ζ}_{2 i}}{{h}_{i}} cos \frac{{ζ}_{2 i}}{{h}_{i}} z + {β}_{i} z \frac{{ζ}_{2 i}^{2}}{{h}_{i}^{2}} sin \frac{{ζ}_{2 i}}{{h}_{i}} z ) \\ {E}_{p} {I}_{p} ( - 2 {β}_{i} \frac{{ζ}_{2 i}}{{h}_{i}} sin \frac{{ζ}_{2 i}}{{h}_{i}} z - {β}_{i} z \frac{{ζ}_{2 i}^{2}}{{h}_{i}^{2}} cos \frac{{ζ}_{2 i}}{{h}_{i}} z )\end{matrix} ]$$

according to the transfer matrix, the displacement, the rotation angle, the shear force and the bending moment of each soil layer are linked, as shown in the following formula. and the organized transfer matrix is:

$$\{ \begin{matrix}{u}_{b} ( {L}_{2} ) \\ {φ}_{b} ( {L}_{2} ) \\ {Q}_{b} ( {L}_{2} ) \\ {M}_{b} ( {L}_{2} )\end{matrix} \} = [ {\tilde{M}}^{a} ] \{ \begin{matrix}{u}_{b} ( 0 ) \\ {φ}_{b} ( 0 ) \\ {Q}_{b} ( 0 ) \\ {M}_{b} ( 0 )\end{matrix} \} + [ {\tilde{M}}^{b} ] \{ \begin{matrix}{u}_{a} ( 0 ) \\ {φ}_{a} ( 0 ) \\ {Q}_{a} ( 0 ) \\ {M}_{a} ( 0 )\end{matrix} \} \\ where [ {\tilde{M}}^{a} ] = [ {\tilde{M}}_{n}^{a} ] [ {\tilde{M}}_{n - 1}^{a} ] … [ {\tilde{M}}_{1}^{a} ] \\ [ {\tilde{M}}^{b} ] = {\sum }_{j = 1}^{n} [ {\tilde{M}}_{n}^{a} ] … [ {\tilde{M}}_{j + 1}^{a} ] [ {\tilde{M}}_{j}^{a} ] [ {\tilde{M}}_{j - 1}^{a} ] … [ {\tilde{M}}_{1}^{a} ] \\ [ {M}^{b} ] = [ \begin{matrix}{\tilde{M}}_{11}^{b} & {\tilde{M}}_{12}^{b} \\ {\tilde{M}}_{21}^{b} & {\tilde{M}}_{22}^{b}\end{matrix} ]$$

the above formula is expressed as:

$$\{ \begin{matrix}{u}_{b} ( L ) \\ {φ}_{b} ( L )\end{matrix} \} = [ {\tilde{M}}_{11}^{{a}_{}} ] \{ \begin{matrix}{U}_{b} ( 0 ) \\ {φ}_{b} ( 0 )\end{matrix} \} + [ {\tilde{M}}_{12}^{a} ] \{ \begin{matrix}{Q}_{b} ( 0 ) \\ {M}_{b} ( 0 )\end{matrix} \} + [ {\tilde{M}}_{12}^{b} ] \{ \begin{matrix}{U}_{a} ( 0 ) \\ {φ}_{a} ( 0 )\end{matrix} \} + [ {\tilde{M}}_{12}^{b} ] \{ \begin{matrix}{Q}_{a} ( 0 ) \\ {M}_{a} ( 0 )\end{matrix} \} \{ \begin{matrix}{Q}_{b} ( L ) \\ {M}_{b} ( L )\end{matrix} \} = [ {\tilde{M}}_{21}^{{a}_{}} ] \{ \begin{matrix}{U}_{b} ( 0 ) \\ {φ}_{b} ( 0 )\end{matrix} \} + [ {\tilde{M}}_{22}^{a} ] \{ \begin{matrix}{Q}_{b} ( 0 ) \\ {M}_{b} ( 0 )\end{matrix} \} + [ {\tilde{M}}_{21}^{b} ] \{ \begin{matrix}{U}_{a} ( 0 ) \\ {φ}_{a} ( 0 )\end{matrix} \} + [ {\tilde{M}}_{22}^{b} ] \{ \begin{matrix}{Q}_{a} ( 0 ) \\ {M}_{a} ( 0 )\end{matrix} \}$$

according to the model, it is assumed that the boundary condition is that the pile top is fixed, so

$$\{ \begin{matrix}{U}_{b} ( L ) \\ {φ}_{b} ( L )\end{matrix} \} = 0$$

then the boundary conditions are substituted into the above formula to obtain:

$$\{ \begin{matrix}{U}_{b} ( 0 ) \\ {φ}_{b} ( 0 )\end{matrix} \} = [ {μ}_{v} ( s , θ ) ] \{ \begin{matrix}{u}_{a} ( 0 ) \\ {φ}_{a} ( 0 )\end{matrix} \}$$

$$where$$

$$[ {μ}_{v} ( s , θ ) ] = - {[ {\tilde{M}}_{11}^{a} ]}^{- 1} ( [ {\tilde{M}}_{11}^{b} ] + {[ {\tilde{M}}_{12}^{b} ] [ {\tilde{M}}_{12}^{a} ]}^{- 1} [ {\tilde{M}}_{11}^{a} ] )$$

[μᵥ(s,θ)] is the interaction matrix between the active pile and the passive pile;

according to the definition of the interaction factor, it is obtained that:

the horizontal interaction factor of pile groups is:

$${β}_{u p} = \frac{{U}_{b} ( 0 )}{{U}_{a} ( 0 )} = \frac{{μ}_{v} ( 1 , 1 ) {K}_{S} ( 1 , 1 ) + {μ}_{v} ( 1 , 2 ) {K}_{S} ( 2 , 1 )}{{K}_{S} ( 1 , 1 )}$$

the shaking interaction factor of pile groups is:

$${β}_{φ M} = \frac{{φ}_{b} ( 0 )}{{φ}_{a} ( 0 )} = \frac{{μ}_{v} ( 2 , 1 ) {K}_{S} ( 1 , 2 ) + {μ}_{v} ( 2 , 2 ) {K}_{S} ( 2 , 2 )}{{K}_{S} ( 2 , 2 )}$$

the total displacement and the rotation angle parameters of the pile top of pile groups have the same calculation method as those of a single pile, specifically as follows:

$$\{ \begin{matrix}{U}_{b}^{′} ( 0 ) - {E}_{u} ( 0 ) \\ {φ}_{b}^{′} ( 0 ) - {E}_{φ} ( 0 ) \\ {Q}_{b}^{′} ( 0 ) - {E}_{Q} ( 0 ) \\ {M}_{b}^{′} ( 0 ) - {E}_{M} ( 0 )\end{matrix} \} = {[ {\overline{N}}^{a} ]}^{- 1} \{ \begin{matrix}{U}_{b} ( 0 ) - {E}_{u} ( {L}_{1} ) \\ {φ}_{b} ( 0 ) - {E}_{φ} ( {L}_{1} ) \\ {Q}_{b} ( 0 ) - {E}_{Q} ( {L}_{1} ) \\ {M}_{b} ( 0 ) - {E}_{M} ( {L}_{1} )\end{matrix} \}$$

4-2) impedance analysis of pile groups:

the calculation of the horizontal impedance of pile groups is as follows, assuming that the number of pile groups is n, and the horizontal displacement u^{G} of pile groups is equal to the horizontal displacement uᵢ^{G} of each single pile, namely

$${u}^{G} = {u}_{i}^{G} = {\sum }_{j = 1}^{n} {u}_{ij}^{G} ( i , j = 1 , 2 , 3 … , n )$$

assuming that the influence factor of the active pile j on the passive pile i is χᵢⱼ, the load borne by pile j in pile groups is Pⱼ, and according to the relationship between load, impedance and displacement:

$${\sum }_{j = 1}^{n} {χ}_{ij} {P}_{j} = {R}_{K} {u}^{G} , {P}^{G} = {\sum }_{j = 1}^{n} {P}_{j} , {χ}_{ij} = 1 when i = k$$

where R_{K} is the impedance of a single pile;

the horizontal dynamic impedance of pile groups is:

$${R}^{G} = \frac{{P}^{G}}{{u}^{G}} = {K}^{G} + i {a}_{0} {C}^{G}$$

K^{G} is the horizontal dynamic stiffness of pile groups; C^{G} is the horizontal dynamic damping of pile groups.

The method of this embodiment realizes the analysis of calculating the dynamic response and dynamic impedance of interacting pile groups. At present, the research on this aspect at home and abroad is mainly a numerical method, which has a wide application range, but the calculation process is complex and the calculation amount is large. There are still some difficulties in some complex structures and the calculation is too slow. It is inconvenient to perform calculation and analysis in practical engineering design. On the basis of this, according to the present disclosure, the influence of wave load on pile groups is taken into account to study the dynamic stability of pile groups, the foundation reaction force is calculated by using an improved Vlasov foundation model, the dynamic stability equation of active piles and passive piles is established by combining an interaction factor method and a matrix transfer method, the dynamic interaction factor between adjacent piles and impedance of pile groups are obtained, and the stability of pile groups is analyzed by parameters. Through research, it is found that the existence of wave load makes the dynamic response of pile groups increase obviously; the dynamic impedance and the interaction factor of pile groups are mainly affected by soil parameters, but the existence of wave load will affect some soil parameters; increasing the elastic modulus of topsoil can effectively improve the impedance of pile groups; the improved Vlasov foundation model in the present disclosure can accurately conform to the engineering practice.

### Embodiment 3

This embodiment is basically the same as the first embodiment with the following special features.

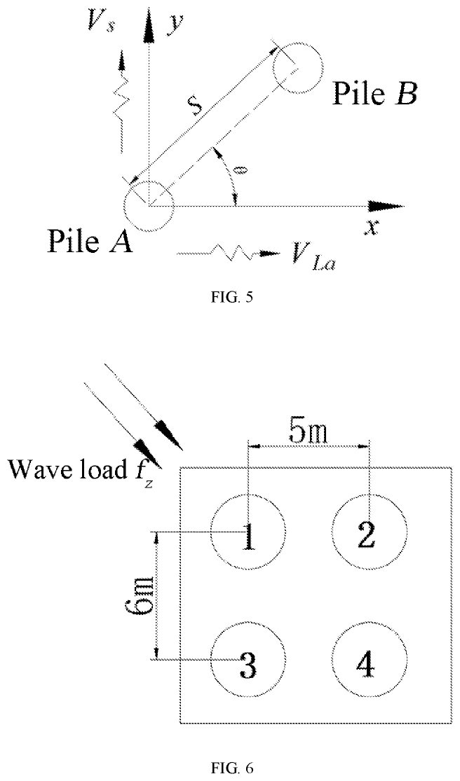

In this embodiment, this embodiment specifically relates to a calculation method for calculating dynamic response and dynamic impedance of pile groups based on an interaction factor superposition method, which is verified by an example of 2×2 pile groups as shown in FIG. 6. The wave load direction is shown in the figure, and the parameters of the pile body are as follows: the pile length is l=37.6 m, the length of the pile body deep into soil is 18.2 m, the pile diameter is d=1.0 m, the horizontal pile distance is 5 m, the longitudinal pile distance is 6 m, E=30 GPa, ρ_{ρ}=2.6×10³kg/m³, Poisson's ratio is vₛ=0.3, and other soil parameters are shown in the following table:

TABLE 1
Table of Soil Parameters

| | Soil | | | Layer | Shear | Elastic |
|---|---|---|---|---|---|---|
| Layer | density | Poisson's | Damping | thickness | wave | modulus |
| number | (kg/m³) | ratio | ratio | (m) | (m/s) | (Mpa) |
| 1 | 1.95 | 0.3 | 0.06 | 5.4 | 100 | 36630 |
| 2 | 1.85 | 0.35 | 0.08 | 10.8 | 118 | 45230 |
| 3 | 1.85 | 0.3 | 0.105 | 12.4 | 130 | 57350 |

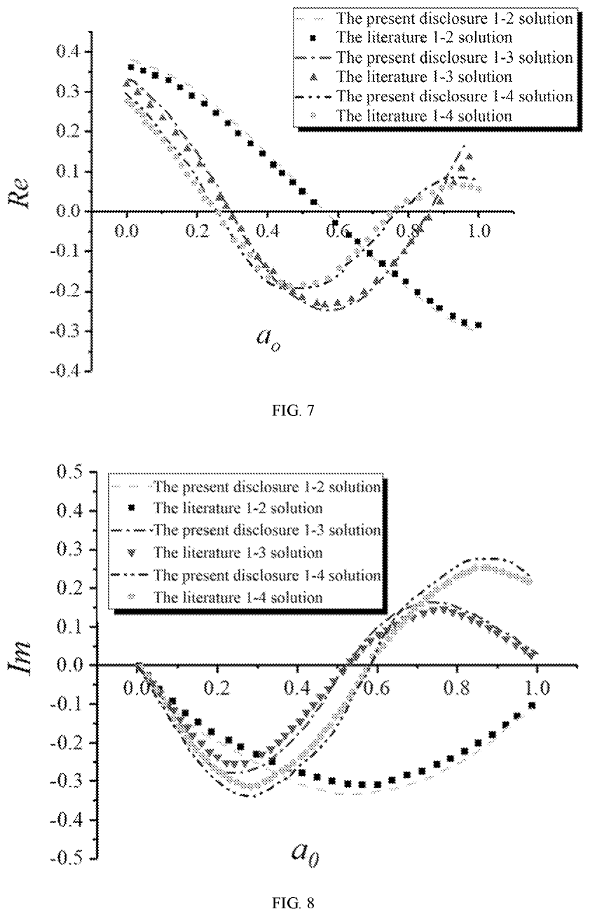

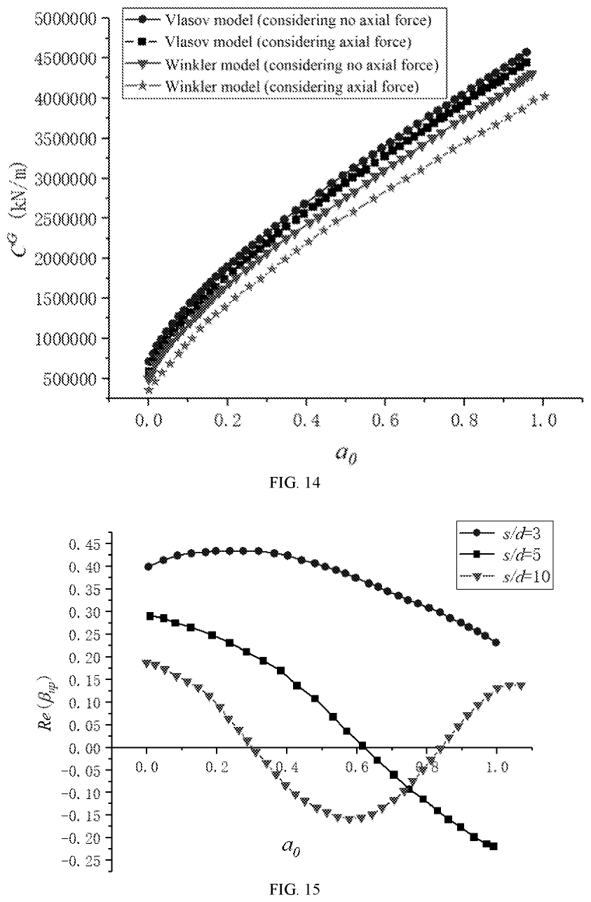

The simulation results are shown in FIGS. 7-18. In this embodiment, the interaction factors between pile 1 and the other three piles are firstly analyzed. Compared with the results of scholars such as Huang Maosong, the two results are in good agreement and meet the accuracy requirements. As shown in FIG. 7 and FIG. 8, the literature solution in the figure is the solution of scholars such as Huang Maosong. FIG. 7 shows the real part of an interaction factor of pile groups obtained by calculation, and FIG. 8 shows the imaginary part of an interaction factor of pile groups obtained by calculation. Through comparison, it is found that the result of this embodiment is slightly higher than that of scholars such as Huang Maosong, which is due to the consideration of continuous characteristics between soils in this embodiment. It can also be seen from the above two figures that the source pile 1 has different interaction factors between piles at different positions. The interaction factors between piles 1-3 and the interaction factors between piles 1-4 have basically the same trend. Piles 1-2 is located closest, and the interaction factor curve between two piles is obviously different from the interaction factor curve between piles 1-3 and piles 1-4.

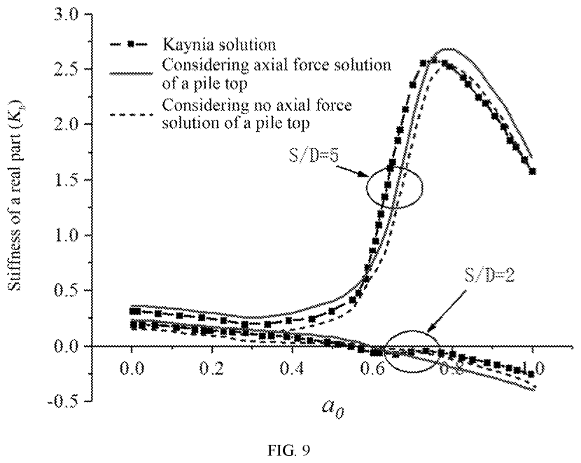

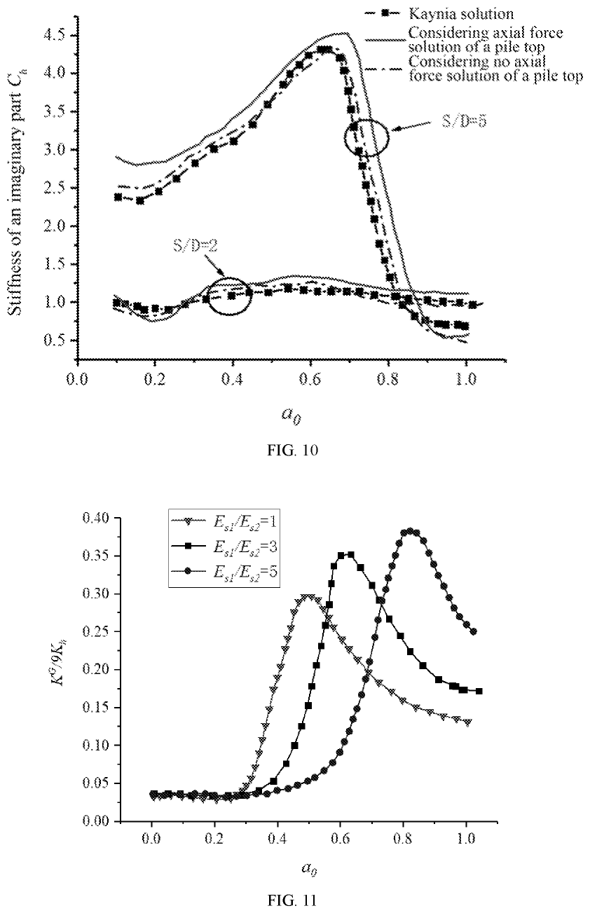

In the example analysis of this embodiment, the dynamic impedance between pile groups is also studied. The obtained result is subjected to a dimensionless process, which is compared with the result of kaynia. At the same time, the influence of axial force on the impedance of pile groups is also compared in theoretical calculation, as shown in FIG. 9 and FIG. 10. It can be seen from the figure that when the ratio of the pile spacing to the pile diameter is small, with the increase of a₀, the change of impedance of pile groups is small and the curve is stable. However, when the ratio of the pile spacing to the pile diameter increases to 5, the change of the impedance curve of pile groups begins to increase, and the curve has obvious fluctuation. From the two figures, it can be seen that when s/d=5, the stiffness of the real part suddenly increases when a₀ is about 0.6, and reaches the highest when a₀ is close to 0.8, and then gradually decreases with the increase of a₀. The stiffness of the imaginary part also has similar changes, reaches the highest when a₀=0.65, and then gradually decreases with the increase of a₀.

### Parametric Analysis

Parameters of the pile foundation are as follows: the pile length is L=55 m, the pile diameter is d=1.6 m, the length of the part of the pile body deep into the soil is 30 m, E=3×10¹⁰ Pa , and the soil parameters are the same as those in the above embodiments.

Assuming that the elastic modulus of the second layer and the third layer of the soil layer is unchanged, the modulus of the topsoil changes so that Eₛ₁/Eₛ₂=1, Eₛ₁/Eₛ₂=3, Eₛ₁/Eₛ₂=5, and the specific research is shown in FIGS. 11 and 12.

It can be seen from the two figures that with the increase of a₀, the real part and the imaginary part of impedance of pile groups first increase and then gradually reach the peak value, and then with the continuous increase of a₀, the stiffness of the real part and the imaginary part begin to decrease. The stiffness of the real part decreases to a certain extent and starts to slow down, while the stiffness of imaginary part decreases to a certain extent and starts to rise slowly. With the increase of elastic modulus of topsoil, the peak position of impedance of pile groups begins to move backward, that is, a₀ corresponding to the peak impedance increases, and the peak value gradually increases with the increase of elastic modulus of topsoil, which shows that topsoil plays an important role in the stability of pile groups. The increase of peak impedance of pile groups represents the enhancement of constraint of soil on the pile foundation. By increasing the elastic modulus of the topsoil, it can effectively improve the constraint effect of pile groups and their stability. Therefore, in practical engineering, the stability of pile groups can be improved by strengthening the soft soil on the surface or replacing it with soil with high elastic modulus.

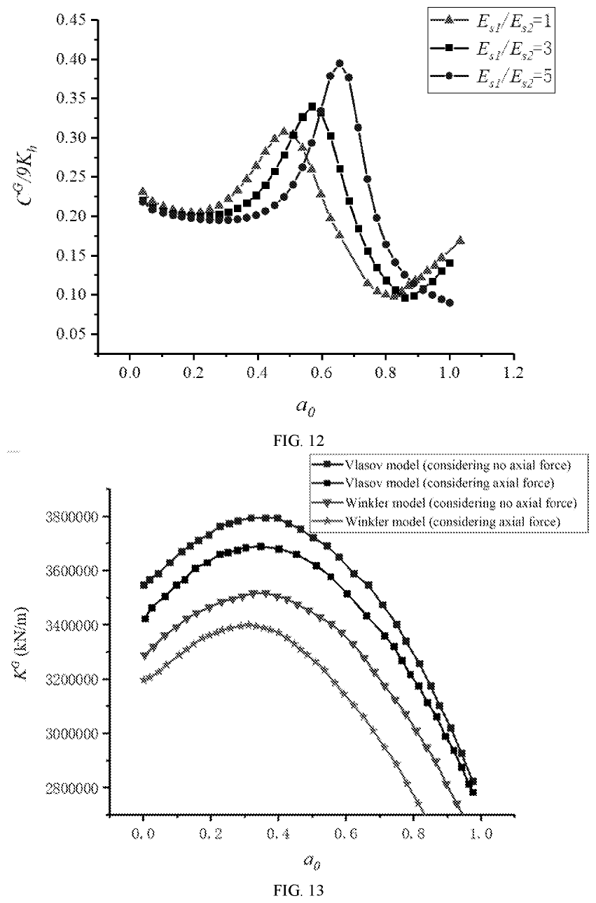

A Winkler model is widely used to simulate the reaction force of soil in some previous studies. In order to better consider the continuous characteristics of soil and further study the pile-soil characteristics of pile groups, the improved Vlasov foundation model based on a continuous medium model is used to calculate the reaction force of soil on the pile side. According to two different foundation models, FIG. 13 analyzes the change of impedance of pile groups under the Winkler model and the Vlasov foundation model with the change of a₀.

First, from the above two figures, it is found that the impedance of the real part of the two models first gradually increases with the increase of a₀, and then starts to decrease gradually after reaching the peak value, while the impedance of the imaginary part is different from the impedance of the real part. With the increase of a₀, the impedance of the imaginary part keeps increasing, and the increasing speed gradually slows down. Then, it can be clearly seen from the two figures that there are obvious differences between the results of impedance of pile groups calculated by the Winkler model and the Vlasov foundation model. The impedance of pile groups calculated by the Vlasov foundation model is obviously higher than that calculated by the Winkler model, which shows that after considering the continuous characteristics of soil, the constraint effect of soil increases and the impedance is larger. Compared with the Winkler model, the Vlasov foundation model more in line with the actual soil conditions. In addition, it can be seen from the figure that after considering the axial force on the top of the pile in the calculation, the corresponding impedance of pile groups will be obviously reduced, which is unfavorable to the stability of the pile foundation. Therefore, for the design of a superlong pile foundation such as a long and flexible pile foundation, it is necessary to check the axial force, so as to fully guarantee the stability of the pile foundation from various aspects.

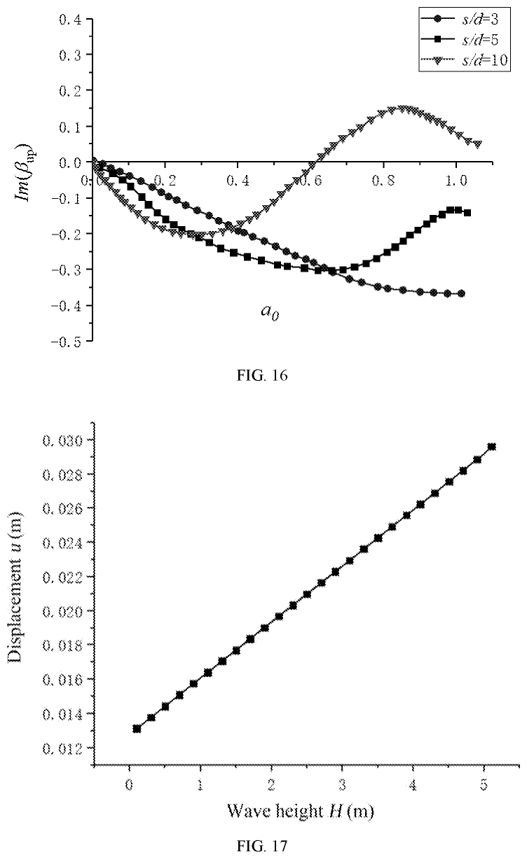

The interaction factors between the pile foundations corresponding to piles at different positions in the pile groups are also different, which has been confirmed in the verification part of the embodiment. The next part will specifically study the influence of the ratio of the pile spacing to the pile diameter on the horizontal dynamic interaction factor, as shown in FIGS. 15 and 16.

It can be seen from the two figures that with the increase of the ratio of the pile spacing to the pile diameter, the fluctuation of the dynamic interaction factor curve begins to increase. When s/d=3, the dynamic interaction factor changes relatively smoothly with the increase of a₀. However, with the increase of s/d value to 5, the fluctuation of the dynamic interaction factor increases obviously. When s/d=10, the fluctuation of the interaction factor curve is very obvious. In addition, it can be seen from the figure that with the increase of s/d, the horizontal dynamic interaction factor decreases within a certain range. As shown in FIG. 15, when a₀ is in the range of 0 to 0.6, it can be seen that the interaction factor decreases obviously, which shows that the interaction effect between adjacent piles will decrease significantly with the increase of the pile spacing within a certain range. When the pile spacing exceeds a certain value, the interaction factor between adjacent piles will become very small. At this time, the effect of pile groups can be ignored, and each single pile in pile groups is studied according to the calculation method of a single pile.

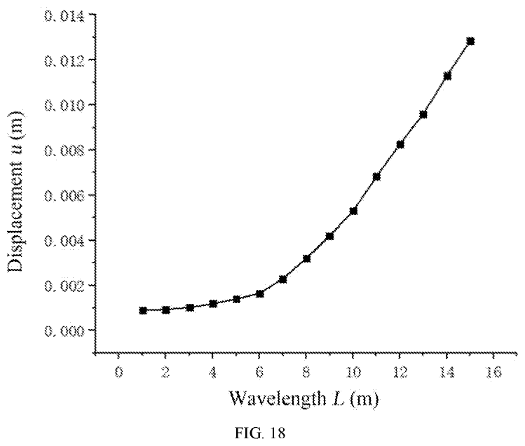

As a dynamic load, the wave load exerts on the pile body, which will also have a certain influence on the dynamic response of pile groups. The influence of the wavelength and the wave height of the wave load on the displacement response of pile groups will be analyzed below, as shown in FIG. 17 and FIG. 18:

It can be seen from the figure that with the constant increase of wave height H, the displacement response of the pile body increases linearly, which is smaller than that of a single pile. The effect of wavelength L on displacement response is different from that of wave height H. With the increase of wavelength L, the displacement response u does not linearly increase simply any longer, but increases non-linearly. Moreover, its increasing speed is faster and faster, which is basically the same as the effect of wavelength on displacement of a single pile. Due to the influence of the pile group effect, the magnitude of the displacement response of pile groups under the effect of the wave load increasing with the wavelength is much smaller than that of a single pile.

In this embodiment, the influence of wave load on pile groups is taken into account to study the dynamic stability of pile groups, the foundation reaction force is calculated by using an improved Vlasov foundation model, the dynamic stability equation of active piles and passive piles is established by combining an interaction factor method and a matrix transfer method, the dynamic interaction factor between adjacent piles and impedance of pile groups are obtained, and the stability of pile groups is analyzed by parameters.

### Embodiment 4

This embodiment is basically the same as the above embodiments with the following special features.

In this embodiment, a system for analyzing dynamic response and dynamic impedance of pile groups comprises:

a storage subsystem, which is configured to store a computer program;

an information processing subsystem, which is configured to realize the steps of the method for analyzing dynamic response and dynamic impedance of pile groups when executing the computer program. In this embodiment, the continuous characteristics between soils are considered in the calculation, and the improved Vlasov foundation model is used to calculate the foundation reaction force of soil, which significantly reduces the calculation cost, solves the cost, and is suitable for popularization and application in engineering practice.

The embodiments of the present disclosure have been described above with reference to the accompanying drawings, but the present disclosure is not limited to the above embodiments, and various changes can be made according to the purpose of the present disclosure. Any changes, modifications, substitutions, combinations or simplifications made according to the spirit and principles of the technical scheme of the present disclosure shall be equivalent substitutions, and they shall belong to the protection scope of the present disclosure as long as they meet the purpose of the present disclosure and do not deviate from the technical principles and concepts of the present disclosure.

1-4. (canceled)

5. A method for analyzing dynamic response and dynamic impedance of pile groups, wherein the foundation reaction force is calculated by using an improved Vlasov foundation model, the dynamic stability equation of active piles and passive piles is established by combining an interaction factor method and a matrix transfer method, the dynamic interaction factor between adjacent piles and impedance of pile groups are obtained, and the stability of pile groups is analyzed by parameters to obtain dynamic response and dynamic impedance of pile groups;
the method for analyzing dynamic response and dynamic impedance of pile groups, comprising the following steps:
(1) parameter selection
the dynamic interaction between pile-soil-pile is an important part of analyzing the dynamic response of pile groups, through the analysis of the dynamic interaction between pile groups, the relationship between active pile-soil-passive pile is obtained, the dynamic response of pile groups is analyzed continuously, and the analysis of dynamic interaction starts with active piles first; the dynamic analysis model of active piles is as follows:
N₀ is set as the vertical static load of the pile top, Q₀e^{iwt} is set as the initial horizontal harmonic load of the pile top, M₀e^{iwt} is set as the initial bending moment of the pile top, and f_{z} is set as the wave load:
$${f}_{z} = \frac{2 ρ gH}{K} \cdot \frac{c h ( K {z}_{1} )}{c h ( K {d}_{L} )} {f}_{A} \cdot cos ( ω t )$$
$$where k = \frac{2 π}{L} ,$$
L is the wavelength;
$$ω = \frac{2 π}{T} ,$$
T is the wave period, and ρ is the density of seawater, which is 1030 kg/m³;
g is the acceleration of gravity, which is 9.8 m/s²; H is the wave height; z₁ is the water depth, d_{L} is the water entry depth of the pile body and does not include the soil buried part;
$${f}_{A} = \frac{1}{\sqrt{{[ {J}_{1}^{′} ( π D / L ) ]}^{2} + {[ {Y}_{1}^{′} ( π D / L ) ]}^{2}}} ,$$
J′₁ is the first-order Bessel function of the first kind, Y′₁ is the first-order Bessel function of the second kind;
according to the model, the motion balance equation of the soil layer is obtained as follows:
$$\{ \begin{matrix}\frac{\partial {Q}_{ai} ( z , t )}{\partial z} - ( {k}_{xi} {U}_{ai} ( z , t ) + {c}_{xi} \frac{\partial {U}_{ai} ( z , t )}{\partial t} - {t}_{gxi} \frac{{\partial }^{2} {U}_{ai} ( z , t )}{\partial {z}^{2}} + {N}_{0} \frac{{\partial }^{2} {U}_{ai} ( z , t )}{\partial {z}^{2}} ) = {ρ}_{p} {A}_{P} \frac{{\partial }^{2} {U}_{ai} ( z , t )}{\partial {t}^{2}} \\ \frac{\partial {M}_{ai} ( z , t )}{\partial z} + {Q}_{ai} ( z , t ) = {f}_{z} ( z , t )\end{matrix}$$
where kₓᵢ, is the stiffness coefficient of soil beside the pile, t_{gxi} is the continuity coefficient of soil beside the pile, cₓᵢ is the damping coefficient of soil, A_{ρ} is the circular cross-sectional area of the pile, ρ_{ρ} is the bulk density of the pile, Qₐᵢ, (z, t) and Mₐᵢ(z, t) are the cross-sectional shear force and bending moment of the active pile;
according to the dynamic interaction between pile-soil-pile involved in pile group, the interaction between pile-soil is described, and the reaction force of soil is simulated based on the VLasov foundation model derived from a continuous medium model, the specific calculation formula is as follows:
$$q ( x ) = {k}_{i} w ( x ) - 2 {t}_{gi} {w}^{″} ( x )$$
$$where$$
$${k}_{i} = \frac{{E}_{0}}{1 - {v}_{0}^{2}} {\int }_{0}^{H} {( \frac{d h ( z )}{dz} )}^{2} dz$$
$${t}_{gi} = \frac{{E}_{0}}{4 ( 1 - {v}_{0}^{2} )} {\int }_{0}^{H} {h ( z )}^{2} d z$$
h(z) is the attenuation function of vertical displacement, Vallabhan and Das are used, the displacement function and the attenuation function are connected by using another new parameter γ, and the accurate expression of the displacement function and the attenuation function is obtained, which is referred to as an improved Vlasov foundation model; the improved Vlasov foundation model is used to calculate the foundation reaction force; according to Vallabhan and Das, the parameters of the foundation model based on the lateral displacement of the pile foundation are as follows:
$${k}_{V} = π ( {η}^{2} + 1 ) G \{ 2 γ \frac{{K}_{1} ( γ )}{{K}_{0} ( γ )} - {γ}^{2} [ {( \frac{{K}_{1} ( γ )}{{K}_{0} ( γ )} )}^{2} - 1 ] \}$$
$${t}_{gp} = π G \{ {\frac{{γ}^{2}}{{{K}_{0} ( γ )}^{2}} [ {{K}_{1} ( γ )}^{2} - {{K}_{0} ( γ )}^{2} ]}^{2} - 2 γ {K}_{1} ( γ ) {K}_{0} ( γ ) \}$$
where η is lame constant,
G is the shear modulus of soil,
γ is the attenuation parameter, which is calculated by an iterative method,
K₀(·) is the zero-order modified Bessel function of the second kind;
K₁(·) is the first-order modified Bessel function of the second kind;
$$h ( γ ) = \frac{{K}_{0} ( 2 γ r / D )}{{K}_{0} ( γ )} ,$$
the formula of a foundation soil reaction force q(x) is:
q(x)=k_{V}u(x)−2t_{gp}u′(x)
the damping of soil is calculated as follows:
$${c}_{xi} \approx 6 {ρ}_{i} {dV}_{si} / \sqrt[4]{{a}_{0}} + 2 {ξ}_{i} {k}_{xi} / ω$$
where ρᵢ is density of soil, d is the pile diameter, Vₛᵢ is the shear wave velocity in soil, ξᵢ is the damping ratio in soil, ω is the circular frequency of vibration, a₀=2πfd/V, and f is the frequency of load; from the above formula, cₓᵢ is consisted of two parts, that is, the energy loss comes from two parts, one part is the damping of the material, that is,
$$6 {ρ}_{i} {dV}_{si} / \sqrt[4]{{a}_{0}} ,$$
and the other part is the loss caused by the propagation of stress wave in soil during the vibration of the pile body, that is, 2ξᵢkₓᵢ/ω;
(2) establishment of model equation
the general form of the steady-state vibration equation of the pile body obtained by the motion balance equation of the pile body is as follows:
$$EI \frac{\partial {U}_{ai} ( z , t )}{\partial {z}^{4}} + {k}_{xi} {U}_{ai} ( z , t ) + {ρ}_{ρ} {A}_{ρ} \frac{{\partial }^{2} {U}_{ai} ( z , t )}{\partial {t}^{2}} + {c}_{xi} \frac{\partial {U}_{ai} ( z , t )}{\partial t} + ( {N}_{i} ( z ) - {t}_{gxi} ) \frac{{\partial }^{2} {U}_{ai} ( z , t )}{\partial {z}^{2}} = 0$$
considering that the pile foundation is partially embedded and fixed in the soil, the part of the pile body in the water bears the effect of the wave load without the constraint of the soil, the pile body is divided into two parts, the vibration equation of the part of the pile body in the soil is shown in the above formula, while the vibration equation of the part of the pile body exposed to the soil is shown in the following formula:
$$EI \frac{\partial {U}_{ai} ( z , t )}{\partial {z}^{4}} + {ρ}_{ρ} {A}_{ρ} \frac{{\partial }^{2} {U}_{ai} ( z , t )}{\partial {t}^{2}} + {c}_{xi}^{′} \frac{\partial {U}_{ai} ( z , t )}{\partial t} + {N}_{i} ( z ) \frac{{\partial }^{2} {U}_{ai} ( z , t )}{\partial {z}^{2}} = {f}_{z} ( z )$$
the displacement Uₐᵢ(z,t) of the pile body is expressed as: Uₐᵢ(z,t)=uₐᵢ(z)e^{iwt}, and the vibration equation becomes the following form:
the part of the pile body deep into soil:
$$\frac{{d}^{4} {u}_{ai} ( z )}{d {z}^{4}} - {m}_{1} \frac{{d}^{2} {u}_{ai} ( z )}{d {z}^{2}} - {m}_{2} {u}_{ai} ( z ) = 0$$
the part of the pile body in water:
$$\frac{{d}^{4} {u}_{ai} ( z )}{d {z}^{4}} - {m}_{3} \frac{{d}^{2} {u}_{ai} ( z )}{d {z}^{2}} - {m}_{4} {u}_{ai} ( z ) = {m}_{5} cosh ( {k}_{f} ( {d}_{L} - z ) )$$
$$where$$
$${m}_{1} = \frac{{δ}_{i}^{2}}{{h}_{i}^{2}} , {m}_{2} = \frac{{ϑ}_{i}^{4}}{{h}_{i}^{4}} , {m}_{3} = \frac{{N}_{i} ( z )}{{E}_{p} {I}_{p}} , {m}_{4} = \frac{{ρ}_{ρ} {A}_{ρ} {w}^{2} - {c}_{xi}^{′} \cdot i \cdot w}{{E}_{p} {I}_{p}} , {m}_{5} = \frac{2 ρ {gH}_{i}}{{k}_{fz} {E}_{p} {I}_{p}} {f}_{A} ,$$
dL is the water depth;
where
$${δ}_{i} = {h}_{i} \sqrt{\frac{( {t}_{gxi} - {N}_{i} )}{{E}_{p} {I}_{p}}} , {ϑ}_{i} = {h}_{i} \sqrt[4]{\frac{{ρ}_{p} {A}_{p} {ω}^{2} - {k}_{xi} - i {c}_{xi} ω}{{E}_{p} {I}_{p}}} , {c}_{xi}^{′} = 6 {ρ}_{i} {dV}_{si} / \sqrt[4]{{a}_{0}}$$
hᵢ is the thickness of the i-th layer of soil;
then the general solution of the following form is obtained by solving the above high-order vibration differential equation:
$${U}_{1 i} ( z ) = {A}_{1 i} cosh ( \frac{{ζ}_{1 i}}{{h}_{i}} z ) + {B}_{1 i} sinh ( \frac{{ζ}_{1 i}}{{h}_{i}} z ) + {C}_{1 i} cos ( \frac{{ζ}_{2 i}}{{h}_{i}} z ) + {D}_{1 i} sin ( \frac{{ζ}_{2 i}}{{h}_{i}} z )$$
$$where {ζ}_{1 i} = \sqrt{\frac{{δ}_{i}^{2}}{2} + \sqrt{\frac{{δ}_{i}^{4}}{4} + {ϖ}_{i}^{4}}} , {ζ}_{2 i} = \sqrt{- \frac{{δ}_{i}^{2}}{2} + \sqrt{\frac{{δ}_{i}^{4}}{4} + {ϖ}_{i}^{4}}} ,$$
A₁ᵢ, B₁ᵢ, C₁ᵢ, D₁ᵢ are the undetermined coefficients determined by boundary conditions;
the general solution of the above formula is:
$${U}_{1 i}^{′} ( z ) = {A}_{1 i}^{′} cosh ( {σ}_{1} z ) + {B}_{1 i}^{′} sinh ( {σ}_{1} z ) + {C}_{1 i}^{′} cos ( {σ}_{2} z ) + {D}_{1 i}^{′} sin ( {σ}_{2} z ) + {E}_{1} cosh [ {k}_{fz} ( {d}_{L} - z ) ]$$
$$where {σ}_{1} = z \sqrt{\frac{{m}_{3}}{2} + \frac{\sqrt{{m}_{3}^{2} + 4 {m}_{4}}}{2}} , {σ}_{2} = z \sqrt{\frac{\sqrt{{m}_{3}^{2} + 4 {m}_{4}}}{2} - \frac{{m}_{3}}{2}} ,$$
A′₁ᵢ, B′₁ᵢ, C′₁ᵢ, D′₁ᵢ, E₁ are also undetermined general solution coefficients, which are determined by the boundary conditions of the pile body, and E₁ is the wave load parameter, which is obtained by direct calculation;
(3) analysis of the part of the pile body exposed to soil, that is, analysis of the part of the pile body bearing the wave load:
the part of the pile body exposed to soil is regarded as a unit layer, which is similar to the division of a soil layer, and it is regarded as a layer, for the rotation angle of the cross section φ′(z), the shear force of the pile body Q′(z), the bending moment M′(z), and the horizontal displacement of the pile body:
the following relationship holds:
$${φ}_{1 i}^{′} ( z ) = {A}_{1 i}^{′} {σ}_{1} sinh ( {σ}_{1} z ) + {B}_{1 i}^{′} {σ}_{1} cosh ( {σ}_{1} z ) - {C}_{1 i}^{′} \frac{{ζ}_{2 i}}{{h}_{i}} sin ( {σ}_{2} z ) + {D}_{1 i}^{′} {σ}_{2} cos ( {σ}_{2} z ) - {k}_{fz} {E}_{1} s h ( {k}_{f} ( {d}_{L} - z ) )$$
$${Q}_{1 i}^{′} ( z ) = {E}_{P} {I}_{P} [ {σ}_{1}^{3} [ {A}_{1 i}^{′} sinh ( {σ}_{1} z ) + {B}_{1 i}^{′} cosh ( {σ}_{1} z ) ] + {σ}_{2}^{3} [ {C}_{1 i}^{′} sin ( {σ}_{2} z ) - {D}_{1 i}^{′} cos ( {σ}_{2} z ) ] - {k}_{f}^{3} {E}_{1} s h ( {k}_{f} ( {d}_{L} - z ) ) ]$$
$${M}_{1 i}^{′} ( z ) = {E}_{P} {I}_{P} [ {σ}_{1}^{2} [ {A}_{1 i}^{′} cosh ( {σ}_{1} z ) + {B}_{1 i}^{′} sinh ( {σ}_{1} z ) ] - {σ}_{2}^{2} [ {C}_{1 i}^{′} cos ( {σ}_{2} z ) + {D}_{1 i}^{′} sin ( {σ}_{2} z ) ] + {k}_{f}^{2} {E}_{1} s h ( {k}_{f} ( {d}_{L} - z ) ) ]$$
it is organized into a matrix as shown in the following formula:
$$\{ \begin{matrix}{U}_{ai}^{′} \\ {φ}_{ai}^{i} \\ {Q}_{ai}^{′} \\ {M}_{ai}^{′}\end{matrix} \} = {n}_{i}^{a} \{ \begin{matrix}{A}_{1 i}^{′} \\ {B}_{1 i}^{′} \\ {C}_{1 i}^{′} \\ {D}_{1 i}^{′}\end{matrix} \} + [ \begin{matrix}{E}_{u} \\ {E}_{φ} \\ {E}_{Q} \\ {E}_{M}\end{matrix} ] ⇒ \{ \begin{matrix}{U}_{ai}^{′} - {E}_{u} \\ {φ}_{ai}^{i} - {E}_{φ} \\ {Q}_{ai}^{′} - {E}_{Q} \\ {M}_{ai}^{′} - {E}_{M}\end{matrix} \} = {n}_{i}^{a} \{ \begin{matrix}{A}_{1 i}^{′} \\ {B}_{1 i}^{′} \\ {C}_{1 i}^{′} \\ {D}_{1 i}^{′}\end{matrix} \}$$
$${n}_{i}^{a} = [ \begin{matrix}cosh {σ}_{1} z & sinh {σ}_{1} z & cos {σ}_{2} z & sin {σ}_{2} z \\ {σ}_{1} s h {σ}_{1} z & {σ}_{1} c h {σ}_{1} z & - {σ}_{2} sin {σ}_{2} z & \frac{{ζ}_{2 i}}{{h}_{i}} cos \frac{{ζ}_{2 i}}{{h}_{i}} z \\ {E}_{p} {I}_{p} {σ}_{1}^{3} sinh {σ}_{1} z & {E}_{p} {I}_{p} {σ}_{1}^{3} cosh {σ}_{1} z & {E}_{p} {I}_{p} {σ}_{2}^{3} sin {σ}_{2} z & - {E}_{p} {I}_{p} {σ}_{2}^{3} cos {σ}_{2} z \\ {E}_{p} {I}_{p} {σ}_{1}^{2} cosh {σ}_{1} z & {E}_{p} {I}_{p} {σ}_{1}^{2} sinh {σ}_{1} z & - {E}_{p} {I}_{p} {σ}_{2}^{2} cos {σ}_{2} z & - {E}_{p} {I}_{p} {σ}_{2}^{2} sin {σ}_{2} z\end{matrix} ]$$
$$[ \begin{matrix}{E}_{u} \\ {E}_{φ} \\ {E}_{Q} \\ {E}_{M}\end{matrix} ] = {E}_{1} [ \begin{matrix}ch [ {k}_{f} ( {d}_{L} - z ) \\ - {k}_{f} \cdot sh ( {d}_{L} - z ) ) \\ - {E}_{P} {I}_{P} {k}_{f}^{3} sinh ( {k}_{f} ( {d}_{L} - z ) ) \\ {E}_{P} {I}_{P} {k}_{f}^{3} cosh ( {k}_{f} ( {d}_{L} - z ) )\end{matrix} ]$$
$${E}_{1} = \frac{- 2 \sqrt{2} \sqrt{{m}_{3} + \sqrt{{m}_{3}^{2} + 4 {m}_{4}}}}{\sqrt{{m}_{3}^{2} + 4 {m}_{4}} ( 4 {k}_{f}^{2} - 2 ( {m}_{3} + \sqrt{{m}_{3}^{2} + 4 {m}_{4}} ) ) {σ}_{1}} + \frac{- 2 \sqrt{2} \sqrt{{m}_{3} - \sqrt{{m}_{3}^{2} + 4 {m}_{4}}}}{\sqrt{{m}_{3}^{2} + 4 {m}_{4}} ( 4 {k}_{f}^{2} - 2 ( {m}_{3} + \sqrt{{m}_{3}^{2} + 4 {m}_{4}} ) ) {σ}_{2}}$$
z=0 at the top of the pile and the following formula is obtained:
$$\{ \begin{matrix}{A}_{1 i}^{′} \\ {B}_{1 i}^{′} \\ {C}_{1 i}^{′} \\ {D}_{1 i}^{′}\end{matrix} \} = inv [ \begin{matrix}1 & 0 & 1 & 0 \\ 0 & {σ}_{1} & 0 & {σ}_{1} \\ 0 & {E}_{P} {I}_{P} {σ}_{1}^{3} & 0 & - {E}_{P} {I}_{P} {σ}_{1}^{3} \\ {E}_{P} {I}_{P} {σ}_{1}^{2} & 0 & - {E}_{P} {I}_{P} {σ}_{1}^{2} & 0\end{matrix} ] \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \} = {[ {n}_{i}^{a} ]}_{z = 0}^{- 1} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$
then, at the boundary of the part of the pile body in the water and the soil layer, let z=hᵢ to obtain:
$$\{ \begin{matrix}{U}_{ai}^{′} ( {h}_{i} ) - {E}_{u} ( {h}_{i} ) \\ {φ}_{ai}^{′} ( {h}_{i} ) - {E}_{φ} ( {h}_{i} ) \\ {Q}_{ai}^{′} ( {h}_{i} ) - {E}_{Q} ( {h}_{i} ) \\ {M}_{ai}^{′} ( {h}_{i} ) - {E}_{M} ( {h}_{i} )\end{matrix} \} = {[ {n}_{i}^{a} ]}_{z = {h}_{i}} \{ \begin{matrix}{A}_{1 i}^{′} \\ {B}_{1 i}^{′} \\ {C}_{1 i}^{′} \\ {D}_{1 i}^{′}\end{matrix} \} = {{[ {n}_{i}^{a} ]}_{z = {h}_{i}} [ {n}_{i}^{a} ]}_{z = 0}^{- 1} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \} = {\overline{N}}^{a} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$
$${\overline{N}}^{a} = {{[ {n}_{i}^{a} ]}_{z = {h}_{i}} [ {n}_{i}^{a} ]}_{z = 0}^{- 1}$$
after the transformation of the matrix, the displacement of the top of the pile exposed to the soil is related to the displacement of the water-soil boundary, as shown in the following formula:
$$\{ \begin{matrix}{U}_{ai}^{′} ( {h}_{i} ) - {E}_{u} ( {h}_{i} ) \\ {φ}_{ai}^{′} ( {h}_{i} ) - {E}_{φ} ( {h}_{i} ) \\ {Q}_{ai}^{′} ( {h}_{i} ) - {E}_{Q} ( {h}_{i} ) \\ {M}_{ai}^{′} ( {h}_{i} ) - {E}_{M} ( {h}_{i} )\end{matrix} \} = {\overline{N}}^{a} \{ \begin{matrix}{U}_{ai}^{′} ( 0 ) - {E}_{u} ( 0 ) \\ {φ}_{ai}^{′} ( 0 ) - {E}_{φ} ( 0 ) \\ {Q}_{ai}^{′} ( 0 ) - {E}_{Q} ( 0 ) \\ {M}_{ai}^{′} ( 0 ) - {E}_{M} ( 0 )\end{matrix} \}$$
it is assumed that the pile length of the part exposed to the soil is L₁, the displacement, the rotation angle, the shear force and the bending moment of the pile bottom of the part exposed to the soil are shown in the following formula:
$$\{ \begin{matrix}{U}_{a}^{′} ( {L}_{1} ) - {E}_{u} ( {L}_{1} ) \\ {φ}_{a}^{′} ( {h}_{i} ) - {E}_{φ} ( {L}_{1} ) \\ {Q}_{a}^{′} ( {h}_{i} ) - {E}_{Q} ( {L}_{1} ) \\ {M}_{a}^{′} ( {h}_{i} ) - {E}_{M} ( {L}_{1} )\end{matrix} \} = {\overline{N}}^{a} \{ \begin{matrix}{U}_{a}^{′} ( 0 ) - {E}_{u} ( 0 ) \\ {φ}_{a}^{′} ( 0 ) - {E}_{φ} ( 0 ) \\ {Q}_{a}^{′} ( 0 ) - {E}_{Q} ( 0 ) \\ {M}_{a}^{′} ( 0 ) - {E}_{M} ( 0 )\end{matrix} \}$$
study of the part of the pile body in soil: according to the part of the pile body in soil which involves the constraint of soil and the stratification of soil, the specific calculation steps are as follows:
the displacement Uₐᵢ(z) of the pile body in soil is:
$${U}_{ai} ( z ) = {A}_{1 i} cosh ( \frac{{ζ}_{1 i}}{{h}_{i}} z ) + {B}_{1 i} sinh ( \frac{{ζ}_{1 i}}{{h}_{i}} z ) + {C}_{1 i} cos ( \frac{{ζ}_{2 i}}{{h}_{i}} z ) + {D}_{1 i} sin ( \frac{{ζ}_{2 i}}{{h}_{i}} z )$$
at this time, the displacement at the top of the pile becomes the displacement at the water-soil boundary, and the displacement at the bottom of the pile is the actual displacement at the bottom of the pile; the relationship between the shear force and the bending moment in the soil layer unit and the horizontal displacement of the pile body is as follows:
$${φ}_{ai} ( z ) = {A}_{1 i} \frac{{ζ}_{1 i}}{{h}_{i}} sinh ( \frac{{ζ}_{1 i}}{{h}_{i}} z ) + {B}_{1 i} \frac{{ζ}_{1 i}}{{h}_{i}} cosh ( \frac{{ζ}_{1 i}}{{h}_{i}} z ) - {C}_{1 i} \frac{{ζ}_{2 i}}{{h}_{i}} sin ( \frac{{ζ}_{2 i}}{{h}_{i}} z ) + {D}_{1 i} \frac{{ζ}_{2 i}}{{h}_{i}} cos ( \frac{{ζ}_{2 i}}{{h}_{i}} z )$$
$${Q}_{ai} ( z ) = {E}_{P} {I}_{P} \frac{{ζ}_{1 i}^{3}}{{h}_{i}^{3}} [ {A}_{1 i} sinh ( \frac{{ζ}_{1 i}}{{h}_{i}} z ) + {B}_{1 i} cosh ( \frac{{ζ}_{1 i}}{{h}_{i}} z ) ] + {E}_{P} {I}_{P} \frac{{ζ}_{2 i}^{3}}{{h}_{i}^{3}} [ {C}_{1 i} sin ( \frac{{ζ}_{2 i}}{{h}_{i}} z ) - {D}_{1 i} cos ( \frac{{ζ}_{2 i}}{{h}_{i}} z ) ]$$
$${M}_{ai} ( z ) = {E}_{P} {I}_{P} \frac{{ζ}_{1 i}^{2}}{{h}_{i}^{2}} [ {A}_{1 i} cosh ( \frac{{ζ}_{1 i}}{{h}_{i}} z ) + {B}_{1 i} sinh ( \frac{{ζ}_{1 i}}{{h}_{i}} z ) ] - {E}_{P} {I}_{P} \frac{{ζ}_{2 i}^{2}}{{h}_{i}^{2}} [ {C}_{1 i} cos ( \frac{{ζ}_{2 i}}{{h}_{i}} z ) + {D}_{1 i} sin ( \frac{{ζ}_{2 i}}{{h}_{i}} z ) ]$$
the above formula is organized into a matrix as shown in the following formula:
$$\{ \begin{matrix}{U}_{ai} \\ {φ}_{ai} \\ {Q}_{ai} \\ {M}_{ai}\end{matrix} \} = [ \begin{matrix}cosh \frac{{ζ}_{1 i}}{{h}_{i}} z & sinh \frac{{ζ}_{1 i}}{{h}_{i}} z & cos \frac{{ζ}_{2 i}}{{h}_{i}} z & sin \frac{{ζ}_{2 i}}{{h}_{i}} z \\ \frac{{ζ}_{1 i}}{{h}_{i}} sh \frac{{ζ}_{1 i}}{{h}_{i}} z & \frac{{ζ}_{1 i}}{{h}_{i}} ch \frac{{ζ}_{1 i}}{{h}_{i}} z & - \frac{{ζ}_{2 i}}{{h}_{i}} sin \frac{{ζ}_{2 i}}{{h}_{i}} z & \frac{{ζ}_{2 i}}{{h}_{i}} cos \frac{{ζ}_{2 i}}{{h}_{i}} z \\ {E}_{p} {I}_{p} \frac{{ζ}_{1 i}^{3}}{{h}_{i}^{3}} sinh \frac{{ζ}_{1 i}}{{h}_{i}} z & {E}_{p} {I}_{p} \frac{{ζ}_{1 i}^{3}}{{h}_{i}^{3}} cosh \frac{{ζ}_{1 i}}{{h}_{i}} z & {E}_{p} {I}_{p} \frac{{ζ}_{2 i}^{3}}{{h}_{i}^{3}} sin \frac{{ζ}_{2 i}}{{h}_{i}^{3}} z & - {E}_{p} {I}_{p} \frac{{ζ}_{2 i}^{3}}{{h}_{i}^{3}} cos \frac{{ζ}_{2 i}}{{h}_{i}} z \\ {E}_{p} {I}_{p} \frac{{ζ}_{1 i}^{2}}{{h}_{i}^{2}} cosh \frac{{ζ}_{1 i}}{{h}_{i}} z & {E}_{p} {I}_{p} \frac{{ζ}_{1 i}^{2}}{{h}_{i}^{2}} sinh \frac{{ζ}_{1 i}}{{h}_{i}^{2}} z & - {E}_{p} {I}_{p} \frac{{ζ}_{2 i}^{2}}{{h}_{i}^{2}} cos \frac{{ζ}_{2 i}}{{h}_{i}^{2}} z & - {E}_{p} {I}_{p} \frac{{ζ}_{2 i}^{2}}{{h}_{i}^{2}} sin \frac{{ζ}_{2 i}}{{h}_{i}} z\end{matrix} ]$$
$$let$$
$$[ {\tilde{m}}_{i}^{a} ] = [ \begin{matrix}cosh \frac{{ζ}_{1 i}}{{h}_{i}} z & sinh \frac{{ζ}_{1 i}}{{h}_{i}} z & cos \frac{{ζ}_{2 i}}{{h}_{i}} z & sin \frac{{ζ}_{2 i}}{{h}_{i}} z \\ \frac{{ζ}_{1 i}}{{h}_{i}} sh \frac{{ζ}_{1 i}}{{h}_{i}} z & \frac{{ζ}_{1 i}}{{h}_{i}} ch \frac{{ζ}_{1 i}}{{h}_{i}} z & - \frac{{ζ}_{2 i}}{{h}_{i}} sin \frac{{ζ}_{2 i}}{{h}_{i}} z & \frac{{ζ}_{2 i}}{{h}_{i}} cos \frac{{ζ}_{2 i}}{{h}_{i}} z \\ {E}_{p} {I}_{p} \frac{{ζ}_{1 i}^{3}}{{h}_{i}^{3}} sinh \frac{{ζ}_{1 i}}{{h}_{i}} z & {E}_{p} {I}_{p} \frac{{ζ}_{1 i}^{3}}{{h}_{i}^{3}} cosh \frac{{ζ}_{1 i}}{{h}_{i}} z & {E}_{p} {I}_{p} \frac{{ζ}_{2 i}^{3}}{{h}_{i}^{3}} sin \frac{{ζ}_{2 i}}{{h}_{i}} z & - {E}_{p} {I}_{p} \frac{{ζ}_{2 i}^{3}}{{h}_{i}^{3}} cos \frac{{ζ}_{2 i}}{{h}_{i}} z \\ {E}_{p} {I}_{p} \frac{{ζ}_{1 i}^{2}}{{h}_{i}^{2}} cosh \frac{{ζ}_{1 i}}{{h}_{i}} z & {E}_{p} {I}_{p} \frac{{ζ}_{1 i}^{2}}{{h}_{i}^{2}} sinh \frac{{ζ}_{1 i}}{{h}_{i}^{2}} z & - {E}_{p} {I}_{p} \frac{{ζ}_{2 i}^{2}}{{h}_{i}^{2}} cos \frac{{ζ}_{2 i}}{{h}_{i}} z & - {E}_{p} {I}_{p} \frac{{ζ}_{2 i}^{2}}{{h}_{i}^{2}} sin \frac{{ζ}_{2 i}}{{h}_{i}} z\end{matrix} ]$$
it is assumed that z=0 at the top of the pile, that is, at the surface of the soil, it can be obtained that:
$$\{ \begin{matrix}{A}_{1 i} \\ {B}_{1 i} \\ {C}_{1 i} \\ {D}_{1 i}\end{matrix} \} = inv [ \begin{matrix}1 & 0 & 1 & 0 \\ 0 & \frac{{ζ}_{1 i}}{{h}_{i}^{3}} & 0 & \frac{{ζ}_{2 i}}{h} \\ 0 & {E}_{P} {I}_{P} \frac{{ζ}_{1 i}^{3}}{{h}_{i}^{3}} & 0 & - {E}_{P} {I}_{P} \frac{{ζ}_{2 i}^{3}}{{h}_{i}^{3}} \\ {E}_{P} {I}_{P} \frac{{ζ}_{1 i}^{2}}{{h}_{i}^{2}} & 0 & - {E}_{P} {I}_{P} \frac{{ζ}_{2 i}^{2}}{{h}_{i}^{2}} & 0\end{matrix} ] \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} = {[ {\tilde{m}}_{i}^{a} ]}_{z = 0}^{- 1} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \}$$
similarly, z=hᵢ at the lower part of the pile foundation, it can be obtained that:
$$\{ \begin{matrix}{U}_{ai} ( {h}_{i} ) \\ {φ}_{ai} ( {h}_{i} ) \\ {Q}_{ai} ( {h}_{i} ) \\ {M}_{ai} ( {h}_{i} )\end{matrix} \} = {[ {\tilde{m}}_{i}^{a} ]}_{z = {h}_{i}} \{ \begin{matrix}{A}_{1 i} \\ {B}_{1 i} \\ {C}_{1 i} \\ {D}_{1 i}\end{matrix} \} = {{[ {\tilde{m}}_{i}^{a} ]}_{z = {h}_{i}} [ {\tilde{m}}_{i}^{a} ]}_{z = 0}^{- 1} \{ \begin{matrix}{U}_{ai} ( 0 ) \\ {φ}_{ai} ( 0 ) \\ {Q}_{ai} ( 0 ) \\ {M}_{ai} ( 0 )\end{matrix} \} [ {\tilde{M}}_{i}^{a} ] \{ \begin{matrix}{U}_{ai} ( 0 ) \\ {φ}_{ai} ( 0 ) \\ {Q}_{ai} ( 0 ) \\ {M}_{ai} ( 0 )\end{matrix} \}$$
$$[ {\tilde{M}}^{a} ] = {{[ {\tilde{m}}_{i}^{a} ]}_{z = {h}_{i}} [ {\tilde{m}}_{i}^{a} ]}_{z = 0}^{- 1}$$
if the soil is divided into multi-layers, according to the principle of continuity of soil uᵢ(0)=uᵢ₋₁(hᵢ₋₁), φᵢ(0)=φᵢ₋₁(hᵢ₋₁), Qᵢ(0)=Qᵢ₋₁(hᵢ₋₁), Mᵢ(0) Mᵢ₋₁(hᵢ₋₁ )
the transfer matrix method is used to connect the displacement, the shear force, the rotation angle and the bending moment between soil layers through a parameter transfer matrix, as shown in the following formula:
$$\{ \begin{matrix}{U}_{a} ( {L}_{2} ) \\ {φ}_{a} ( {L}_{2} ) \\ {Q}_{a} ( {L}_{2} ) \\ {M}_{a} ( {L}_{2} )\end{matrix} \} = [ {\tilde{M}}_{n}^{a} ] [ {\tilde{M}}_{n - 1}^{a} ] [ {\tilde{M}}_{i}^{a} ] … [ {\tilde{M}}_{1}^{a} ] \{ \begin{matrix}{U}_{a} ( 0 ) \\ {φ}_{a} ( 0 ) \\ {Q}_{a} ( 0 ) \\ {M}_{a} ( 0 )\end{matrix} \}$$
where L₂ is the length of the pile body in soil;
[\tilde{M}^{a}]=[\tilde{M}ₙ^{a}][\tilde{M}ₙ₋₁^{a}][\tilde{M}ᵢ^{a}] . . . [\tilde{M}₁^{a}], this matrix is the transfer matrix;
let
$$[ {\tilde{M}}^{a} ] = [ \begin{matrix}{\tilde{M}}_{11}^{a} & {\tilde{M}}_{12}^{a} \\ {\tilde{M}}_{21}^{a} & {\tilde{M}}_{22}^{a}\end{matrix} ]$$
the above formula is expressed as follows:
$$\{ \begin{matrix}{U}_{a} ( {L}_{2} ) \\ {φ}_{a} ( {L}_{2} )\end{matrix} \} = [ {\tilde{M}}_{11}^{a} ] \{ \begin{matrix}{u}_{a} ( 0 ) \\ {φ}_{a} ( 0 )\end{matrix} \} + [ {\tilde{M}}_{12}^{a} ] \{ \begin{matrix}{Q}_{a} ( 0 ) \\ {M}_{a} ( 0 )\end{matrix} \}$$
$$\{ \begin{matrix}{Q}_{a} ( {L}_{2} ) \\ {M}_{a} ( {L}_{2} )\end{matrix} \} = [ {\tilde{M}}_{21}^{a} ] \{ \begin{matrix}{u}_{a} ( 0 ) \\ {φ}_{a} ( 0 )\end{matrix} \} + [ {\tilde{M}}_{22}^{a} ] \{ \begin{matrix}{Q}_{a} ( 0 ) \\ {M}_{a} ( 0 )\end{matrix} \}$$
it is assumed that the boundary condition of the pile bottom is a fixed end and the pile top is a free end, then:
$$\{ \begin{matrix}{U}_{a} ( {L}_{2} ) \\ {φ}_{a} ( {L}_{2} )\end{matrix} \} = \{ \begin{matrix}0 \\ 0\end{matrix} \}$$
the above formula is organized, it is obtained that:
$$\{ \begin{matrix}{U}_{a} ( 0 ) \\ {φ}_{a} ( 0 )\end{matrix} \} = {[ - {\tilde{M}}_{11}^{a} ]}^{- 1} [ {\tilde{M}}_{12}^{a} ] \{ \begin{matrix}{Q}_{a} ( 0 ) \\ {M}_{a} ( 0 )\end{matrix} \} = [ {K}_{S} ] \{ \begin{matrix}{Q}_{a} ( 0 ) \\ {M}_{a} ( 0 )\end{matrix} \}$$
$$[ {K}_{S} ] = - {[ {\tilde{M}}_{11}^{a} ]}^{- 1} [ {\tilde{M}}_{12}^{a} ]$$
[Kₛ] is the impedance function matrix of the pile top;
$$[ {K}_{S} ] = [ \begin{matrix}{K}_{S 11} & {K}_{S 12} \\ {K}_{S 21} & {K}_{S 22}\end{matrix} ]$$
the above formula is organized, it is obtained that:
Uₐ(0)=K_{S}(1,1)Qₐ(0)+K_{S}(1,2)Mₐ(0)
φₐ(0)=K_{S}(2,1)Qₐ(0)+K_{S}(2,2)Mₐ(0)
finally, when calculating the total displacement and the total rotation angle of the pile top, the displacements of the pile top of the part in the soil Uₐ(0) and φₐ(0) are regarded as the displacement of the pile bottom in the part of the pile body exposed to the soil to obtain:
$$\{ \begin{matrix}{U}_{a}^{′} ( 0 ) - {E}_{u} ( 0 ) \\ {φ}_{a}^{′} ( 0 ) - {E}_{φ} ( 0 ) \\ {Q}_{a}^{′} ( 0 ) - {E}_{Q} ( 0 ) \\ {M}_{a}^{′} ( 0 ) - {E}_{M} ( 0 )\end{matrix} \} = {[ {\overline{N}}^{a} ]}^{- 1} \{ \begin{matrix}{U}_{a} ( 0 ) - {E}_{u} ( {L}_{1} ) \\ {φ}_{a} ( 0 ) - {E}_{φ} ( {L}_{1} ) \\ {Q}_{a} ( 0 ) - {E}_{Q} ( {L}_{1} ) \\ {M}_{a} ( 0 ) - {E}_{M} ( {L}_{1} )\end{matrix} \}$$
the above formula is the displacement, the rotation angle, the shear force and the bending moment of the final pile top obtained by combining the dynamic response of the two parts of the pile body;
according to the definition of the horizontal impedance of the single pile, the calculation formula of the single pile impedance is obtained as shown in the following formula:
$${R}_{K} = \frac{{Q}_{a} ( 0 )}{{u}_{a} ( 0 )} = \frac{{Q}_{a} ( 0 )}{{K}_{S} ( 1 , 1 {Q}_{a} ( 0 ) + {K}_{S} ( 1 , 2 )} = {K}_{K} + i {a}_{0} {C}_{K}$$
where the impedance R_{K} consists of a real part and an imaginary part, the real part K_{K} is the dynamic stiffness of a single pile in the horizontal direction, and the imaginary part C_{K} is the horizontal dynamic damping of a single pile;
(4) establishment of pile groups model:
4-1) model analysis of pile groups:
ψ(s,θ) is set as the attenuation function of soil stress wave, f′_{z} is set as the wave load borne by the passive pile, and the other parameters have the same meaning as the single pile; the attenuation function ψ(s,θ) is calculated as follows:
$$ψ ( s , θ ) = ψ ( s , 0 ) {cos}^{2} θ + ψ ( s , \frac{π}{2} ) {sin}^{2} θ$$
$$where ψ ( s , 0 ) = {\sqrt{\frac{{r}_{p}}{s} e}}^{\frac{ω ( η + i ) ( s - {r}_{p} )}{{V}_{La}}} , ψ ( s , \frac{π}{2} ) = {\sqrt{\frac{{r}_{p}}{s} e}}^{\frac{ω ( η + i ) ( s - {r}_{p} )}{{V}_{si}}}$$
here s is the pile spacing, θ is the included angle between piles; V_{La} is the Lysmer simulation wave velocity of soil, which is calculated as follows:
$${V}_{L a} = \frac{3.4 {V}_{si}}{π ( 1 - {ν}_{si} )}$$
where Vₛᵢ is the shear wave velocity of soil, and vₛᵢ is the Poisson's ratio of soil;
the displacement when the stress wave caused by vibration of the active pile is sent is Uₐᵢ(z,t), and according to the loss of the stress wave in soil, the displacement attenuation after reaching the passive pile is:
Uₐₛuₐₛ(z)e^{iωt}=ψ(s,θ)uₐᵢ(z)e^{iωt}
it is assumed that the displacement of the passive pile is U_{bi}(z,t), which is written in the form of U_{bi}(z,t)=U_{bi}(z)e^{iwt} for the convenience of calculation, and the vibration balance equation of the passive pile is as follows:
the vibration balance equation of the part of the pile body in water;
$$EI \frac{\partial {U}_{bi} ( z , t )}{\partial {z}^{4}} + {ρ}_{ρ} {A}_{ρ} \frac{{\partial }^{2} {U}_{bi} ( z , t )}{\partial {t}^{2}} + {c}_{xi}^{′} , \frac{\partial {U}_{bi} ( z , t )}{\partial t} + {N}_{i} ( z ) \frac{{\partial }^{2} {U}_{bi} ( z , t )}{\partial {z}^{2}} = {f}_{z}^{′} ( z )$$
the vibration balance equation of the part of the pile body in soil;
$${E}_{P} {I}_{P} \frac{{d}^{4} {u}_{bi} ( z )}{d {z}^{4}} - ( {t}_{gxi} - {N}_{i} ( z ) ) \frac{{d}^{2} {u}_{bi} ( z )}{d {z}^{2}} - {ρ}_{ρ} {A}_{ρ} {ω}^{2} {u}_{bi} ( z ) = ( {k}_{xi} + i ω {c}_{xi} ) ( {ψ}_{i} ( s , θ ) {u}_{ai} ( z ) - {u}_{bi} ( z ) )$$
compared with the active pile, the value of the wave load f_{z} of the passive pile is slightly different, because the positions of the active pile and the passive pile are different, the wave crest is uncapable of acting on each pile at the same time; in addition, the interaction between piles leads to asymmetry of vortices and interaction between vortices, so as to lead to different loads on each pile; at the same time, considering the influence of other factors, in the calculation of this step, the wave load borne by the passive pile is calculated according to f′_{z}=0.8 f_{z};
the calculation process of the above formula is as follows:
first let
$${φ}_{i} ( s , θ ) = \frac{( {k}_{xi} + i ω {c}_{xi} )}{{E}_{p} {I}_{p}} {ψ}_{i} ( s , θ )$$
the above formula is expressed as:
$$\frac{{d}^{4} {u}_{bi} ( z )}{d {z}^{4}} - {ϛ}_{1} \frac{{d}^{2} {u}_{bi} ( z )}{d {z}^{2}} - {ϛ}_{2} {u}_{bi} ( z ) = φ ( s , θ ) {u}_{ai} ( z )$$
$$where {ϛ}_{1} = {( \frac{{δ}_{i}}{{h}_{i}} )}^{2} , {ϛ}_{2} = {( \frac{{ϖ}_{i}}{{h}_{i}} )}^{4} ,$$
the general solution of the above formula is expresses as:
$${u}_{bi} ( z ) = {A}_{2 i} ch \frac{{ζ}_{1 i}}{{h}_{i}} z + {B}_{2 i} sh \frac{{ζ}_{1 i}}{{h}_{i}} z + {C}_{2 i} cos \frac{{ζ}_{2 i}}{{h}_{i}} z + {D}_{2 i} sin \frac{{ζ}_{2 i}}{{h}_{i}} z + z {α}_{i} ( {A}_{1 i} sinh \frac{{ζ}_{1 i}}{h} z + {B}_{1 i} cosh \frac{{ζ}_{1 i}}{{h}_{i}} z ) + z {β}_{i} ( - {C}_{1 i} sin \frac{{ζ}_{2 i}}{{h}_{i}} z + {D}_{1 i} cos \frac{{ζ}_{2 i}}{{h}_{i}} z )$$
$$where$$
$${α}_{i} = \frac{φ ( s , θ )}{2 \frac{{ζ}_{1 i}}{{h}_{i}} [ 2 {( \frac{{ζ}_{1 i}}{{h}_{i}} )}^{2} - {( \frac{{δ}_{i}}{{h}_{i}} )}^{2} ]} ,$$
$${β}_{i} = \frac{φ ( s , θ )}{2 \frac{{ζ}_{2 i}}{{h}_{i}} [ 2 {( \frac{{ζ}_{2 i}}{{h}_{i}} )}^{2} - {( \frac{{δ}_{i}}{{h}_{i}} )}^{2} ]} ,$$
in the soil layer unit, the relationship between the rotation angle of the cross section φ_{bi}(z) , the bending moment M_{bi}(z), the shear force Q_{bi}(z) and the lateral displacement u_{bi}(z) of the cross section of each pile foundation has the same calculation process as that of a single pile, which is expressed in the form of matrix as follows:
$$\{ \begin{matrix}{u}_{bi} ( L ) \\ {φ}_{bi} ( L ) \\ {Q}_{bi} ( L ) \\ {M}_{bi} ( L )\end{matrix} \} = [ {\tilde{M}}_{i}^{a} ] \{ \begin{matrix}{u}_{bi} ( 0 ) \\ {φ}_{bi} ( 0 ) \\ {Q}_{bi} ( 0 ) \\ {M}_{bi} ( 0 )\end{matrix} \} + [ {\tilde{M}}_{i}^{b} ] \{ \begin{matrix}{u}_{ai} ( 0 ) \\ {φ}_{ai} ( 0 ) \\ {Q}_{ai} ( 0 ) \\ {M}_{ai} ( 0 )\end{matrix} \}$$
where [\tilde{M}ᵢ^{a}] is the same as the calculation of a single pile, but the calculation of [\tilde{M}ᵢ^{b}] is slightly complicated, as shown in the following formula:
$$[ {\tilde{M}}_{i}^{b} ] = - {{{{[ {\tilde{m}}_{i}^{a} ]}_{z = {h}_{i}} [ {\tilde{m}}_{i}^{a} ]}_{z = 0}^{- 1} [ {\tilde{m}}_{i}^{b} ]}_{z = 0} [ {\tilde{m}}_{i}^{a} ]}_{z = 0}^{- 1} + {{[ {\tilde{m}}_{i}^{b} ]}_{z = {h}_{i}} [ {\tilde{m}}_{i}^{a} ]}_{z = 0}^{- 1}$$
$$where [ {\tilde{m}}_{i}^{b} ] \{ \begin{matrix}{\tilde{m}}_{1 i}^{b} \\ {\tilde{m}}_{2 i}^{b} \\ {\tilde{m}}_{3 i}^{b} \\ {\tilde{m}}_{4 i}^{b}\end{matrix} \}$$
$${[ {\tilde{m}}_{1 i}^{b} ]}^{T} = [ \begin{matrix}{α}_{i} z s h \frac{{ζ}_{1 i}}{{h}_{i}} z \\ {α}_{i} z c h \frac{{ζ}_{1 i}}{{h}_{i}} z \\ - {β}_{i} z sin \frac{{ζ}_{2 i}}{{h}_{i}} z \\ {β}_{i} z cos \frac{{ζ}_{2 i}}{{h}_{i}} z\end{matrix} ] ,$$
$${[ {\tilde{M}}_{2 i}^{b} ]}^{T} = [ \begin{matrix}{α}_{i} sh \frac{{ζ}_{1 i}}{{h}_{i}} z + {α}_{i} z \frac{{ζ}_{1 i}}{{h}_{i}} c h \frac{{ζ}_{1 i}}{{h}_{i}} z \\ {α}_{i} ch \frac{{ζ}_{1 i}}{{h}_{i}} z + {α}_{i} z \frac{{ζ}_{1 i}}{{h}_{i}} s h \frac{{ζ}_{1 i}}{{h}_{i}} z \\ - {β}_{i} sin \frac{{ζ}_{2 i}}{{h}_{i}} z - {β}_{i} z \frac{{ζ}_{2 i}}{{h}_{i}} cos \frac{{ζ}_{2 i}}{{h}_{i}} z \\ {β}_{i} cos \frac{{ζ}_{2 i}}{{h}_{i}} z - {β}_{i} z \frac{{ζ}_{2 i}}{{h}_{i}} sin \frac{{ζ}_{2 i}}{{h}_{i}} z\end{matrix} ]$$
$${[ {\tilde{m}}_{3 i}^{b} ]}^{T} = [ \begin{matrix}{E}_{p} {I}_{p} ( 3 {α}_{i} \frac{{ζ}_{1 i}^{2}}{{h}_{i}^{2}} s h \frac{{ζ}_{1 i}}{{h}_{i}} z + {α}_{i} z \frac{{ζ}_{1 i}^{3}}{{h}_{i}^{3}} c h \frac{{ζ}_{1 i}}{{h}_{i}} z ) \\ {E}_{p} {I}_{p} ( 3 {α}_{i} \frac{{ζ}_{1 i}^{2}}{{h}_{i}^{2}} c h \frac{{ζ}_{1 i}}{{h}_{i}} z + {α}_{i} z \frac{{ζ}_{1 i}^{3}}{{h}_{i}^{3}} s h \frac{{ζ}_{1 i}}{{h}_{i}} z ) \\ {E}_{p} {I}_{p} ( 3 {β}_{i} \frac{{ζ}_{2 i}^{2}}{{h}_{i}^{2}} sin \frac{{ζ}_{2 i}}{{h}_{i}} z + {β}_{i} z \frac{{ζ}_{2 i}^{3}}{{h}_{i}^{3}} cos \frac{{ζ}_{2 i}}{{h}_{i}} z ) \\ {E}_{p} {I}_{p} ( - 3 {β}_{i} \frac{{ζ}_{2 i}^{2}}{{h}_{i}^{2}} cos \frac{{ζ}_{2 i}}{{h}_{i}} z + {β}_{i} z \frac{{ζ}_{2 i}^{3}}{{h}_{i}^{3}} sin \frac{{ζ}_{2 i}}{{h}_{i}} z )\end{matrix} ]$$
$${[ {\tilde{m}}_{4 i}^{b} ]}^{T} = [ \begin{matrix}{E}_{p} {I}_{p} ( 2 {α}_{i} \frac{{ζ}_{1 i}}{{h}_{i}} c h \frac{{ζ}_{1 i}}{{h}_{i}} z + {α}_{i} z \frac{{ζ}_{1 i}^{2}}{{h}_{i}^{2}} s h \frac{{ζ}_{1 i}}{{h}_{i}} z ) \\ {E}_{p} {I}_{p} ( 2 {α}_{i} \frac{{ζ}_{1 i}}{{h}_{i}} s h \frac{{ζ}_{1 i}}{{h}_{i}} z + {α}_{i} z \frac{{ζ}_{1 i}^{2}}{{h}_{i}^{2}} c h \frac{{ζ}_{1 i}}{{h}_{i}} z ) \\ {E}_{p} {I}_{p} ( - 2 {β}_{i} \frac{{ζ}_{2 i}}{{h}_{i}} cos \frac{{ζ}_{2 i}}{{h}_{i}} z + {β}_{i} z \frac{{ζ}_{2 i}^{2}}{{h}_{i}^{2}} sin \frac{{ζ}_{2 i}}{{h}_{i}} z ) \\ {E}_{p} {I}_{p} ( - 2 {β}_{i} \frac{{ζ}_{2 i}}{{h}_{i}} sin \frac{{ζ}_{2 i}}{{h}_{i}} z - {β}_{i} z \frac{{ζ}_{2 i}^{2}}{{h}_{i}^{2}} cos \frac{{ζ}_{2 i}}{{h}_{i}} z )\end{matrix} ]$$
according to the transfer matrix, the displacement, the rotation angle, the shear force and the bending moment of each soil layer are linked, as shown in the following formula, and the organized transfer matrix is:
$$\{ \begin{matrix}{u}_{b} ( {L}_{2} ) \\ {φ}_{b} ( {L}_{2} ) \\ {Q}_{b} ( {L}_{2} ) \\ {M}_{b} ( {L}_{2} )\end{matrix} \} = [ {\tilde{M}}^{a} ] \{ \begin{matrix}{u}_{b} ( 0 ) \\ {φ}_{b} ( 0 ) \\ {Q}_{b} ( 0 ) \\ {M}_{b} ( 0 )\end{matrix} \} + [ {\tilde{M}}^{b} ] \} \{ \begin{matrix}{u}_{a} ( 0 ) \\ {φ}_{a} ( 0 ) \\ {Q}_{a} ( 0 ) \\ {M}_{a} ( 0 )\end{matrix} \}$$
$$where [ {\tilde{M}}^{a} ] = [ {\tilde{M}}_{n}^{a} ] [ {\tilde{M}}_{n - 1}^{a} ] … [ {\tilde{M}}_{1}^{a} ]$$
$$[ {\tilde{M}}^{b} ] = {\sum }_{j = 1}^{n} [ {\tilde{M}}_{n}^{a} ] … [ {\tilde{M}}_{j + 1}^{a} ] [ {\tilde{M}}_{j}^{a} ] [ {\tilde{M}}_{j - 1}^{a} ] … [ {\tilde{M}}_{1}^{a} ]$$
$$[ {\tilde{M}}^{b} ] = [ \begin{matrix}{\tilde{M}}_{11}^{b} & {\tilde{M}}_{12}^{b} \\ {\tilde{M}}_{21}^{b} & {\tilde{M}}_{22}^{b}\end{matrix} ]$$
the above formula is expressed as:
$$\{ \begin{matrix}{u}_{b} ( L ) \\ {φ}_{b} ( L )\end{matrix} \} = [ {\tilde{M}}_{11}^{a} ] \{ \begin{matrix}{U}_{b} ( 0 ) \\ {φ}_{b} ( 0 )\end{matrix} \} + [ {\tilde{M}}_{12}^{a} ] \{ \begin{matrix}{Q}_{b} ( 0 ) \\ {M}_{b} ( 0 )\end{matrix} \} + [ {\tilde{M}}_{11}^{b} ] \{ \begin{matrix}{U}_{a} ( 0 ) \\ {φ}_{a} ( 0 )\end{matrix} \} + [ {\tilde{M}}_{12}^{b} ] \{ \begin{matrix}{Q}_{a} ( 0 ) \\ {M}_{a} ( 0 )\end{matrix} \}$$
$$\{ \begin{matrix}{Q}_{b} ( L ) \\ {M}_{b} ( L )\end{matrix} \} = [ {\tilde{M}}_{21}^{a} ] \{ \begin{matrix}{U}_{b} ( 0 ) \\ {φ}_{b} ( 0 )\end{matrix} \} + [ {\tilde{M}}_{22}^{a} ] \{ \begin{matrix}{Q}_{b} ( 0 ) \\ {M}_{b} ( 0 )\end{matrix} \} + [ {\tilde{M}}_{21}^{b} ] \{ \begin{matrix}{U}_{a} ( 0 ) \\ {φ}_{a} ( 0 )\end{matrix} \} + [ {\tilde{M}}_{22}^{b} ] \{ \begin{matrix}{Q}_{a} ( 0 ) \\ {M}_{a} ( 0 )\end{matrix} \}$$
according to the model, it is assumed that the boundary condition is that the pile top is fixed, so
$$\{ \begin{matrix}{U}_{b} ( L ) \\ {φ}_{b} ( L )\end{matrix} \} = 0$$
then the boundary conditions are substituted into the above formula to obtain:
$$\{ \begin{matrix}{U}_{b} ( 0 ) \\ {φ}_{b} ( 0 )\end{matrix} \} = [ {μ}_{v} ( s , θ ) ] \{ \begin{matrix}{u}_{a} ( 0 ) \\ {φ}_{a} ( 0 )\end{matrix} \}$$
$$where [ {μ}_{v} ( s , θ ) ] = - {[ {\tilde{M}}_{11}^{a} ]}^{- 1} ( [ {\tilde{M}}_{11}^{b} ] + {[ {\tilde{M}}_{12}^{b} ] [ {\tilde{M}}_{12}^{a} ]}^{- 1} [ {\tilde{M}}_{11}^{a} ] )$$
[μᵥ(s,θ)] is the interaction matrix between the active pile and the passive pile;
according to the definition of the interaction factor, it is obtained that:
the horizontal interaction factor of pile groups is:
$${β}_{u p} = \frac{{U}_{b} ( 0 )}{{U}_{a} ( 0 )} = \frac{{μ}_{v} ( 1 , 1 ) {K}_{S} ( 1 , 1 ) + {μ}_{v} ( 1 , 2 ) {K}_{S} ( 2 , 1 )}{{K}_{S} ( 1 , 1 )}$$
the shaking interaction factor of pile groups is:
$${β}_{φ M} = \frac{{φ}_{b} ( 0 )}{{φ}_{a} ( 0 )} = \frac{{μ}_{v} ( 2 , 1 ) {K}_{S} ( 1 , 2 ) + {μ}_{v} ( 2 , 2 ) {K}_{S} ( 2 , 2 )}{{K}_{S} ( 2 , 2 )}$$
the total displacement and the rotation angle parameters of the pile top of pile groups have the same calculation method as those of a single pile, specifically as follows:
$${\{ \begin{matrix}{U}_{b}^{′} ( 0 ) ‐ {E}_{u} ( 0 ) \\ {φ}_{b}^{′} ( 0 ) ‐ {E}_{φ} ( 0 ) \\ {Q}_{b}^{′} ( 0 ) ‐ {E}_{Q} ( 0 ) \\ {M}_{b}^{′} ( 0 ) ‐ {E}_{M} ( 0 )\end{matrix} \} [ {\overline{N}}^{a} ]}^{- 1} = \{ \begin{matrix}{U}_{b} ( 0 ) ‐ {E}_{u} ( {L}_{1} ) \\ {φ}_{b} ( 0 ) ‐ {E}_{φ} ( {L}_{1} ) \\ {Q}_{b} ( 0 ) ‐ {E}_{Q} ( {L}_{1} ) \\ {M}_{b} ( 0 ) ‐ {E}_{M} ( {L}_{1} )\end{matrix} \}$$
4-2) impedance analysis of pile groups:
the calculation of the horizontal impedance of pile groups is as follows, assuming that the number of pile groups is n, and the horizontal displacement u^{G} of pile groups is equal to the horizontal displacement of each single pile, namely
$${u}^{G} = {u}_{i}^{G} = {\sum }_{{j = 1}^{}}^{n} {u}_{ij}^{G} ( i , j = 1 , 2 , 3 … , n )$$
assuming that the influence factor of the active pile j on the passive pile i is χᵢⱼ, the load borne by pile j in pile groups is Pⱼ, and according to the relationship between load, impedance and displacement:
$${\sum }_{j = 1}^{n} {χ}_{ij} {P}_{j} = {R}_{K} {u}^{G} , {P}^{G} = {\sum }_{j = 1}^{n} {P}_{j} , {χ}_{ij} j = 1 when i = k$$
where R_{K} is the impedance of a single pile;
the horizontal dynamic impedance of pile groups is:
$${R}^{G} = \frac{{P}^{G}}{{u}^{G}} = {K}^{G} + i {a}_{0} {C}^{G}$$
K^{G} is the horizontal dynamic stiffness of pile groups; C^{G} is the horizontal dynamic damping of pile groups.

6. A system for analyzing dynamic response and dynamic impedance of pile groups, comprising:
a storage subsystem, which is configured to store a computer program;
an information processing subsystem, which is configured to realize the steps of the method for analyzing dynamic response and dynamic impedance of pile groups according to claim 5 when executing the computer program.
